(19) United States
(12) Patent Application Publication
(10) Pub. No.: US 2003/0046389 A1
(43) Pub. Date: Mar. 6, 2003

(54) Method for monitoring a web site's keyword visibility in search engines and directories and resulting traffic from such keyword visibility

(76) Inventor: Laura M. Thieme, Worthington, OH (US)

Correspondence Address: THOMPSON HINE LLP, 10 W. BROAD ST., SUITE 700, COLUMBUS, OH, 43215-3435, US

(21) Appl. No.: 10/235,247

(22) Filed: Sep. 4, 2002

Related U.S. Application Data
(60) Provisional application No. 60/317,095, filed on Sep. 4, 2001.

(51) Int. Cl. G06F 15/173

(52) U.S. Cl. 709/224

(57) ABSTRACT

A system and method using a Web promotion program and a keyword visibility tracking and traffic analysis program to improve usage of the data collected by these programs. According to a preferred embodiment of the present invention, the system and method first perform the steps of running the Web promotion program and the keyword visibility tracking and analysis program, and generating data from each program. A relationship is then formed between the sets of data, and also between historical data stored from previous analyses. A database is then populated with the related data and historical related data, in accordance with pre-determined rules and criteria. Reports may be automatically generated from the database data, providing a basis for recommendations and further action to improve the user's Web site ranking in a search engine.

This application claims the benefit of U.S. Provisional Application No. 60/317,095, filed Sep. 4, 2001.

### FIELD OF THE INVENTION

This invention relates to monitoring and enhancing a Web site's visibility, i.e., how prevalent and often a Web site appears in search engines and directories based on searching keyword phrases such as a company name, brand name(s), and categorical subjects. This invention also relates to monitoring, quantifying, and analyzing the resulting traffic from the keyword visibility.

### BACKGROUND

Company Webmasters and individuals promote their Web sites in search engines and directories in order to attract potential customers to their Web site. Search engines are one of many ways to direct Internet traffic to a Web site, where they are becoming the leading way to direct targeted traffic to a Web site. When an Internet user visits a search engine they either use a keyword search box or browse listings under a directory to locate a Web site of relevance to their keyword search or area of interest.

Currently, there are two general types of search tools that are used to locate a Web site of interest:

1) Search directories, such as, for example, Yahoo® Directory, Open Directory, Looksmart®, and Netscape; and

2) Search engines, such as Google®, MSN® Search, Altavista, Excite^{SM}, Lycos®, Dogpile®, Hotbot®, Inktomi®, TEOMA^{SM}, America Online® (“AOL®) Search, and Overture®.

Each search directory or search engine utilizes non-published algorithms to index and rank Web sites, and/or Web pages within a Web site. Even so, many company Webmasters and individuals have learned how to increase their chances of getting indexed, described in more detail below, or appear in the top ten search results in a particular search directory or search engine. Being within or near the top ten search results is highly desirable since those returns are more likely to result in traffic to the Web site than those which fall farther down the list of results.

Currently, there are four popular methods for a search engine to index a particular Web site without the use of cost-per-click, paid placement, or keyword bidding. First, a Web site can be prepared with Search Engine Optimization (“SEO”) techniques. Search engine optimization entails an SEO expert or professional performing the following tasks:

1) Reviewing a Web site's keyword visibility in the search engines;

2) Determining which keywords to relate to a Web site's products and/or services; and

3) Writing and adding appropriate source code to an entire site, or individual Web pages based on this review and determination.

Software source code can include “metatags,” which allow a SEO professional to write a relevant page title, corresponding description, and keywords. Metatags are keywords embedded into the Web pages, and are used by some search engines for indexing the content of the Web page. SEO professionals may also advise an owner of the Web site on how to write strategic and relevant “copy,” i.e., text, for a given Web page or Web site, which will increase the chances of being indexed by a search engine and displayed as a relevant search result in the same search engine.

A second method for a search engine to index a particular Web site is to either hand-submit the complete address of an Internet Web page, known as a Uniform Resource Locator (URL) or use automated registration/submission software to register a URL with search engines and directories. Search engine sites report that a large proportion of free URL submissions and/or registrations come from individuals trying to deceive or illegally increase their chances of being ranked in the search engines. These individuals might submit one URL several times within a given time period with hopes of increasing their chances of being ranked higher in the search engines. Alternatively, these individuals might submit a page having a competitor's URL who has better rankings in the search engine as a “false front” and utilize a technique known in the art as “cloaking technology.” With cloaking technology, a submitter supplies a false-front page for search engines to index and rank. However, when users click on the site from the search engine, they are directed to the submitter's Web page, which the search engine would not see or list in its search engine listings. This has the effect of increasing traffic at the submitter's web site while decreasing their competitor's visibility. It is generally unacceptable to submit one URL several times to a search engine, and is often discouraged by the search engines in their search engine submission guidelines. Thus, many search engines prefer hand-submissions for a fee, to discourage these activities.

A third method for a search engine to index a particular Web site is based on the existence of a frequently visited first Web site that might have an outgoing hypertext or image link to a second Web site. Search engines are likely to follow or “crawl” the popular first site's hypertext links to a new Web site. Thus, it is possible for the second site to get listed in a search engine because the first site is linked to the second site.

A fourth method for a search engine to index a particular Web site is based on keyword bidding or cost-per-click (or cost-per-visitor), which is also known as paid placement. Paid placement is currently in use by MSN®, Altavista®, Yahoo®, Lycos®, Overture®, Google®, AOL®, and many other search engines. The top three positions on the first page of search results for a particular keyword phrase go to the highest bidder. Companies will bid at Overtures for a particular keyword phrase, based on how much they are willing to pay per click. These results are in turn licensed to MSN®, Yahoo®, Altavista®, Lycos®, and other search engines. Google's paid placement results are currently licensed to AOL® and AskJeeves®. Paid placement is typically more expensive to pay cost-per-click; however, many clients opt for paid placement because there is a guarantee that the search engines will place their site, depending on how much the company is willing to pay for each visitor to their web site, at the top of the search results which can often number in the hundreds of thousands for one keyword phrase. Search engine optimization (SEO) is typically the least expensive method of achieving visibility for a particular keyword phrase, because it avoids the fees associated with keyword bidding or cost-per-click.

Currently, there are two popular methods to get a search directory editor to review a Web site for inclusion in a relevant category listing:

1) Free URL submission, title, and description under relevant category heading; and

2) Paid inclusion or express review submission, title, and description under relevant category heading.

Once a Web site has been submitted, or visited by search engines, a company's Webmaster becomes interested in having his or her Web site indexed and ranked near the top of a search result for keywords/phrases that match his or her company's name, brand names, and/or related keywords/phrases.

The following are commonly referred to terms in this industry:

“Search Engine Optimizations” or “SEOs,” which are methods followed to place a Web site at the top of a search engine or directory listing;

“Search Engine Positioning,” which is how a Web site ranks in a search engine or directory listing;

“Search Engine Friendly Web Design,” which uses a combination of aesthetic design concepts, programming language, and incorporation of static and dynamic or database-driven Web pages, sometimes used because some search engines may have difficulty indexing Web sites, URLs, or content that is programmed in certain languages. Such languages may include, but are not limited to: perl scripts (.pl), active server pages (.asp), Cold Fusion (.cfm), or shopping cart items listed in cgi-bins);

“Search Engine Submissions” or “URL submissions,” which refer to visiting a search engine's Web site and clicking on the “Add” or “Submit URL” link often posted at the bottom of the search engine's home page. A search engine submission may be free or cost a six-month or annual subscription fee; and

“Directory Registrations,” which refers to registering, is also known as “submitting” a Web site to one of the above listed directories. Directories usually have annual registration fees, and/or cost-per-click fees, and are reviewed by a directory editor or directory category editor, who can dramatically influence the ability for a Web site to appear in a relevant category or topic listing in a directory.

There are numerous rules, guidelines, and/or procedures that a SEO expert/professional or Webmaster must abide by to ensure their Web site is properly listed in a search engine and/or directory. These generally unpublished rules, guidelines, and/or procedures can change frequently depending on the search engine/directory and/or SEO industry. In addition, the SEO professional or Webmaster is interested in obtaining a certain level of visibility for their client or company's Web site in the search engines and directories. Thus, the SEO professional or Webmaster often uses certain software tools to monitor their URL's keyword visibility, and perhaps use the same software to re-submit their Web site in the same automated fashion.

Currently, there are three popular methods to monitor keyword visibility for a given Web site:

1) Automated Web site promotional software, such as WebPositionGold™;

2) Search engine analyzer/submitter software such as TopDog Pro®; and

3) Manual or random keyword visibility checking performed by the Webmaster of the Web site's position.

WebPositionGold™ includes a software-generated tool that creates optimized Web pages for search engines, submits pages to search engines and directories, and monitors the results on a daily, weekly, or monthly basis either by scheduling an automated report to run, or by running a report manually on demand. Top Dog Pro® includes similar keyword visibility monitoring software, but it is unable to schedule reports to run automatically. Manual or random keyword visibility checking is time-consuming, and thus least desired by search engine optimization professionals.

There are a variety of software programs to determine the number of visitors a Web site receives on a monthly basis. For example, WebTrends® is a Web site traffic log file analysis tool that enables users to determine which search engine sent traffic to their Web site for a specific keyword phrase, and enables users to assess Web site visitor needs on a monthly or daily basis. However, there is currently no known relationship data tool enabling analysis between keyword visibility and traffic log analysis programs.

The limitations of all known prior art software can be any one of, but not limited to, the following:

1. The prior art can be set up to monitor a Web site's visibility for specified keyword phrases. However, each report may collect approximately 50 megabytes (“MB”) of data, which is burdensome to work with and unwieldy to analyze.

2. The prior art can be set up to run daily, weekly, or monthly reports. However, search engines have criticized users of the prior art for taxing their servers by running the daily or weekly reports.

3. Data storage space can be a problem when using the prior art for monitoring multiple Web site accounts.

4. A report generated by the prior art using a personal computer and a dial-up Internet connection can take up to two hours or more.

5. A report generated by the prior art using a personal computer and a high-speed (cable modem or DSL) Internet connection can take as long as half an hour or more.

6. A report generated by the prior art on a server, with a T-1 connection, can take fifteen minutes or more.

7. The prior art includes an option to export reports in Comma Separated Values (“CSV”) format. However, the CSV format reports are not easily stored or located with the file naming conventions used in the prior art.

8. The prior art CSV format reports can be very tedious to review, or to extrapolate data, based on the individual's specific interests. The individual must separately locate the CSV format files each time the report is run, and must have knowledge of MS Excel or Access, or other advanced query processing software to further analyze the data.

9. The prior art software does not easily archive data in a printer friendly format. The prior art currently gives a user the option to access a “Trend Report,” which displays all information for all keywords for all search engines since the first report was run. Within a few months, the “Trend Report” could amount to as many as 300 pages or more in printed format, which makes it very burdensome to review and comprehend in a time-efficient manner.

10. The prior art software does not enable reports to be automatically posted for review by its users on a Web-based interface.

11. The prior art software does not allow multiple URL analysis amongst many client reports.

12. The prior art software does not enable various reports that enable the user to extrapolate specific reports based on a particular keyword phrase, and/or a particular search engine, according to the client's needs.

13. The prior art software includes a “doorway page” tool, search engine submission tool, and metatag generator, each of which are generally disfavored by the search engine industry because of misuse of these tools by some Webmasters and SEO professionals.

14. The prior art software has also received criticism from search engine operators because some Webmasters and other SEO individuals may use the prior art software to check search engine positions on a frequent basis, which constrains valuable and limited resources at the search engine.

15. The prior art software does not allow further recommendations and/or comments based on search engine position results, to be displayed within the same report.

16. The prior art software does not allow Webmasters and SEO professionals to manage multiple clients and the resulting data, in a time-efficient manner.

17. The prior art software does not allow for easy review of historical data or present trending information in graphical format.

18. The prior art software does not allow for easy review of keyword visibility improvements, drops, and/or isolation of rankings without display of additional URL information.

19. The prior art software does not allow for SEO professionals to offer additional recommendations as it relates to keywords promoted, visibility, and incoming Web site traffic.

20. The prior art software does not allow for easily determining the relationship between keywords promoted by SEO professionals and actual resulting Web site traffic.

21. The prior art software does not allow for a time-efficient summary of Web site traffic logs.

22. The prior art software does not allow users of the data to track any type of correspondence related to recommendations, comments and/or action items on which to proceed, approve, or act on a monthly basis.

23. The prior art allows submitters to embed software code into their web site to draw a relationship between keyword visibility and resulting traffic and/or resulting sales. However, the prior art cannot relate keyword visibility to traffic or resulting sales without resorting to embedded code.

Therefore, a need exists for a system and method for monitoring a Web site's keyword visibility in search engines and directories that overcomes the problems and limitations of the prior art. A need exists to review the data on a Web-based system, to allow multiple users to easily access and review current and historical reports. A need also exists to automatically relate and analyze data generated by Web site traffic analysis software and Web site promotional software. A further need exists to offer and to track customized recommendations by the SEO professional to its users of the data, as well as to enable users of the data to submit feedback in response to recommendations, and which action items to proceed on a monthly basis using the Web-based system.

### SUMMARY

According to the present invention, a system and method of using a Web accessible keyword visibility tracking and traffic analysis tool is disclosed that improves usage of the data collected by Web site promotions software program, such as WebPositionGold™, or a traffic log analysis software program, such as WebTrends®. According to a preferred embodiment of the present invention, the system and method first perform the step of establishing a relationship between the data extracted from a Web site promotions software program as well as allowing Web-based access to current and historical Web site promotions software program data, and the present invention's software, where the present invention's software automatically sorts the collection of a Web site's keyword visibility data collected by a Web site promotions software program. Then, a step is performed using an Agent that populates a database according to predetermined rules and parameters set forth by the SEO professional and/or by the end user. The Web accessible system and method according to the present invention then offers recommendations based on rules determined by the SEO professional. The system and method provide monthly summaries on keyword visibility, recommendations on whether to submit or not to re-submit, whether to bid or not to bid where paid placement may be necessary in order to achieve first page listings, and related action items comprising: URL submissions and/or registrations, and additional comments by an SEO professional using the system and method of the present invention. Users of the data also have the option of submitting feedback through the Web-based system in response to recommendations and proposed action items.

Lastly, a step is performed by establishing a relationship between the data extracted from a Web site promotions software program and the data extracted from a traffic log analysis software program on a monthly basis. The system and method of the present invention provide monthly keyword visibility and traffic analysis, calculate percentage increases/decreases in monthly traffic by keyword and by search engine as it relates to a keyword's visibility in the corresponding search engine, and allow for an online return on investment calculation. The system and method of the present invention draw a direct correlation to a keyword's visibility in a search engine or directory, the number of visitors that resulted from that visibility, the number of sales, if known, for that item, and the online marketing cost of the specific product's sales. Additionally, the system and method of the present invention will retrieve data from WebTrends or equivalent Web site log software tools to allow the SEO professional and the end user to quickly identify the most popular Web site pages, the least popular Web site pages, search engines that drive traffic to those pages, and the impact a keyword's visibility has on traffic to a specific Web page within a specific Web site. Additional site recommendations will be made by the SEO professional or Website traffic analysis professional through the administrative area, which will be displayed to the end user through the Web-based system.

### BRIEF DESCRIPTION OF THE DRAWINGS

Further features of the present invention will become apparent to those skilled in the art to which the present invention relates from reading the following specification and claims, with reference to the accompanying drawings, in which:

FIG. 1 is a system diagram of a prior art system;

FIGS. 2A and 2B are block diagrams of a system according to preferred embodiments of the present invention;

FIG. 3 is schematic diagram of the system in FIGS. 2A and 2B;

FIG. 4 is a flow chart showing a data collection, processing, and storage method according to a preferred embodiment of the present invention occuring in Section E in FIG. 3;

FIG. 5 is a flow chart showing a client set up method according to a preferred embodiment of the present invention occuring in Section D and E in FIG. 3;

FIG. 6 is a flow chart showing a client data summarizing method according to a preferred embodiment of the present invention occuring in Section D in FIG. 3;

FIG. 7 is a flow chart showing method for an end user to login according to a preferred embodiment of the present invention occuring in Section A in FIG. 3;

FIG. 8 is a flow chart showing a method for an end user to retrieve feedback data according to a preferred embodiment of the present invention occuring in Section A in FIG. 3;

FIG. 9 is a flow chart showing a method for an end user to retrieve keyword visibility graph data according to a preferred embodiment of the present invention occuring in Section A in FIG. 3;

FIG. 10 is a flow chart showing a method for an end user to retrieve keyword visibility improvement data according to a preferred embodiment of the present invention occuring in Section A in FIG. 3;

FIG. 11 is a flow chart showing a method for an end user to retrieve keyword visibility drops data according to a preferred embodiment of the present invention occuring in Section A in FIG. 3;

FIG. 12 is a flow chart showing a method for an end user to retrieve (keyword) KW Matrix data according to a preferred embodiment of the present invention occuring in Section A in FIG. 3;

FIG. 13A is a flow chart showing a method for an end user to login to retrieve keyword visibility summary data according to a preferred embodiment of the present invention occuring in Section A in FIG. 3;

FIG. 13B is a flow chart showing a method for an end user to retrieve keyword visibility summary data according to a preferred embodiment of the present invention occuring in Section A in FIG. 3;

FIG. 14 is a flow chart showing a method for an end user to retrieve KW Detail data according to a preferred embodiment of the present invention occuring in Section A in FIG. 3;

FIG. 15 is a flow chart showing a method for an end user to retrieve URL submission report data according to a preferred embodiment of the present invention occuring in Section A in FIG. 3;

FIG. 16A is a flow chart showing a method to access and use an administrative tool according to a preferred embodiment of the present invention occuring in Section D and E of FIG. 3;

FIG. 16B is a flow chart showing a method to access and use a client administration tool in the administrative tool of FIG. 16A occuring in Section D and E of FIG. 3;

FIG. 16C is a flow chart showing a method to access and use a client detail tool in the client administrative tool of FIG. 16B occuring in Section D and E of FIG. 3;

FIG. 16D is a flow chart showing a method to access and use a keyword administration tool in the client administrative tool of FIG. 16B occuring in Section D and E of FIG. 3;

FIG. 16E is a flow chart showing a method to access and use a feedback administration tool in the administrative tool of FIG. 16A occuring in Section D and E of FIG. 3;

FIG. 16F is a flow chart showing a method to access and use a global message administration tool in the administrative tool of FIG. 16A occuring in Section D and E of FIG. 3;

FIG. 16G is a flow chart showing a method to access and use a search engine administration tool in the administrative tool of FIG. 16A occuring in Section D of FIG. 3 occuring in Section D and E of FIG. 3;

FIG. 16H is a flow chart showing a method to access and use a refresh ranking report administration tool in the administrative tool of FIG. 16A occuring in Section D and E of FIG. 3;

FIG. 16I is a flow chart showing a method to access and use a failed reports administration tool in the administrative tool of FIG. 16A occuring in Section D and E of FIG. 3;

FIG. 16J is a flow chart showing a method to access and use a summary administration tool in the administrative tool of FIG. 16A occuring in Section D and E of FIG. 3; and

FIGS. 17A-T are screen shots of various screens generated by a system and method according to a preferred embodiment of the present invention.

### DESCRIPTION OF THE PREFERRED EMBODIMENT(S)

As is shown in the Figures, the system and method according to preferred embodiments of the present invention are shown. Preferably, the system and method provide end users the ability to archive data for extended periods.

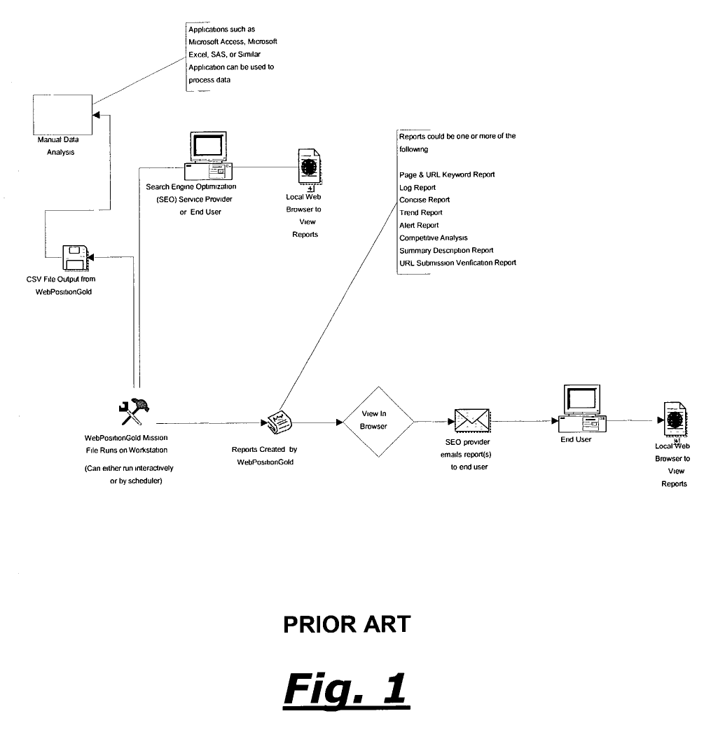

The prior art is shown in FIG. 1. As can be seen, elements of the necessary information regarding key word visibility and web site traffic may be collected. However, the SEO professional must manually review and analyze the data, a slow and cumbersome process.

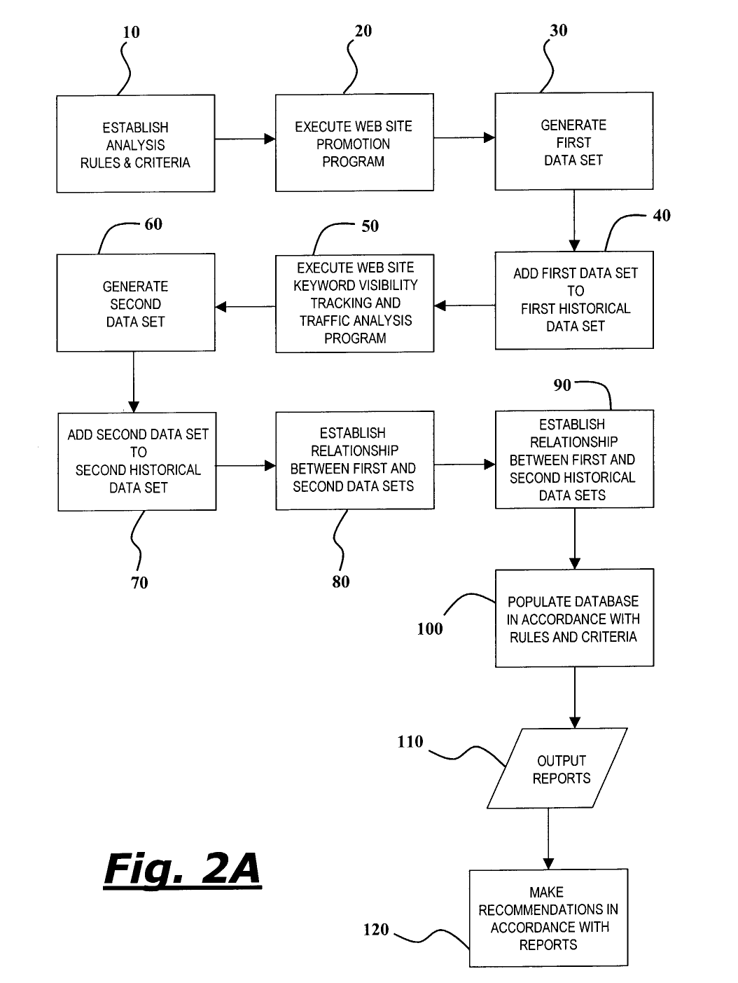

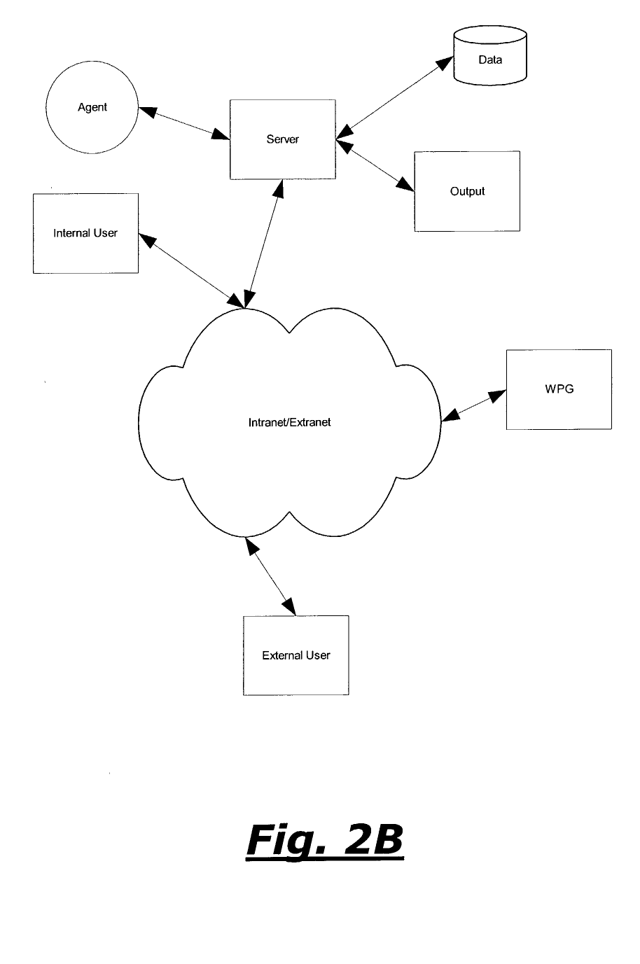

FIG. 2A shows an overview of a preferred embodiment of the present invention. At step 10, the SEO professional or user establishes a set of rules and criteria for Web site analysis. The criteria may include, but are not limited to, the keywords used, the volume of traffic for the web page, data, competitor information, feedback, and the types and categories of sales resulting from the traffic. Rules may include, but are not limited to, minimum and maximum thresholds, comparisons, ranking, decisions, trends, analyses, and alerts. At step 20, a web site promotion software program such as WebPositionGold™ is executed to obtain information regarding the web site usage, including, but not limited to, the web site's position on search engines, Web site visitor information, and referring pages for Web site visitors. The output of the program execution at step 20 is a first set of data at step 30. The first set of data is added to a first historical data set at step 40 in order to produce a running record of data over a predetermined length of time. At step 50, a Web site keyword visibility tracking and traffic analysis program such as WebTrends® is executed, producing a second data set at step 60. The second data set contains information on visitors to the web site, including, but not limited to, the number of visitors, the number of repeat visitors, content areas visited within the Web site, and conversion of Web site processes such as registration and check out. The second data set is added to a second historical data set at step 70 in order to produce a running record of data over a predetermined length of time. At step 80, the first and second data sets 30, 60 are concurrently examined and a relationship between data in the first and second data sets is established in accordance with the rules and criteria established at step 10. Similarly, the first and second historical data sets 40, 70 are examined and a relationship is established between the first and second historical data sets at step 90. At step 100, a database is populated with related data from the first and second data sets 30, 60 and the first and second data historical sets 40, 70. The database 100 may then be used at step 110 to produce reports in accordance with the rules and criteria established at step 10. At step 120 a SEO professional or other user may make recommendations for improving the Web site's ranking for search engines, based on the reports produced at step 110.

FIG. 2B illustrates an overview of the general arrangement of a preferred embodiment of the present invention.

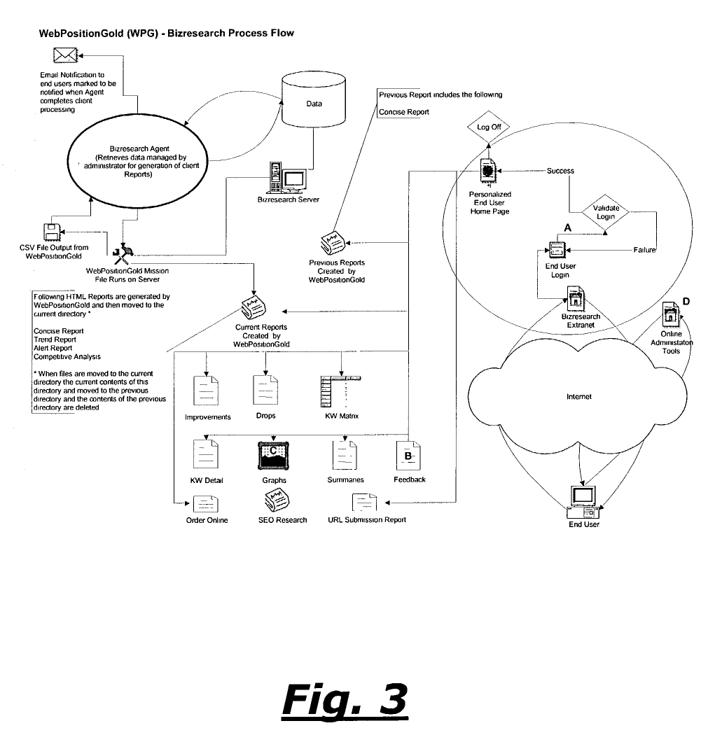

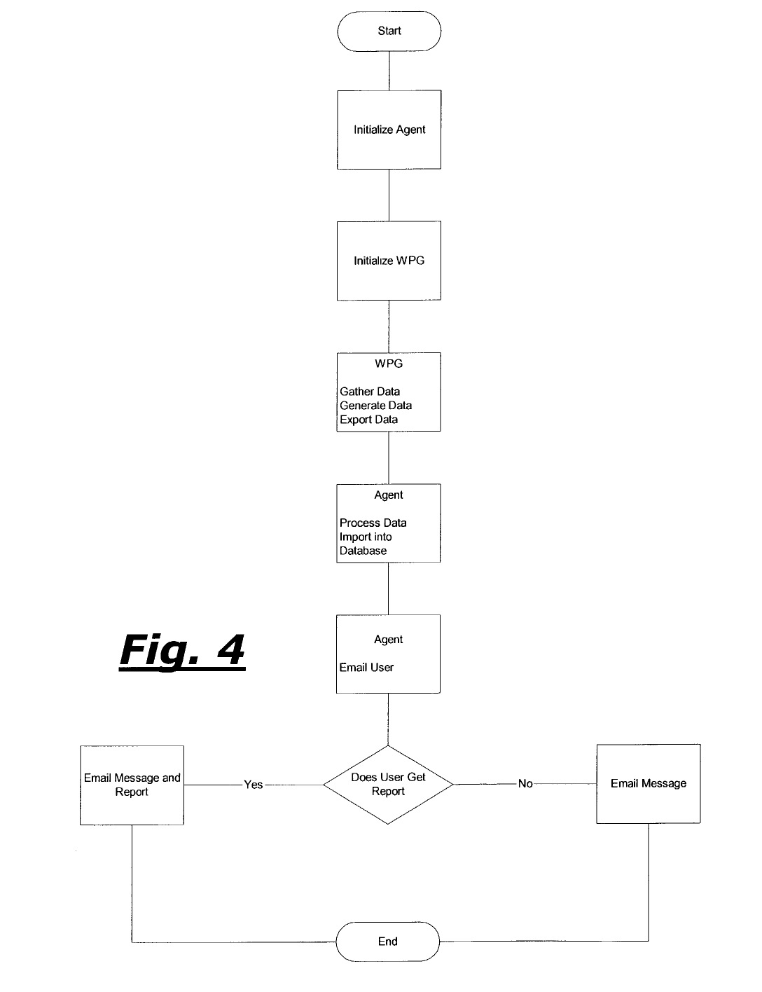

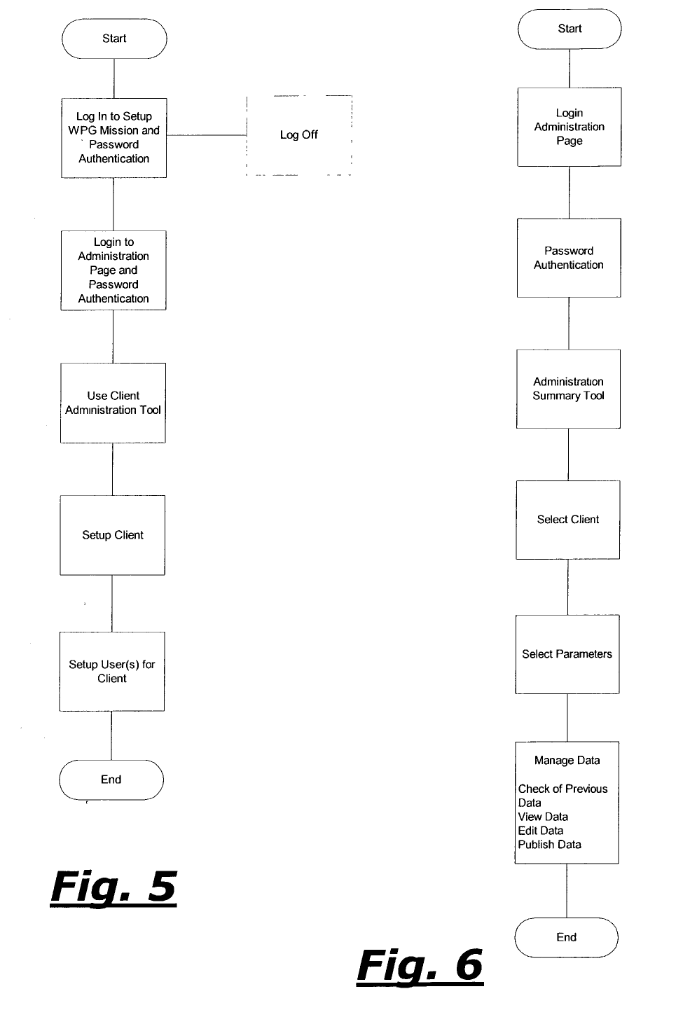

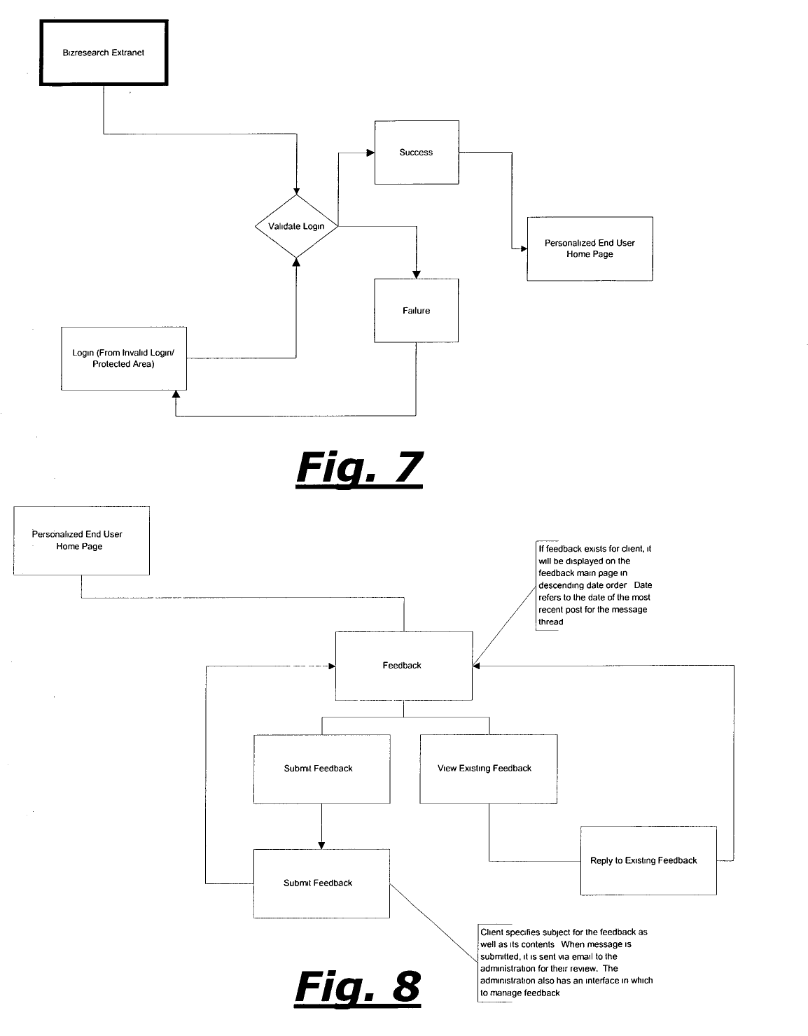

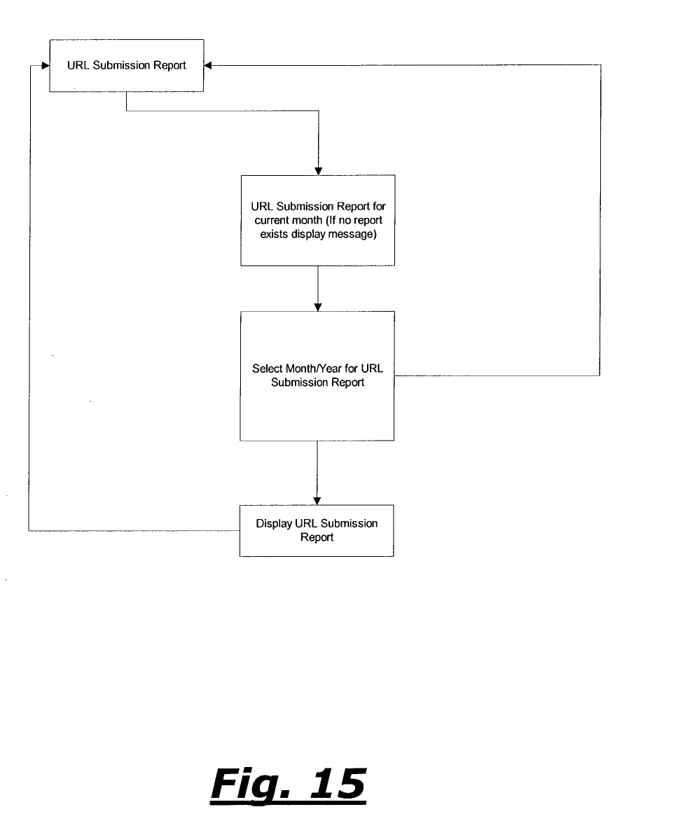

As shown in FIGS. 3 and 8-15, preferably the system and method provide end users the ability to identify and isolate data, according to the following predetermined parameters.

As seen in FIG. 8, the end-user now has the ability to submit feedback to, or request customer service from, the SEO professional.

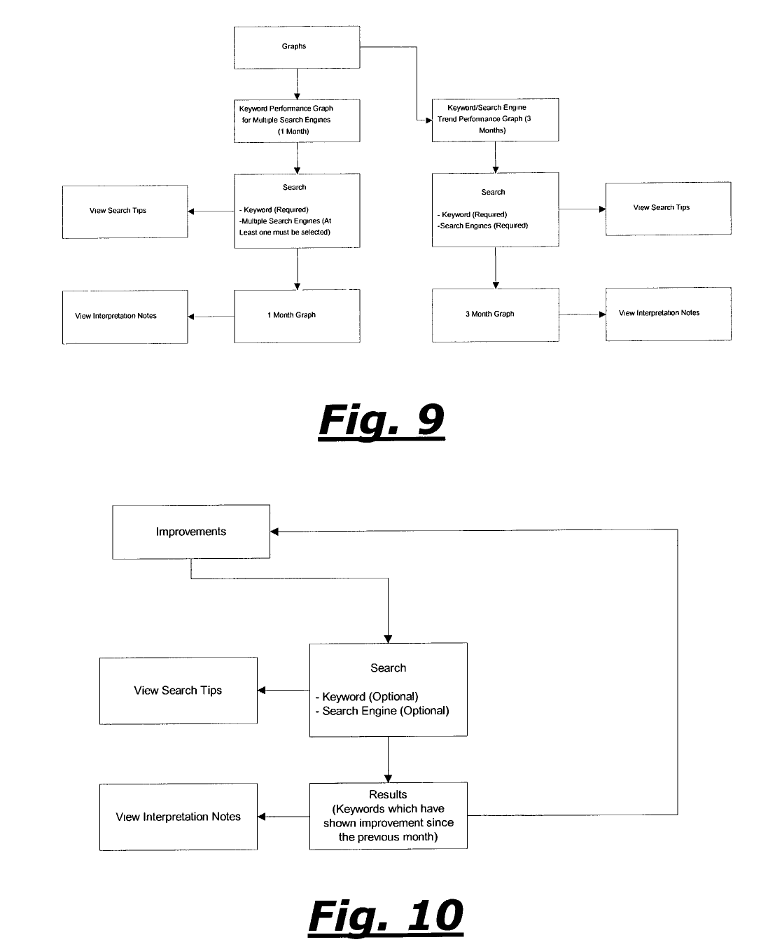

As shown in FIG. 9, a first parameter for showing a keyword performance bar graph, which has the ability to display keyword visibility in easy-to-view graphical format. This first parameter also has the ability to further limit data by: adding search tips; selecting one or all keywords in drop-down box; selecting one or all search engines in drop-down box; adding a legend; adding mouse-over ALT tags to a temporarily display numerical value of each bar graph; and/or adding interpretation notes to the results page.

As shown in FIG. 10, a second parameter for showing keyword ranking improvements from the first date of the last month to the first date of the current month.

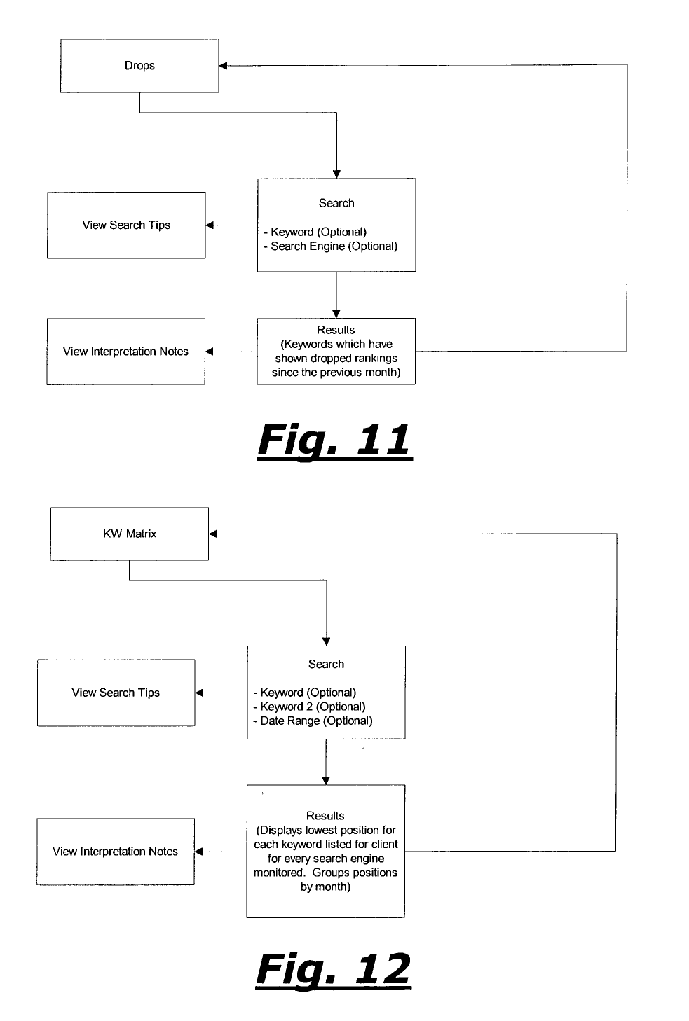

As shown in FIG. 11, a third parameter for showing keyword ranking drops from the first date of the last month to the first date of the current month.

As shown in FIG. 12, a fourth parameter for showing a keyword matrix illustrating numerical representation of keyword rankings at the first date of each month, which has the ability to limit data by either selecting or showing all keywords or selecting specific months or show all months if data was collected by the current system and method.

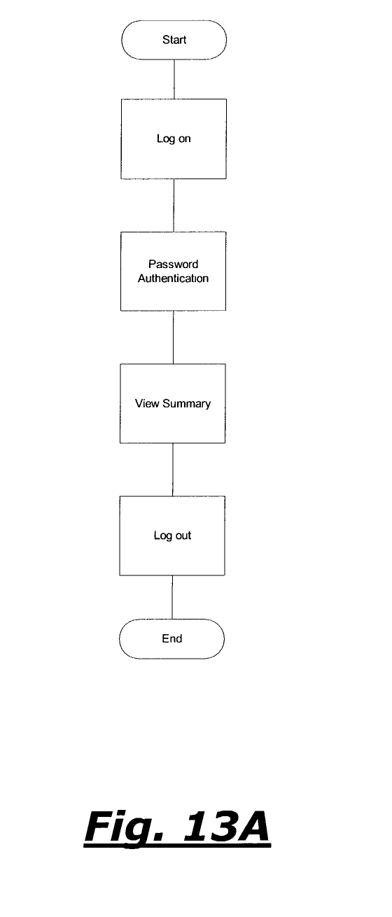

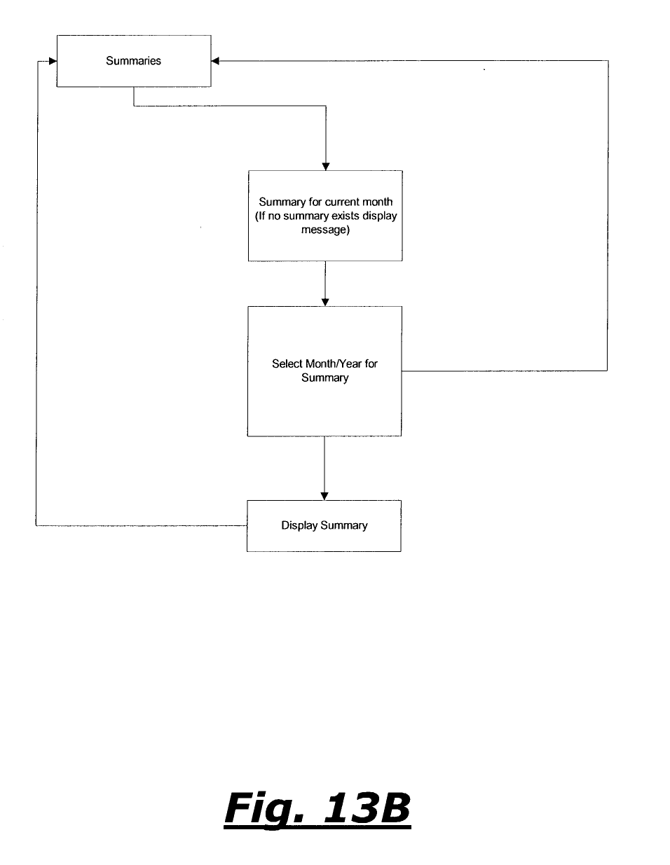

As shown in FIG. 13, a fifth parameter for showing keyword visibility summaries with the ability to view the following first through fourth types of information.

A first type of information is a list of keywords currently monitored.

A second type of information is a summary of keyword visibility according to the following: top ten (keyword ranking is displayed within the first ten search results in a particular search engine); top twenty (keyword ranking is displayed between 11-20 search results in a particular search engine); top thirty (keyword ranking is displayed between 21-30 search results in a particular search engine); needs improvement (keyword visibility is between 31-40 search results in a particular search engine); and no visibility (keyword visibility either exceeds the 40^{th} position or is not listed at all within a particular search engine).

A third type of information is automated recommendations (not shown) on how to improve keyword visibility in a particular search engine, according to the following. First, if the keyword has no visibility (either exceeds the 40^{th} position or is not listed at all within a particular search engine) then a SEO professional recommends re-submitting the end-users URL(s) to the corresponding search engine in which it has no visibility. Second, if a keyword has no visibility (see above) then a recommendation to not re-submit is made to certain directories, which do not allow multiple URL submissions to improve keyword visibility. Third, recommendations are made based on current search engine rules, procedures, or guidelines set up in Web-based administrative area by the SEO professional, including, but not limited to: relevance of Web page title; relevance of Web page source code metatags keywords; relevance of Web page source code metatags description; relevance of Web page content (copy); relevance of a particular search directory's editorial review of entire Web site; relevance of the number of external Web sites linking back to the end-user's Web site popularity (“link popularity”); and inability to resubmit to particular search engine or search directory according to existing guidelines. Fourth, the ability to insert related URL submissions through Web-based administrative area by a SEO professional. Fifth, the ability to add comments for an end user to read related to the status on the end-user's keyword visibility. Sixth, the ability to view multiple monthly summaries.

A fourth type of information is based on, first, the ability to interface with an end user without use of e-mail, which can be damaged by viruses, and otherwise increasingly unreliable e-mail servers. Second, the ability to access an end-user's historical feedback through archives. Third, the ability to receive notification through e-mail that feedback has been submitted by end user. Fourth, the ability to receive notification through e-mail that a response has been written to the feedback. Fifth, the present invention provides a SEO professional and an end-user an overall enhanced customer relationship management tool.

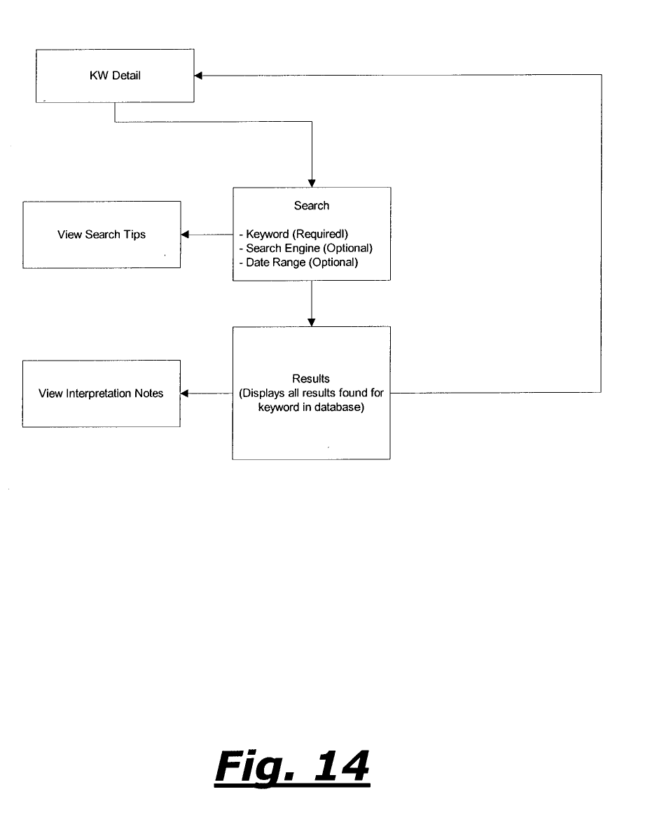

As shown in FIG. 14, a seventh parameter for showing keyword ranking detail with the ability to limit data by the end user selecting: one keyword in drop-down box; one or all search engines in drop-down box; or a date range.

As shown in FIG. 3, further parameters used to provide end users with the ability to isolate and identify data include: the ability to order additional and related services online in a secure online processing area; the ability to have access to additional research; the ability to log in and log off of multiple end user accounts; the ability to track current and historical URL submissions/registrations, whether fees were paid, and additional related information; and the ability to relate URL submissions/registrations to current and historical keyword visibility.

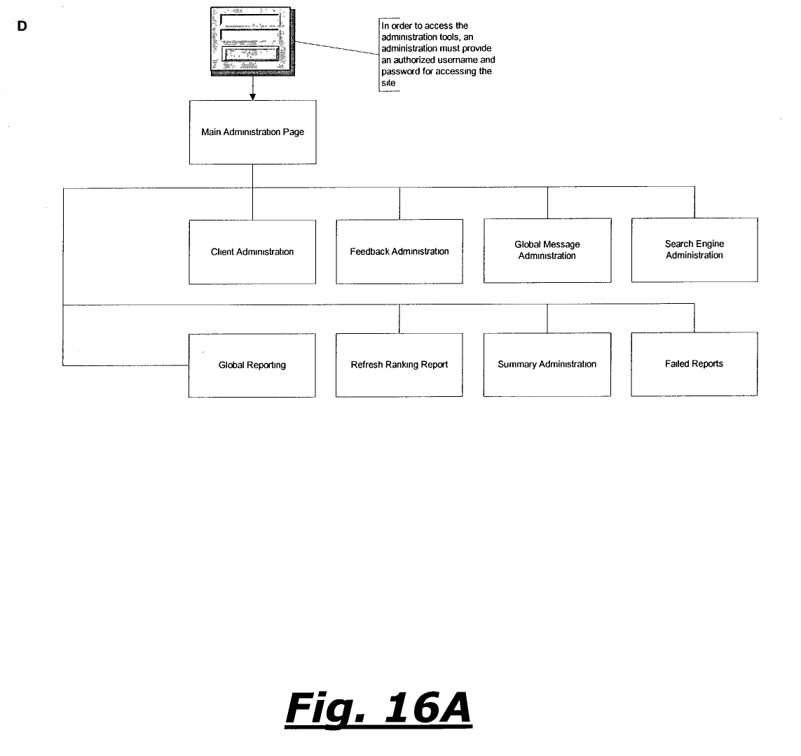

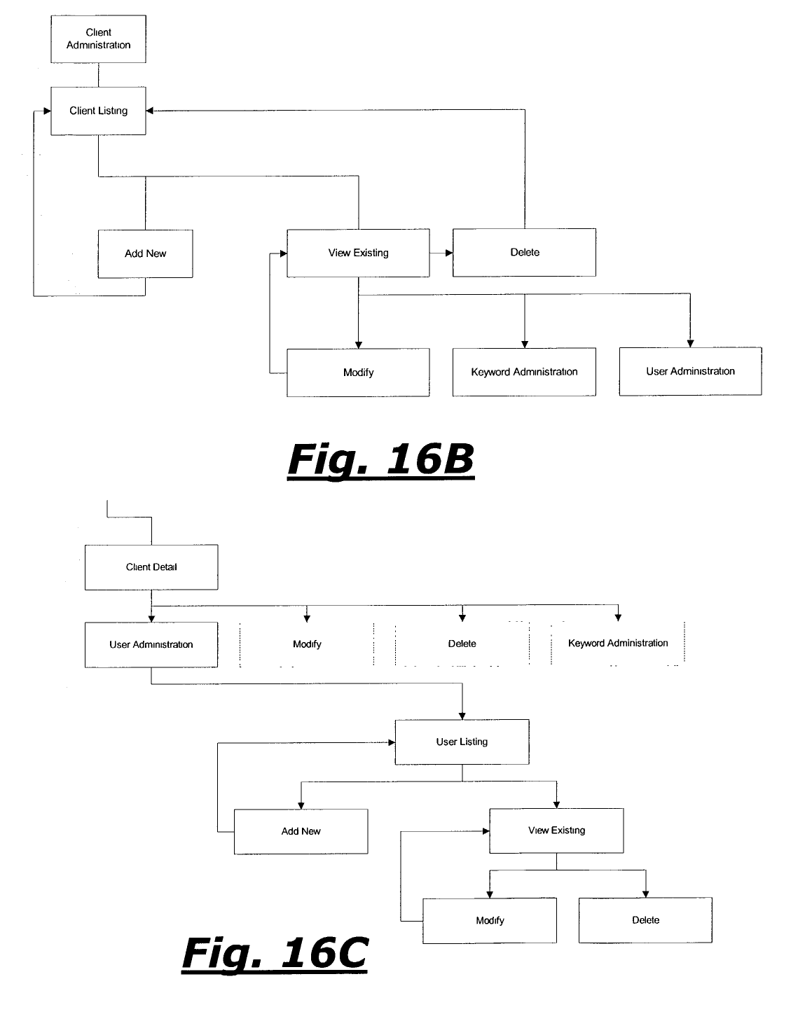

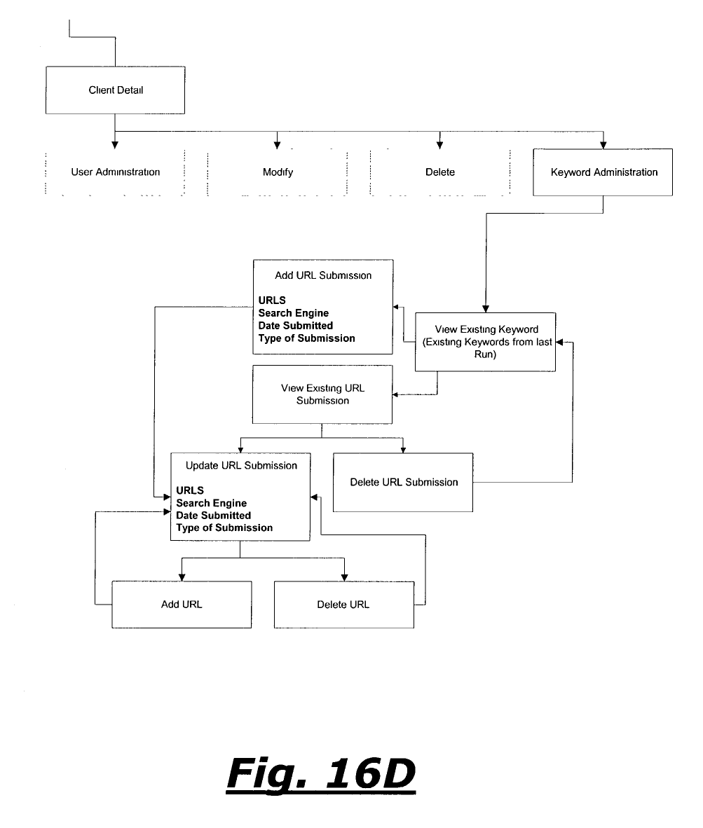

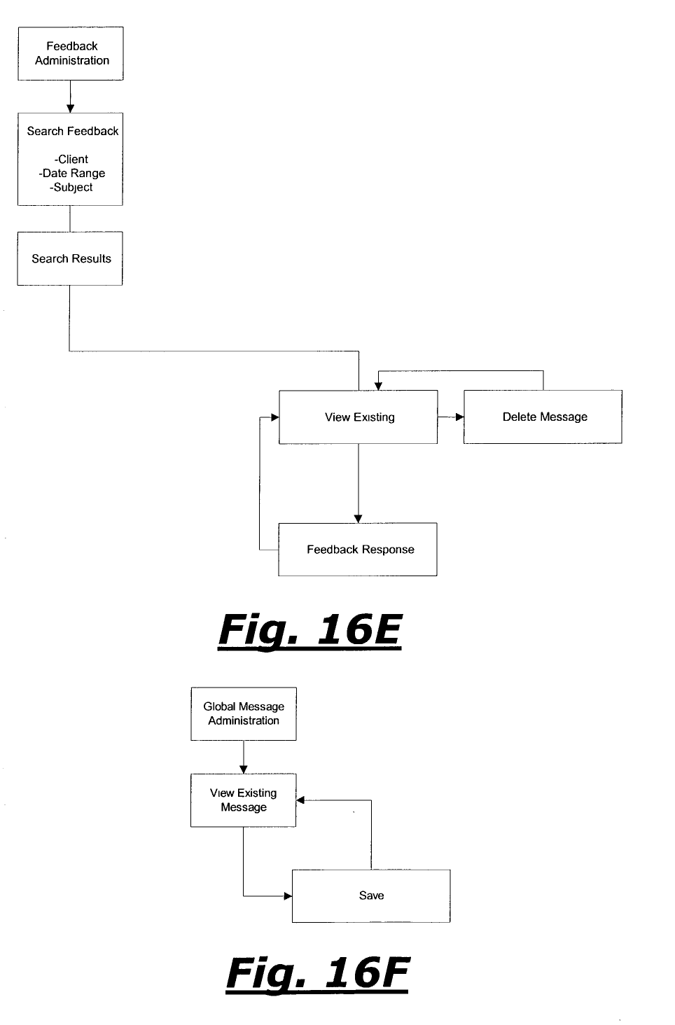

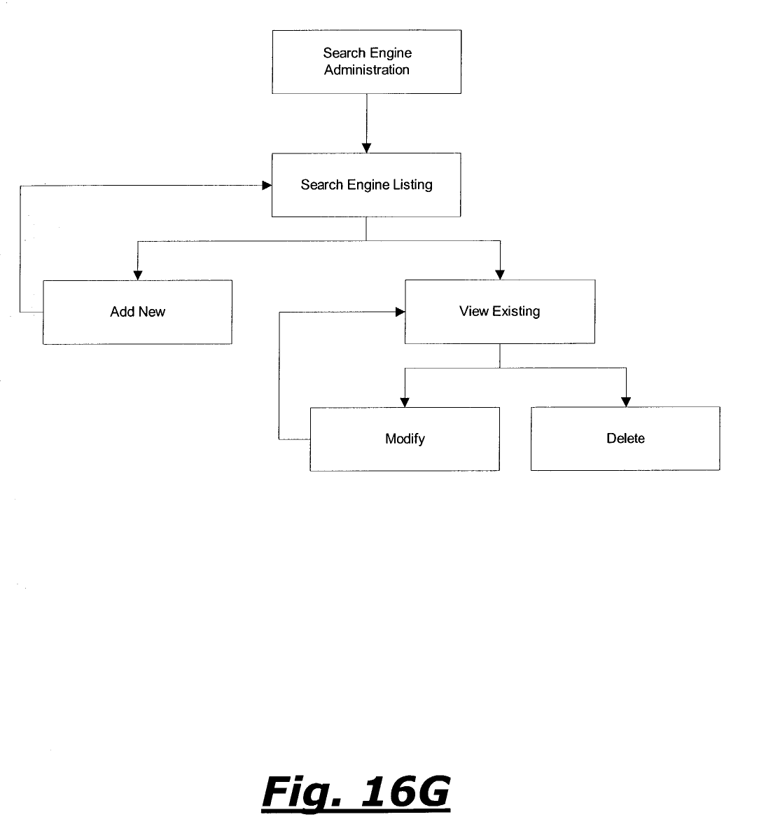

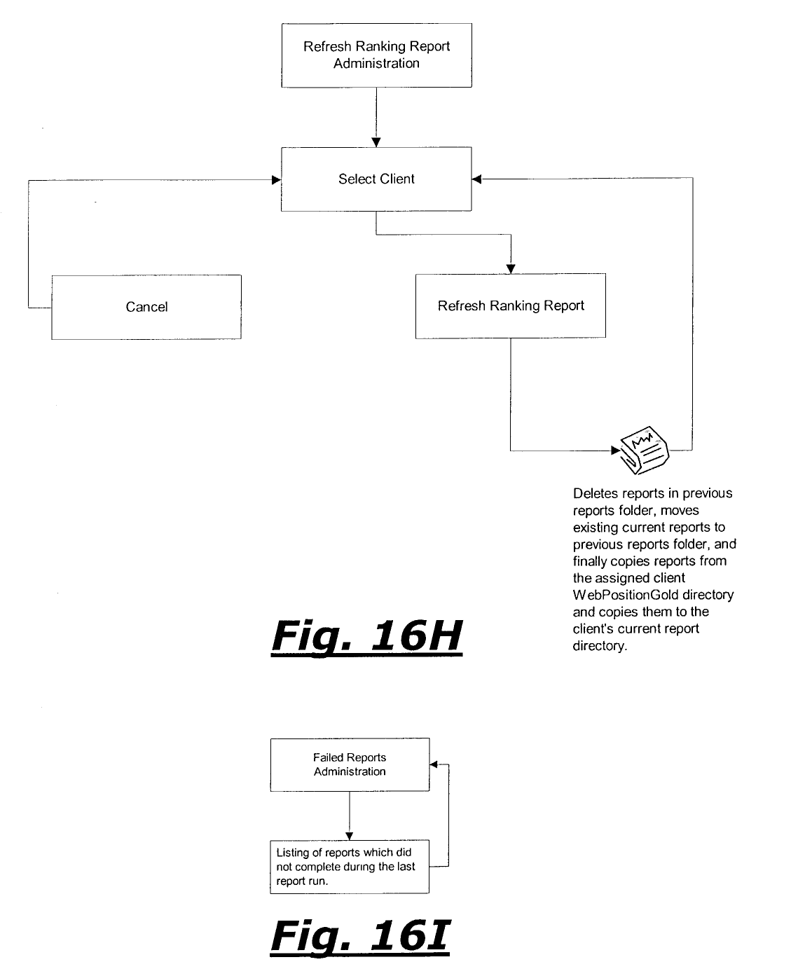

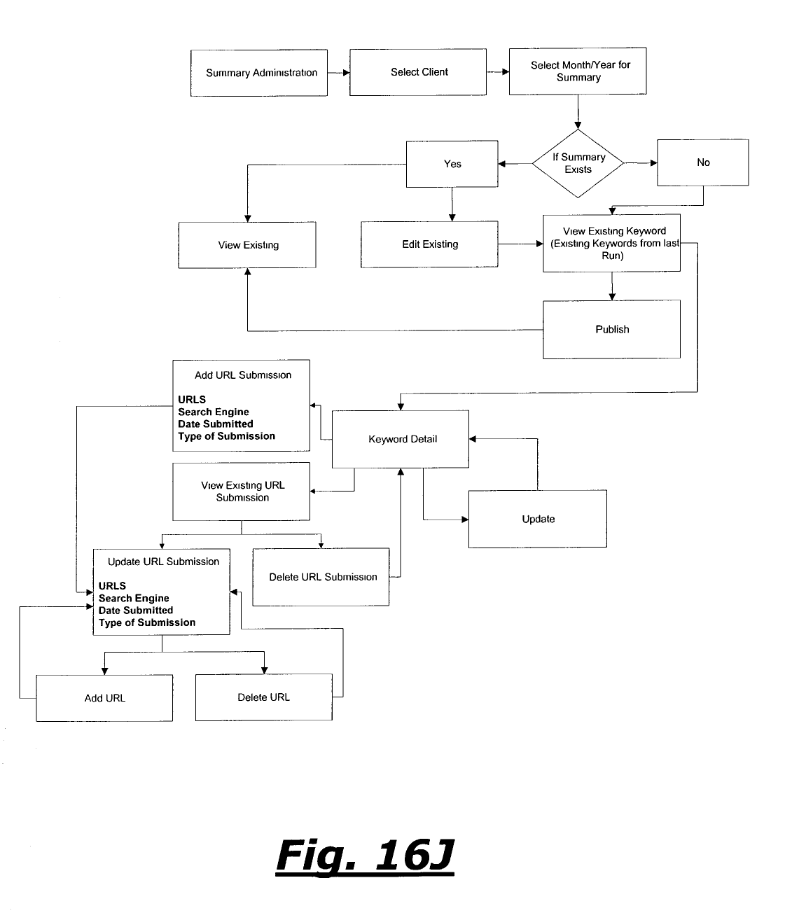

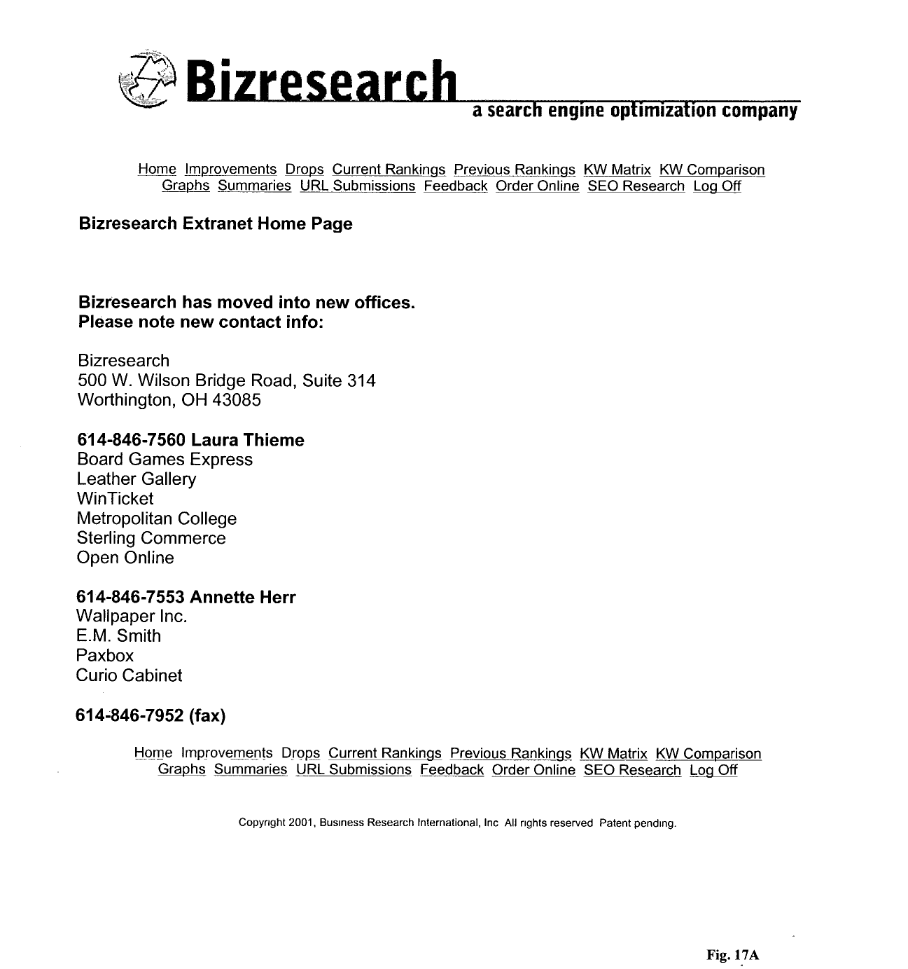

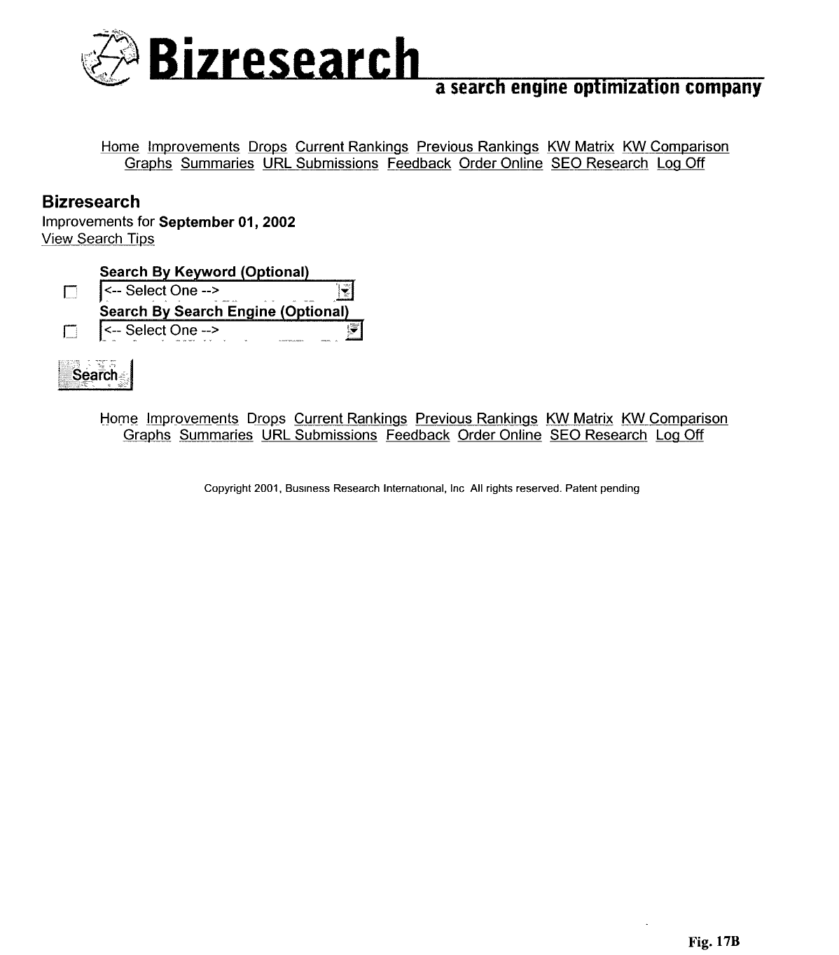

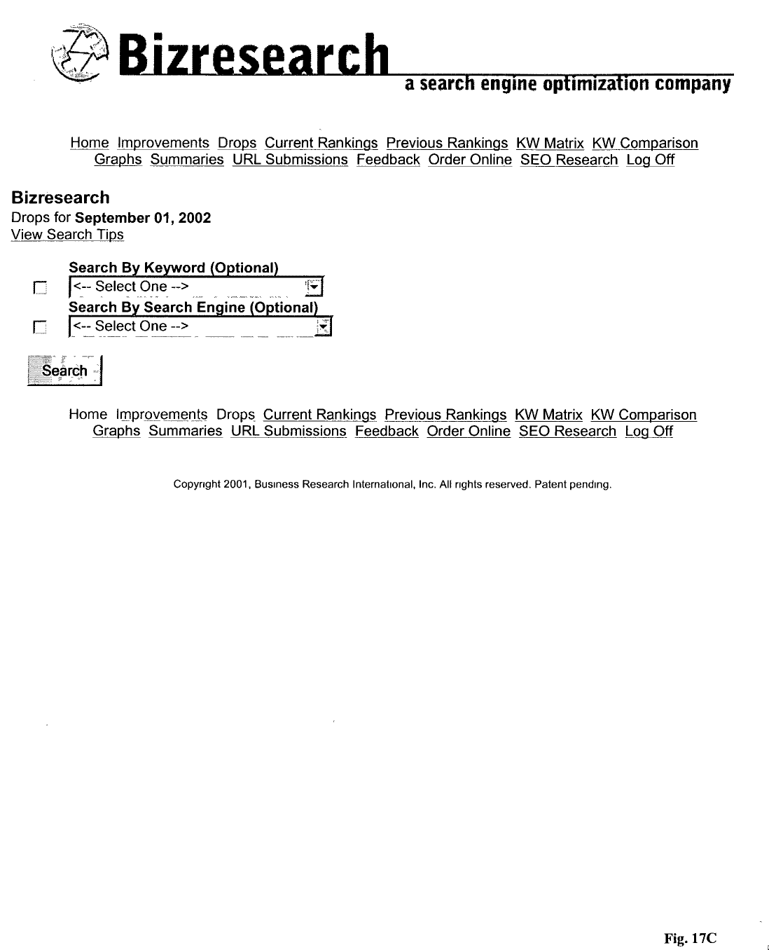

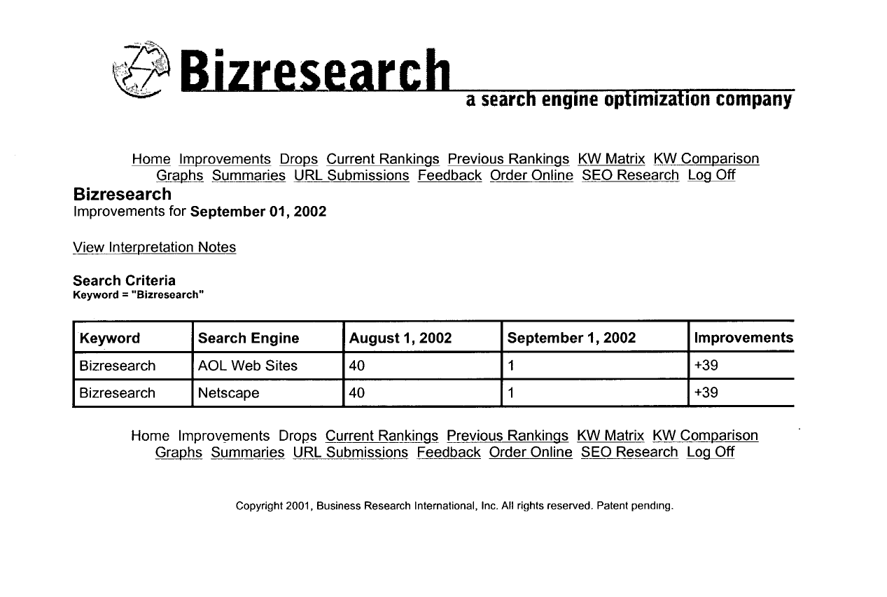

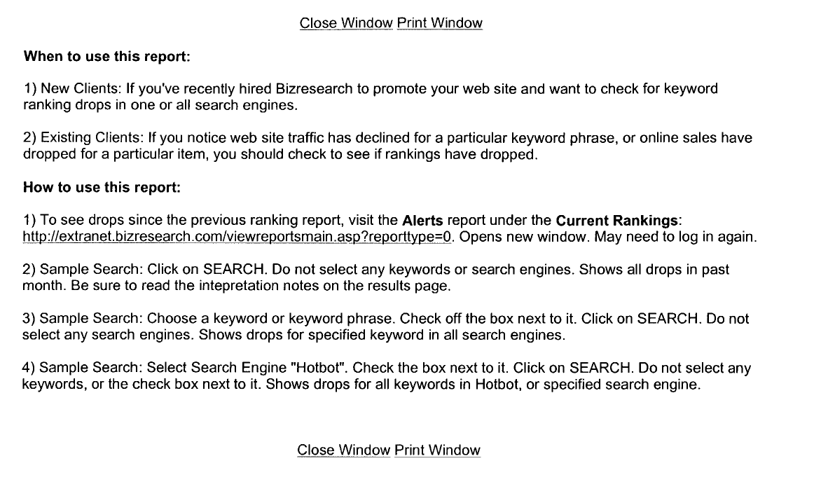

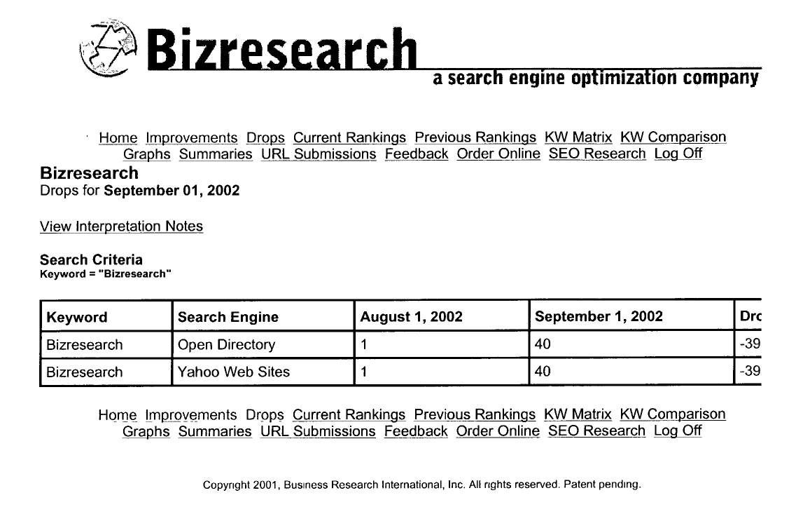

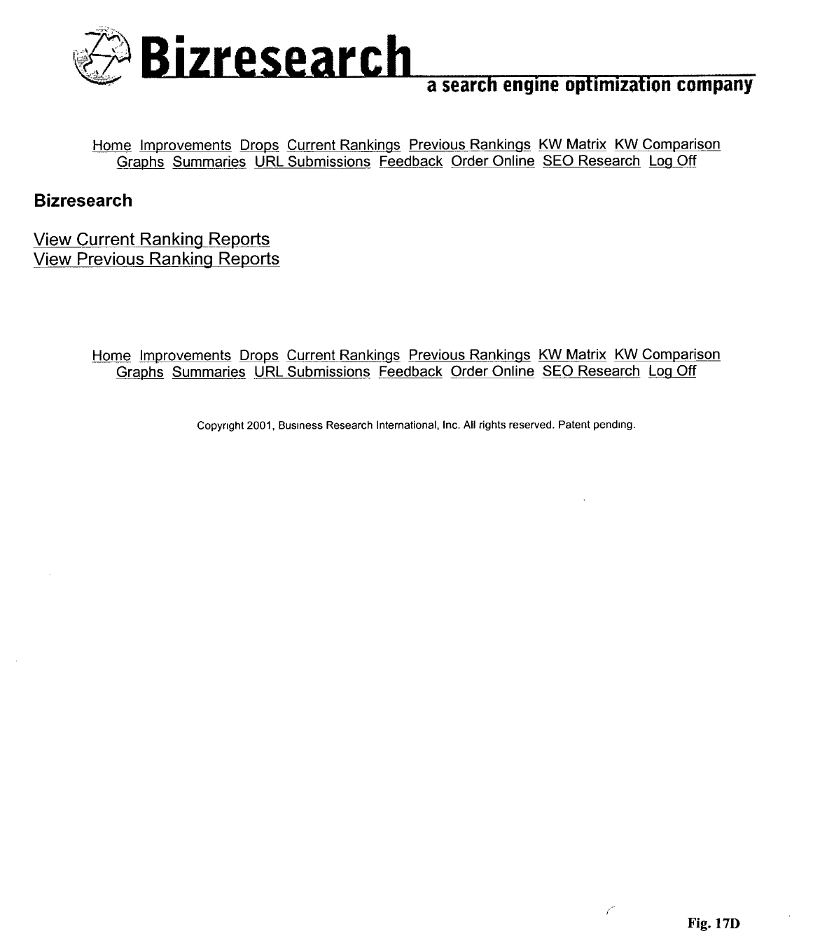

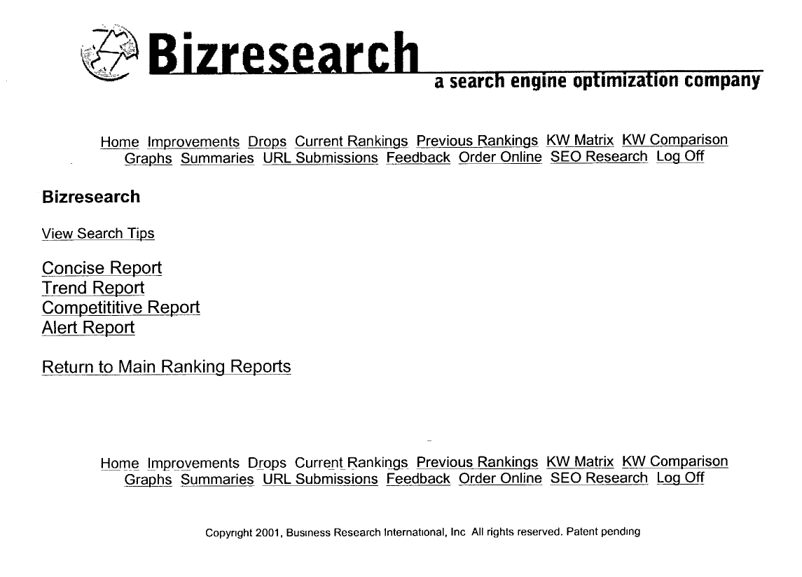

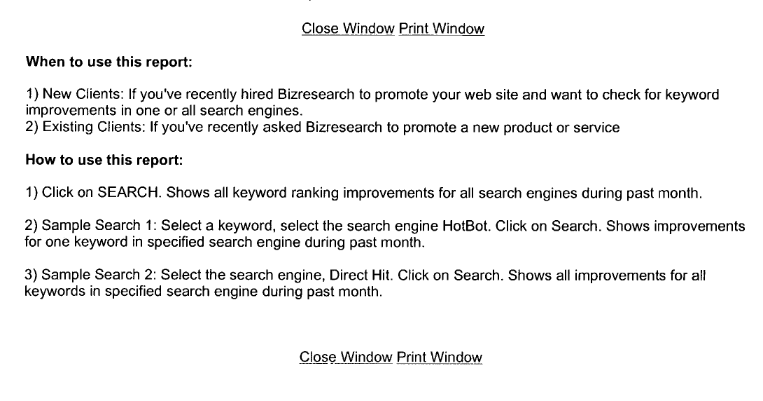

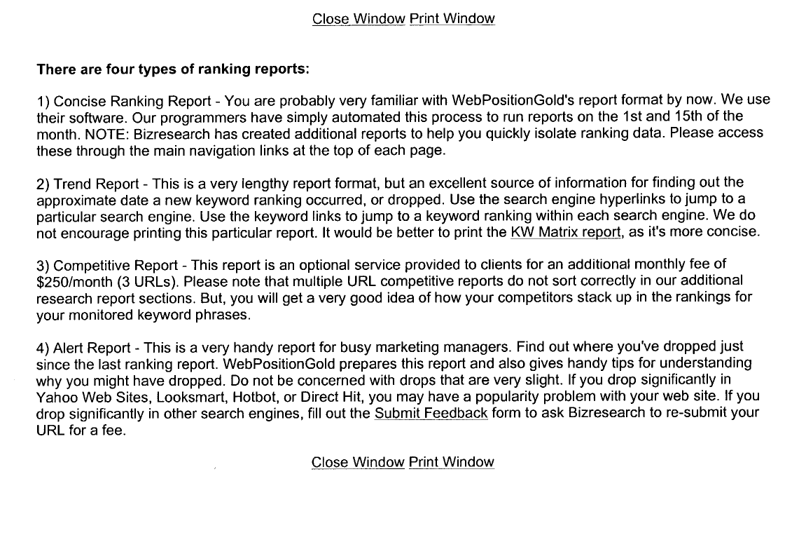

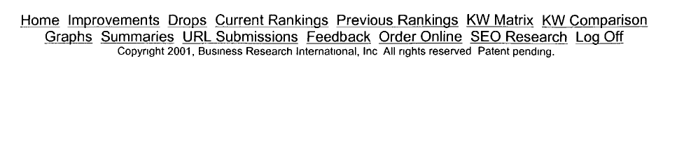

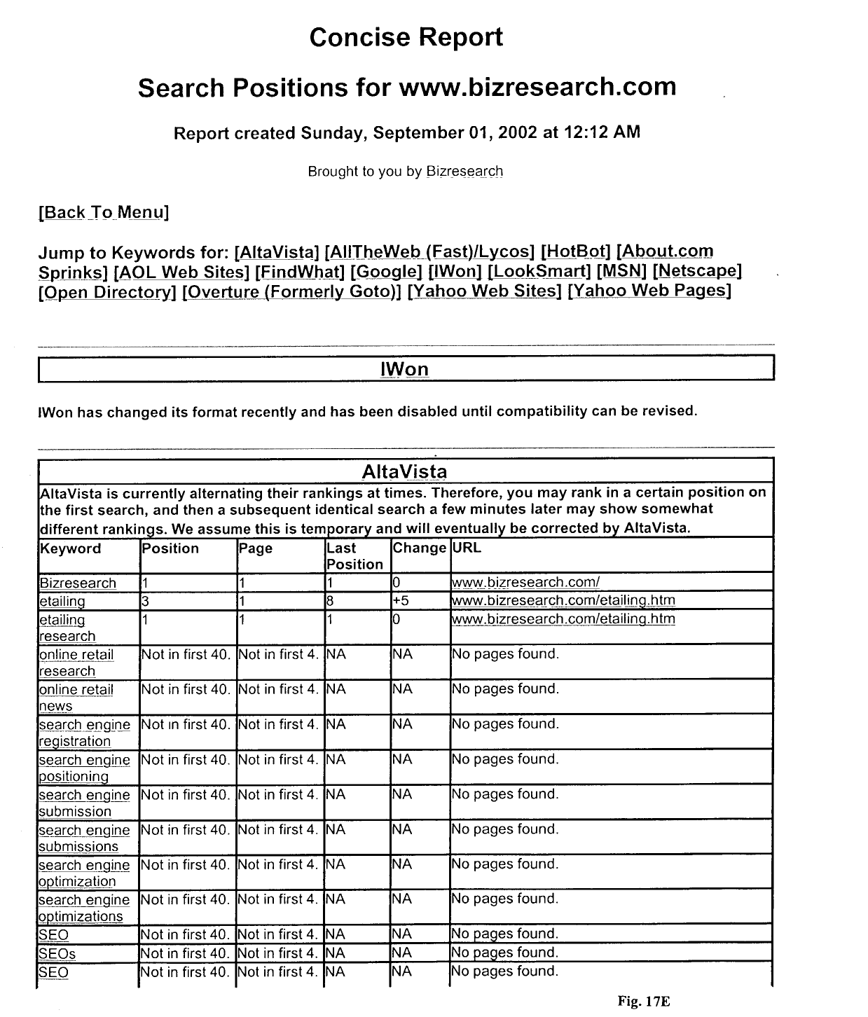

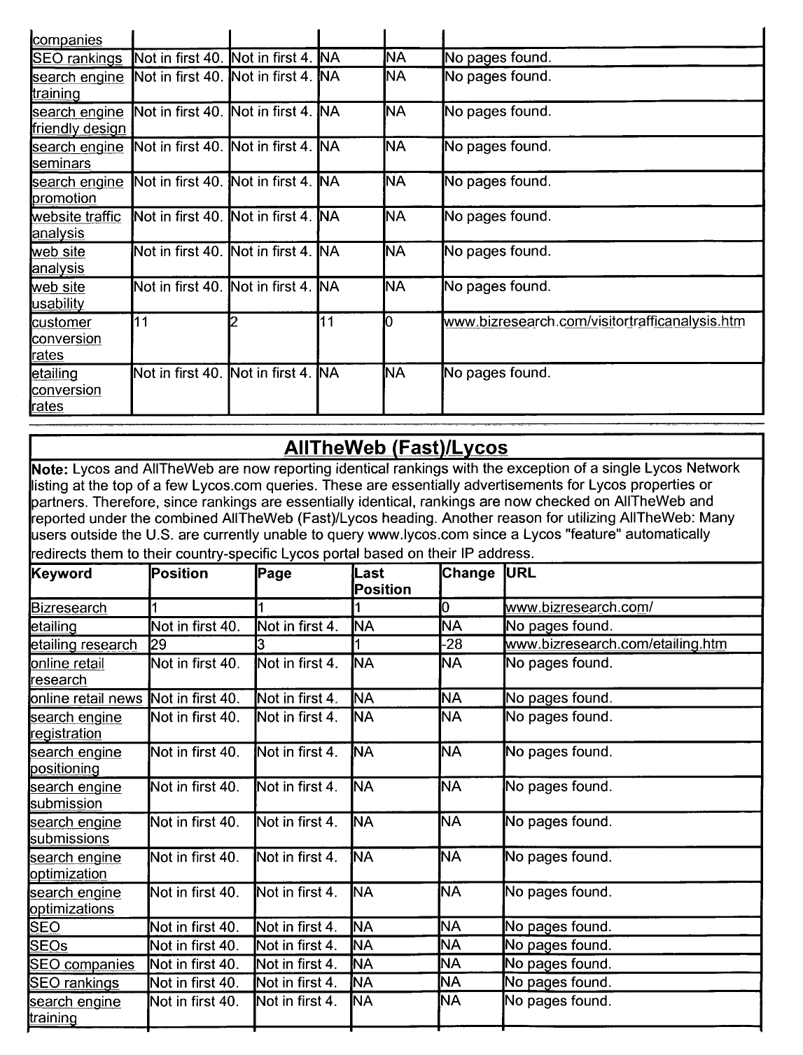

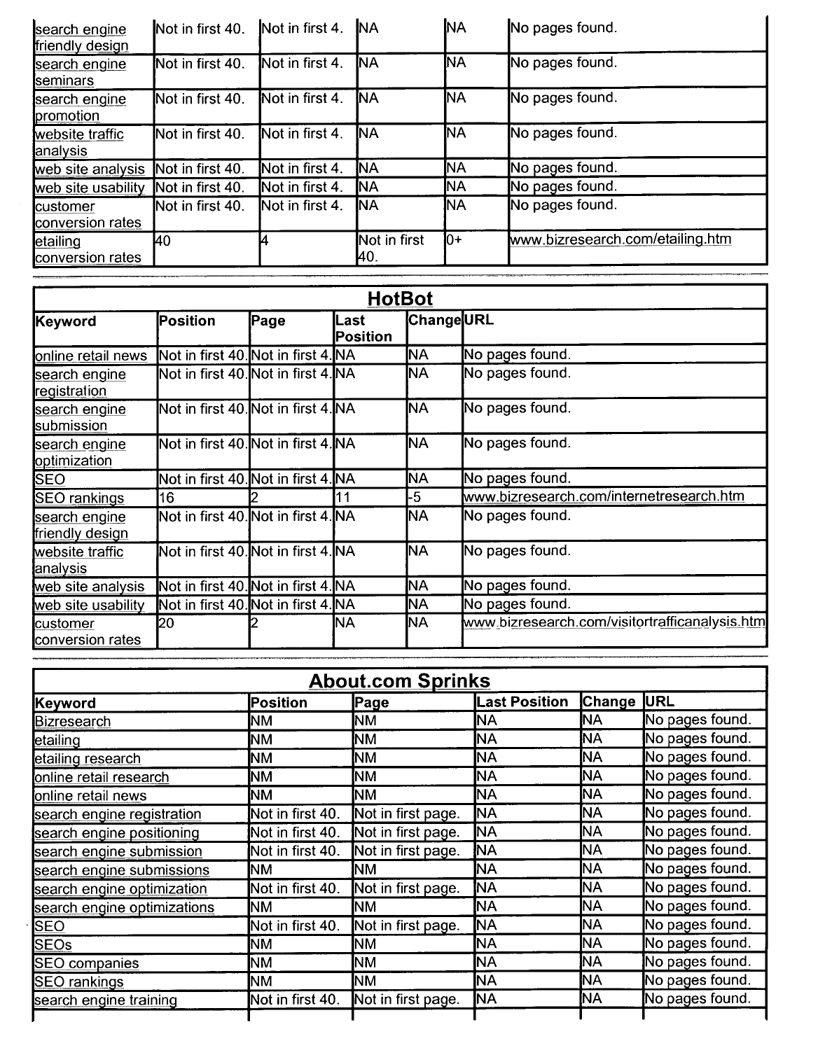

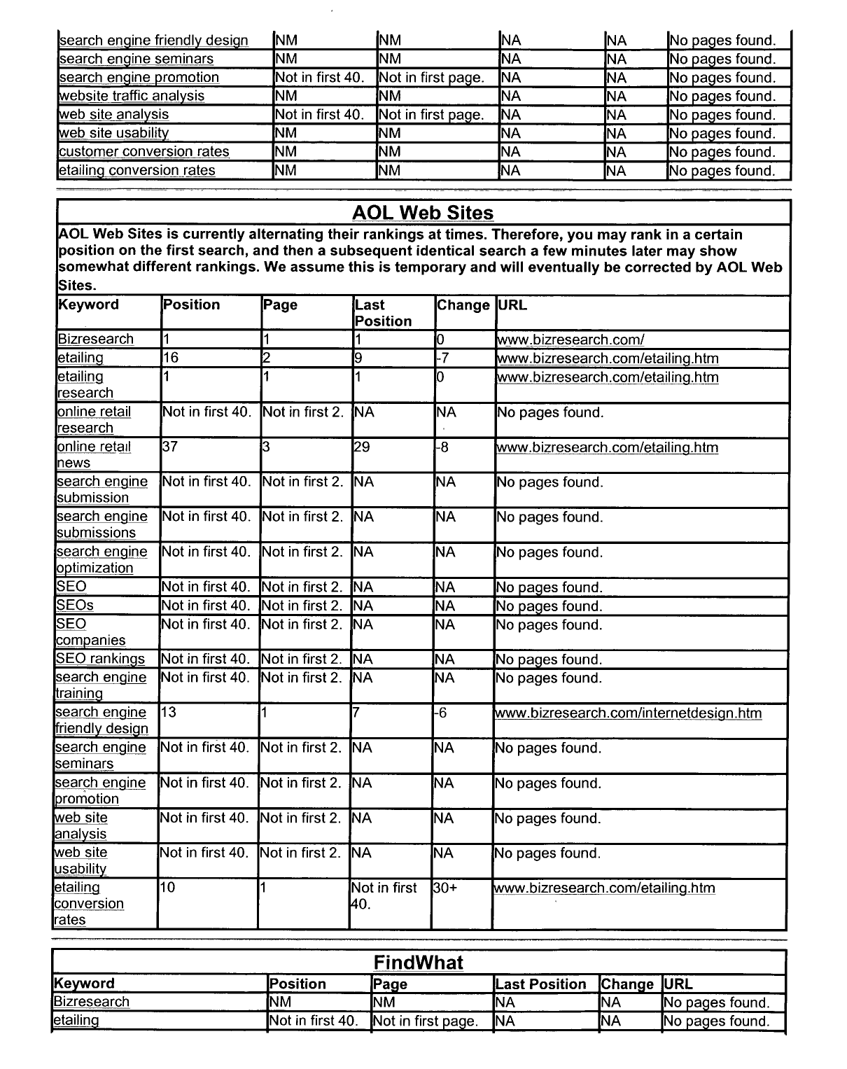

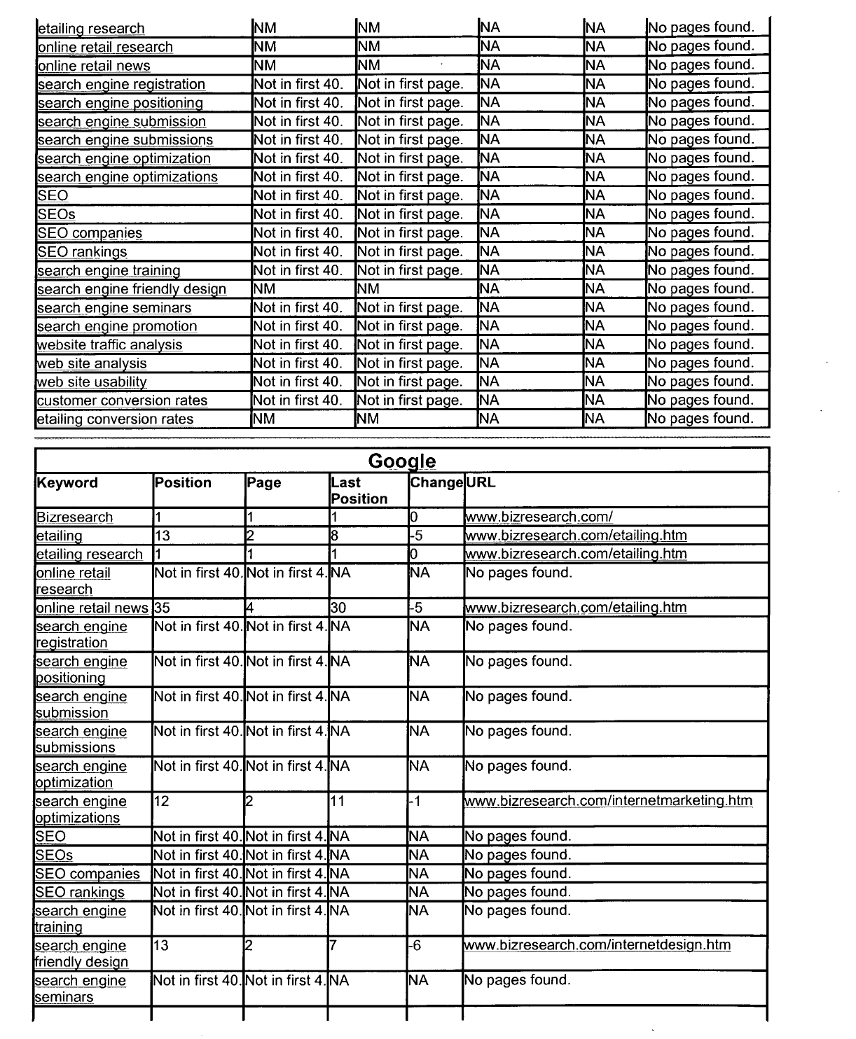

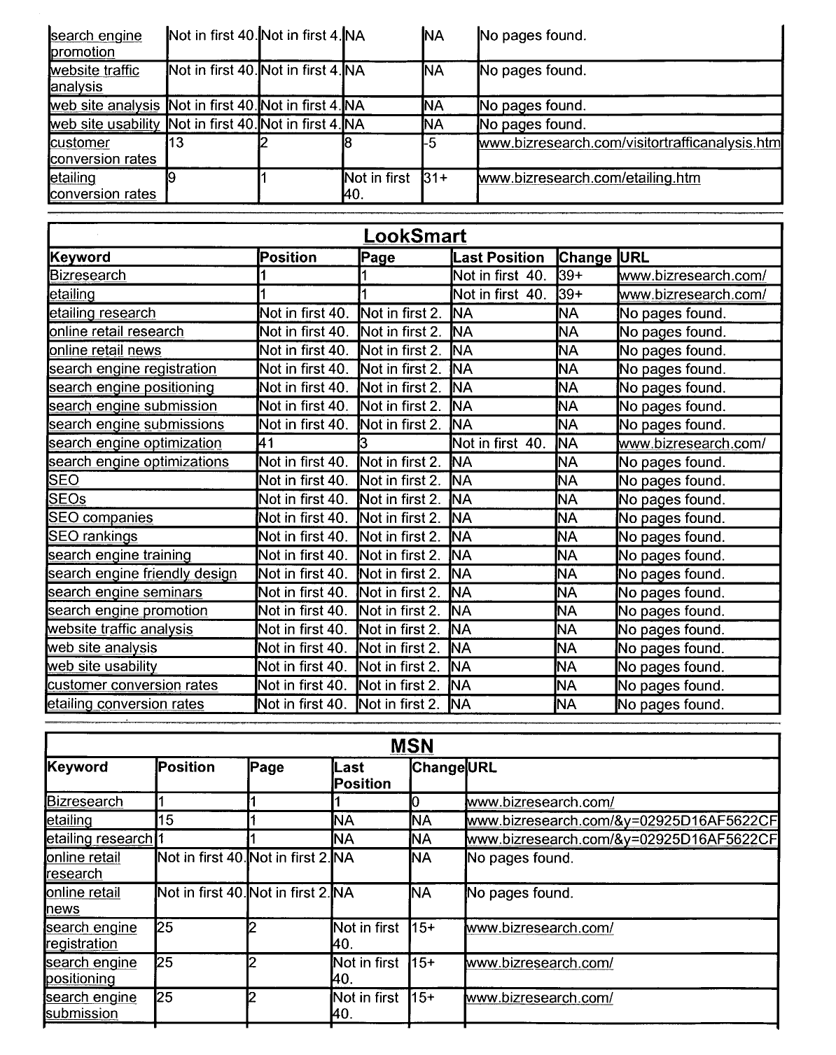

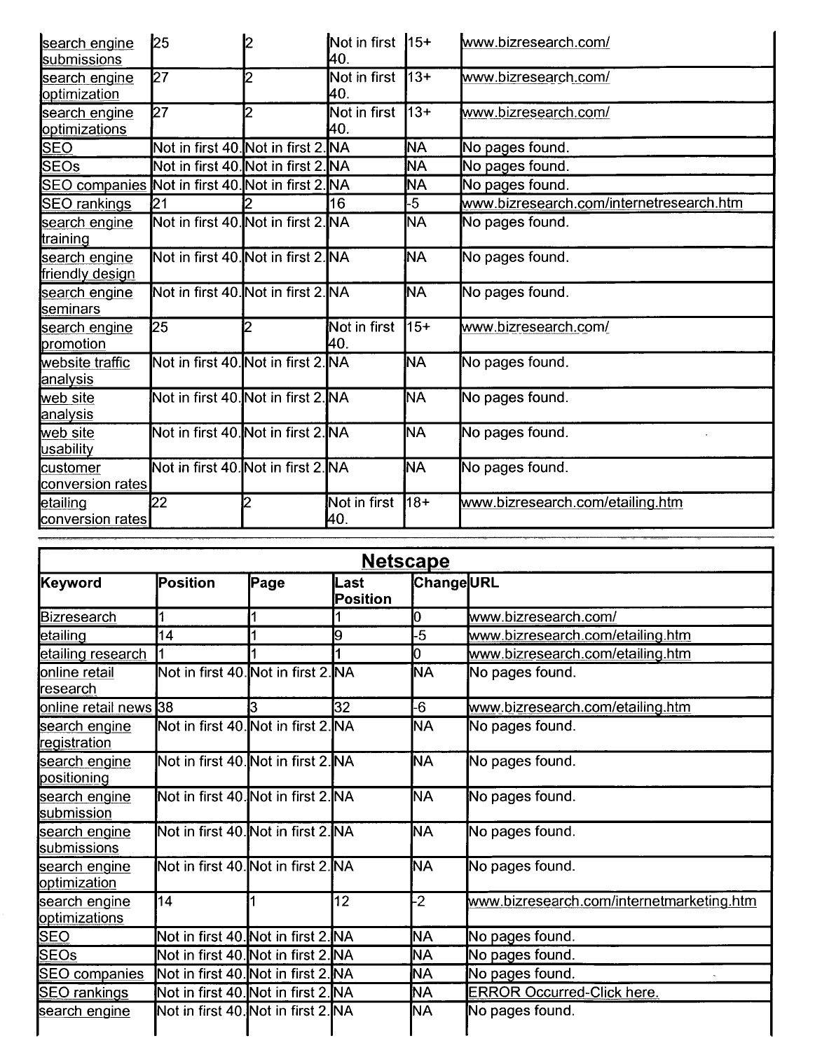

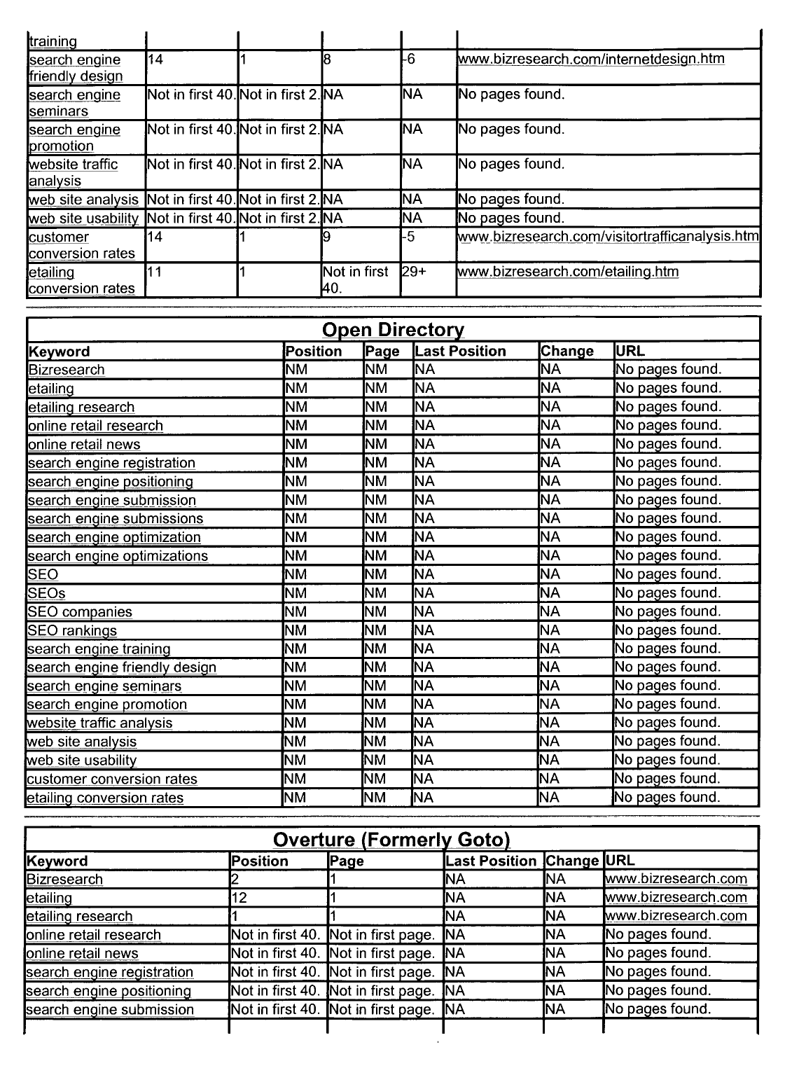

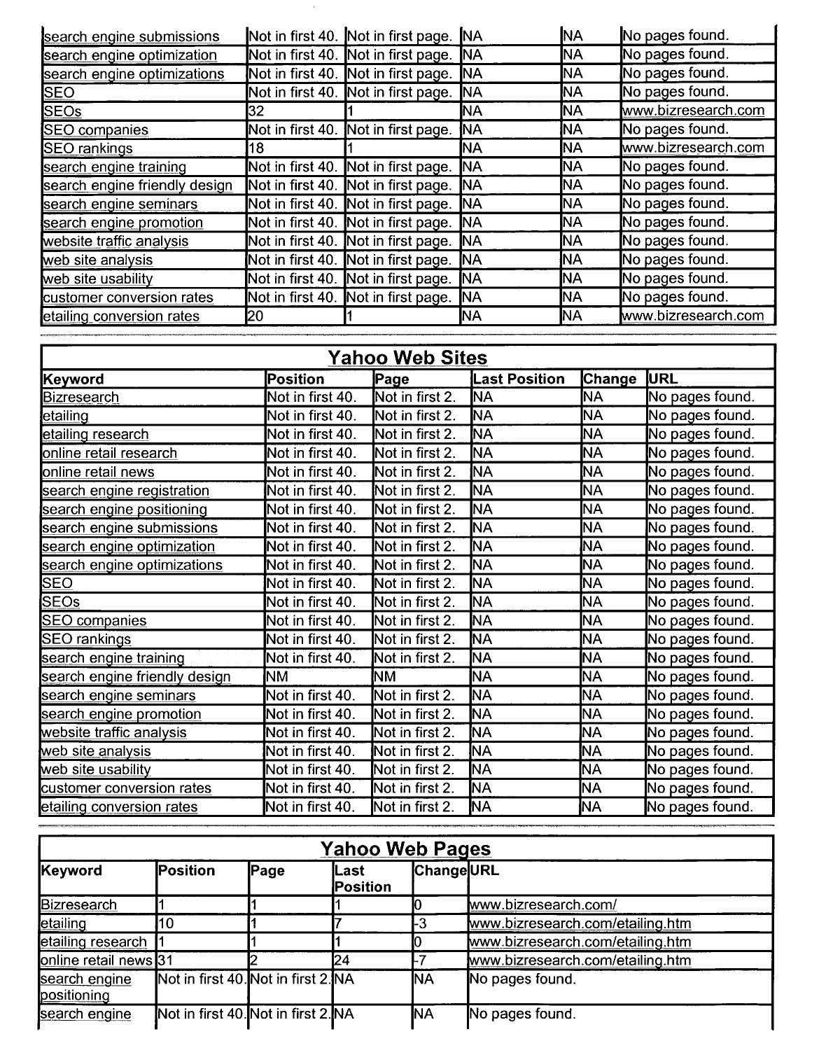

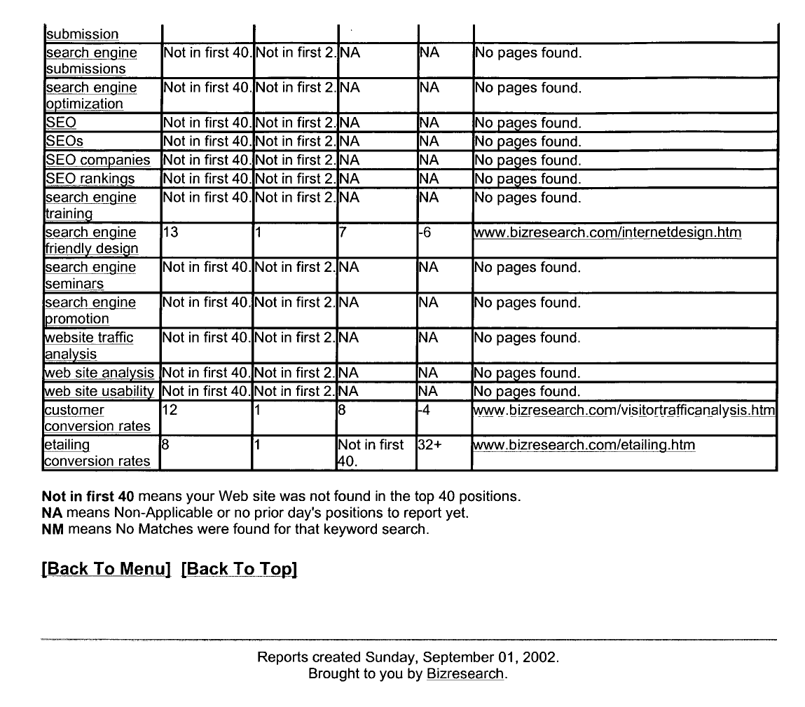

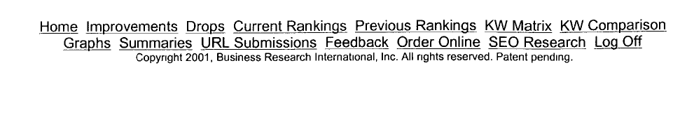

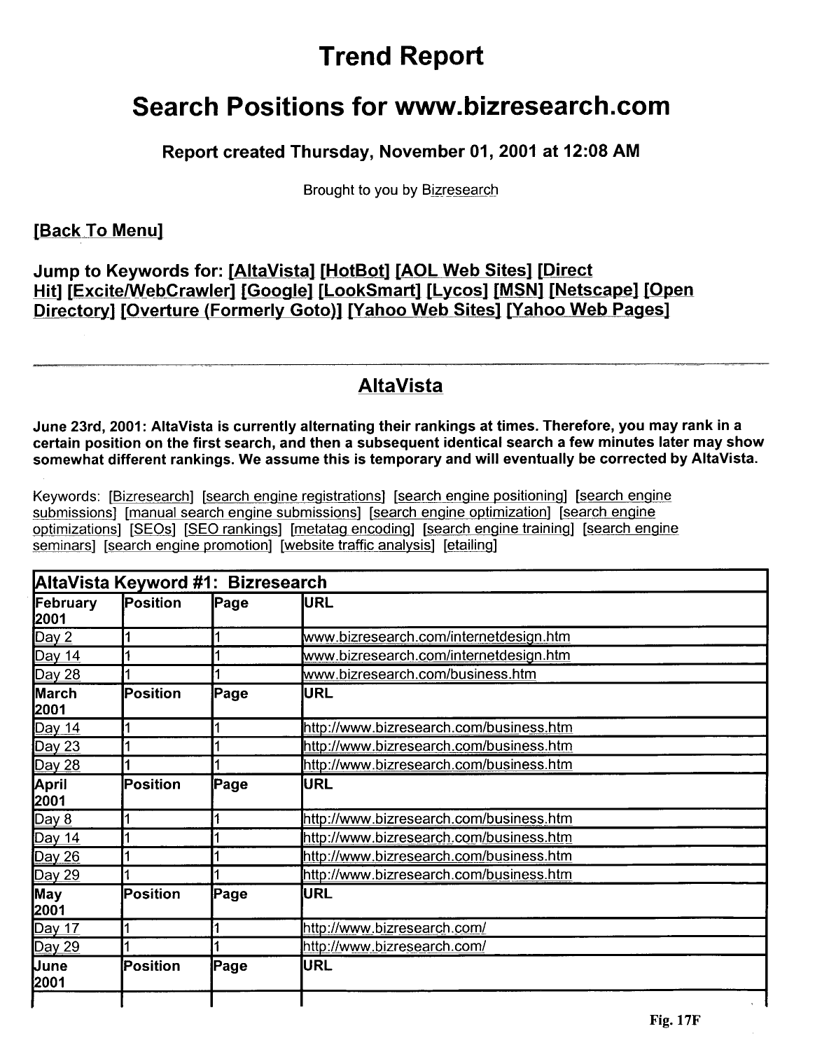

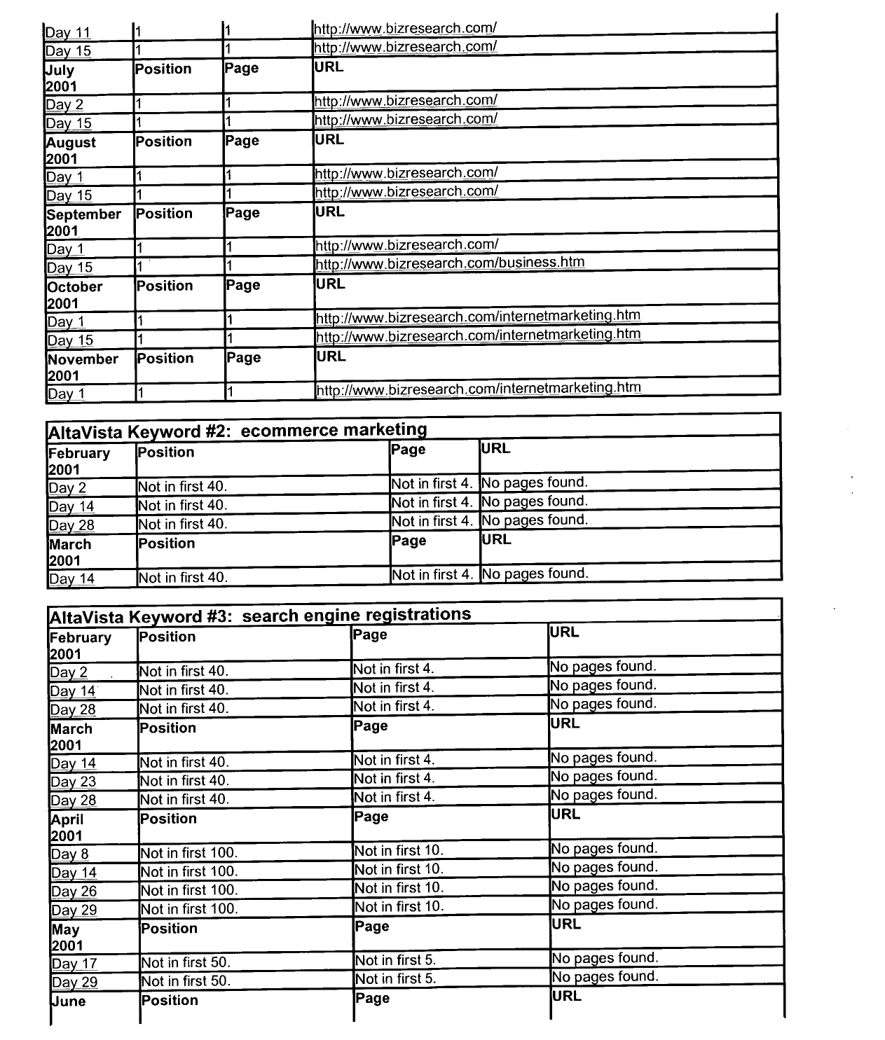

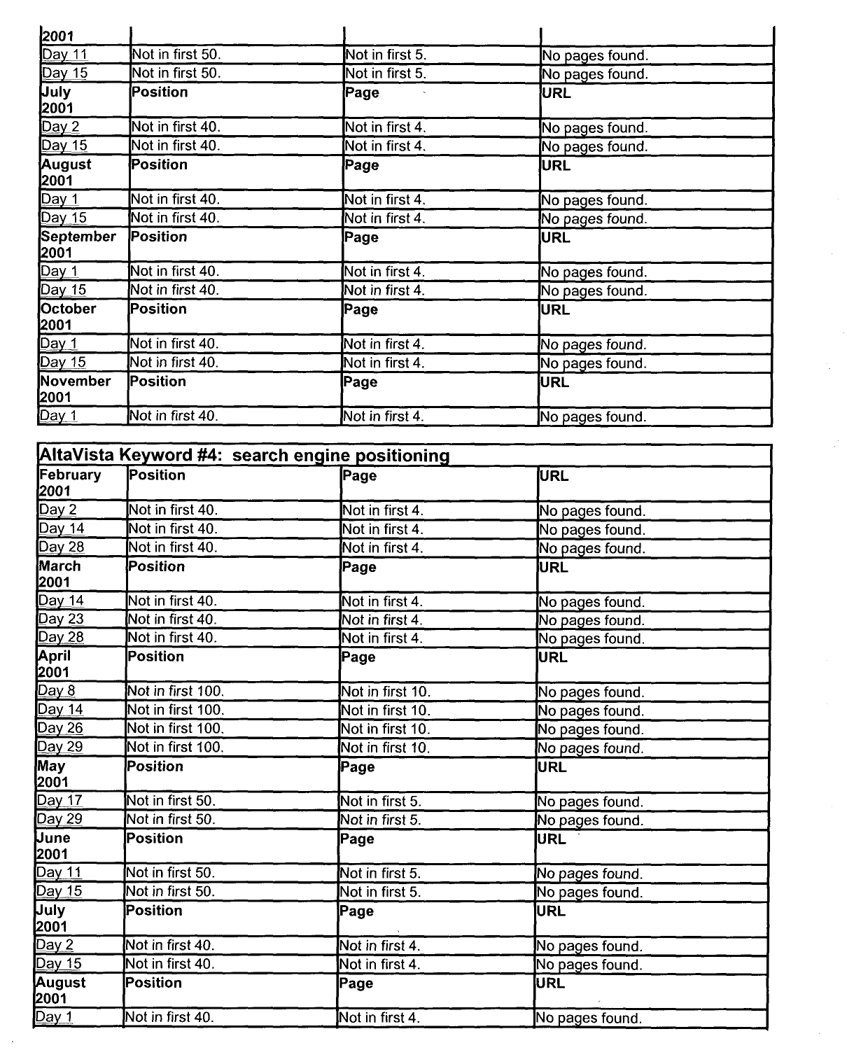

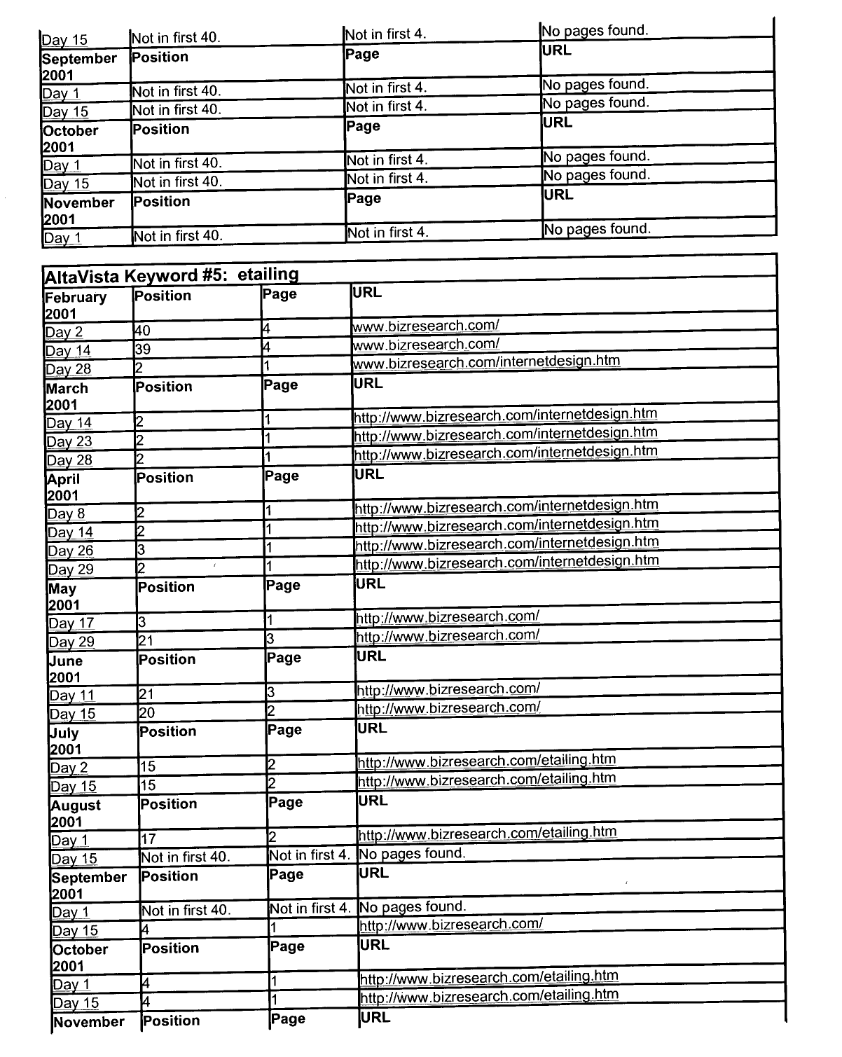

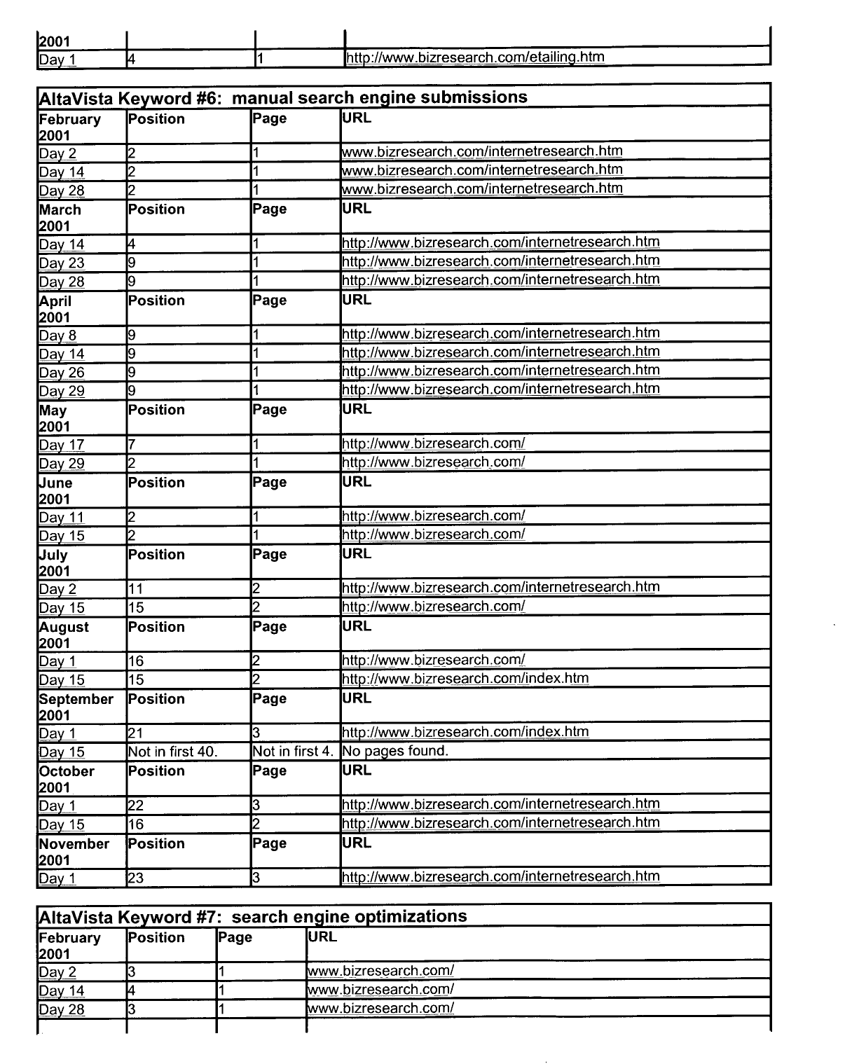

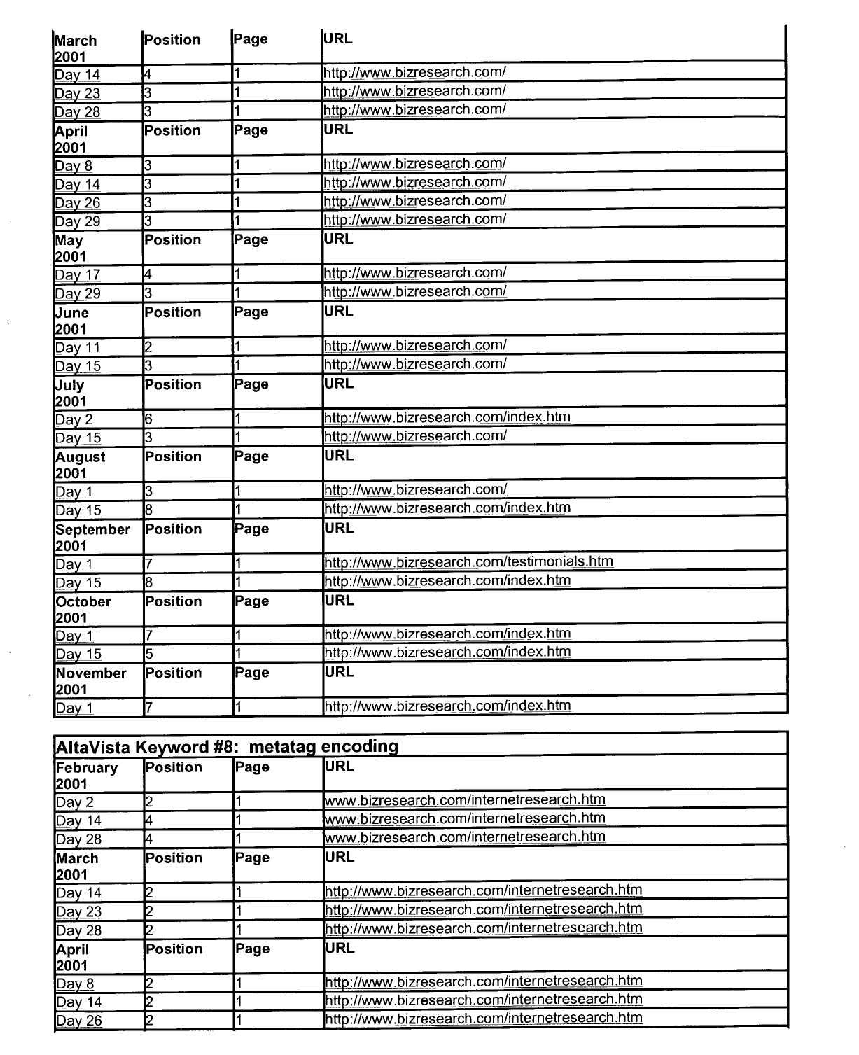

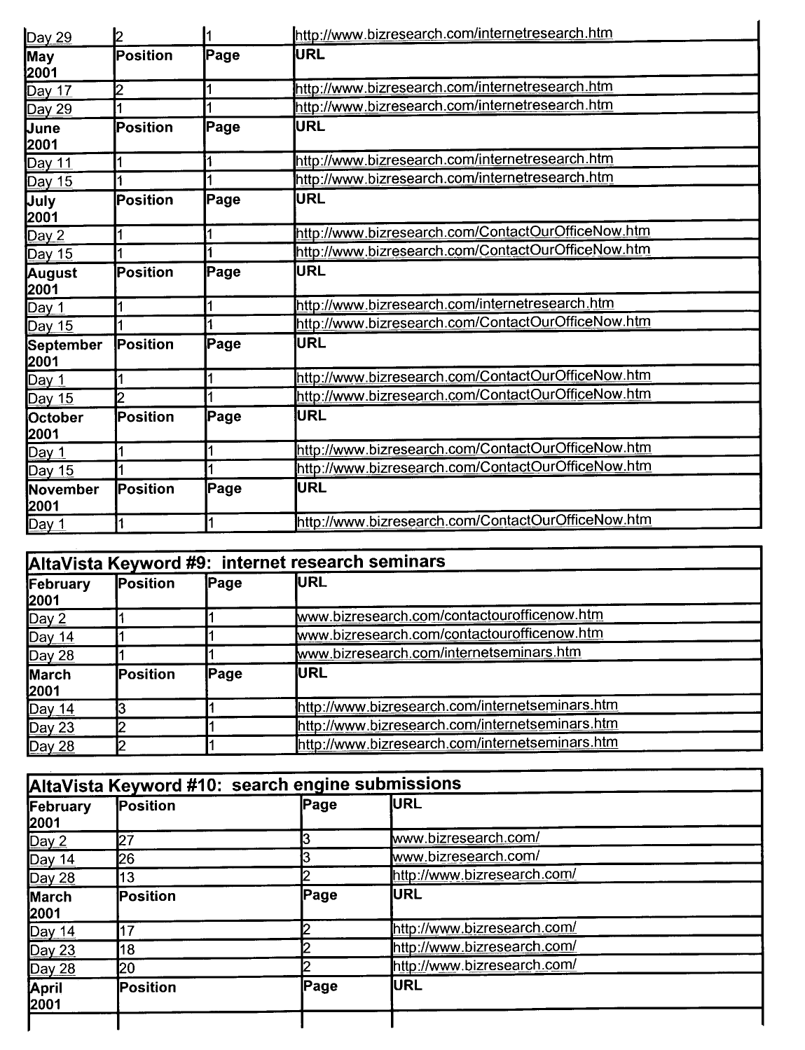

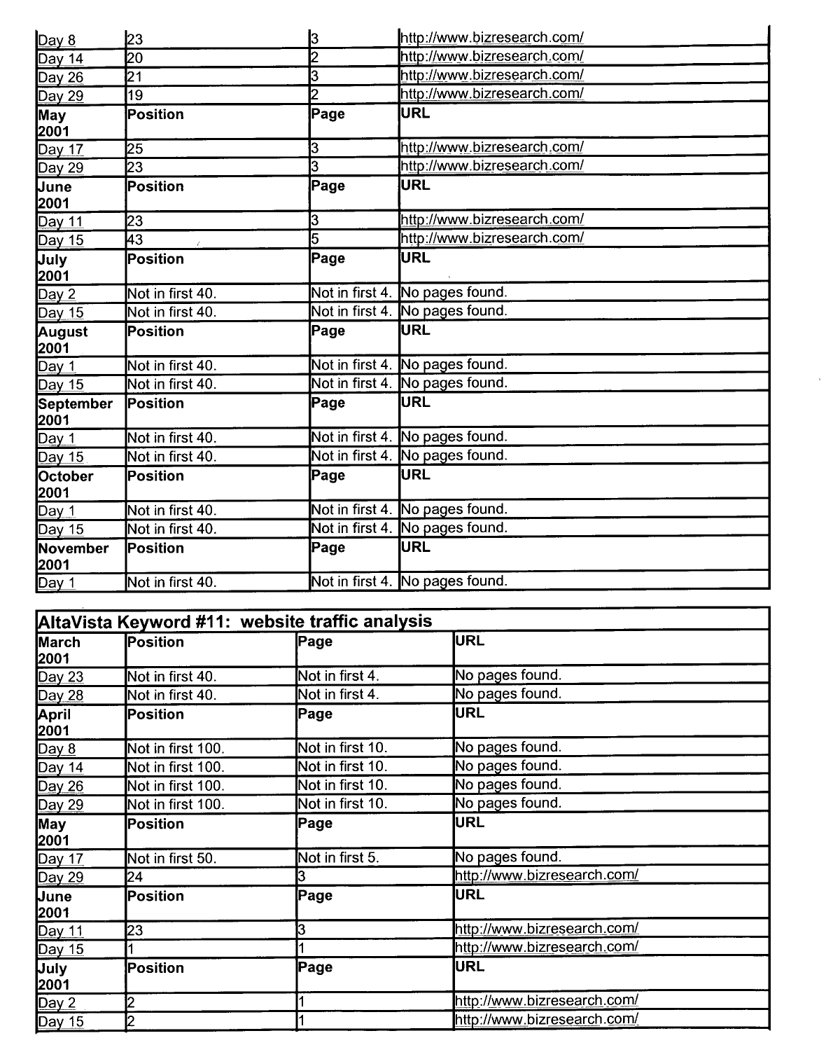

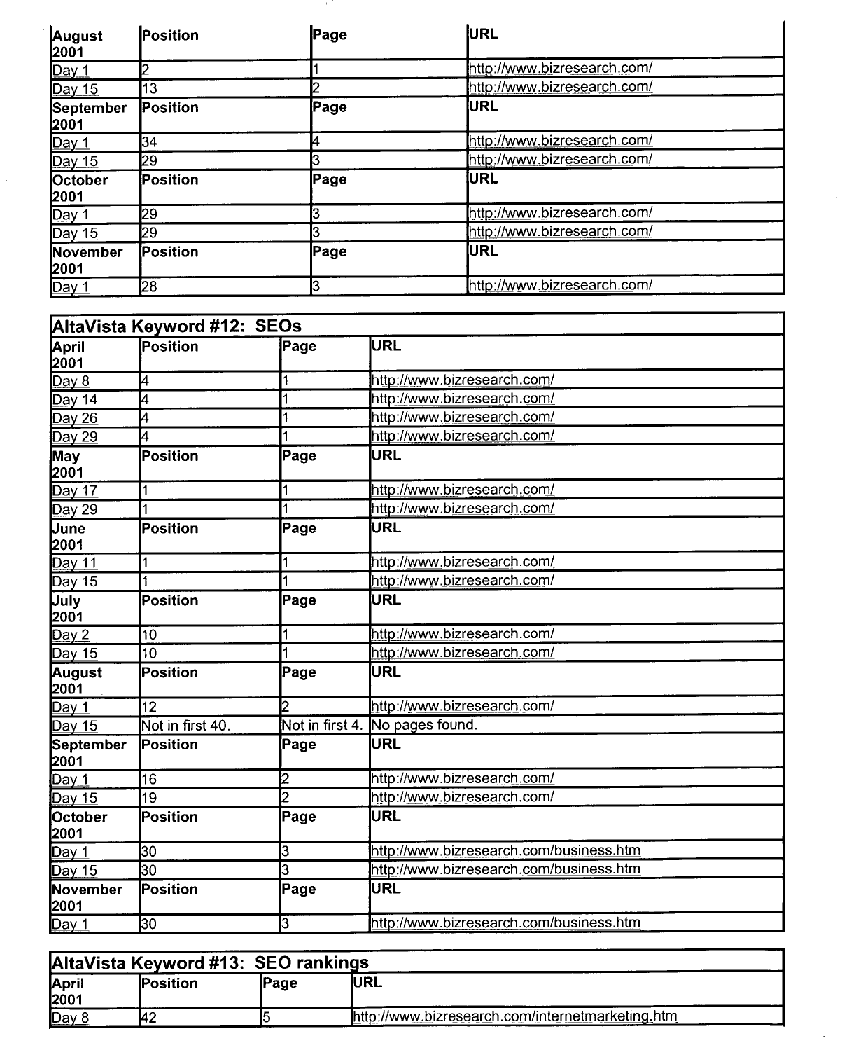

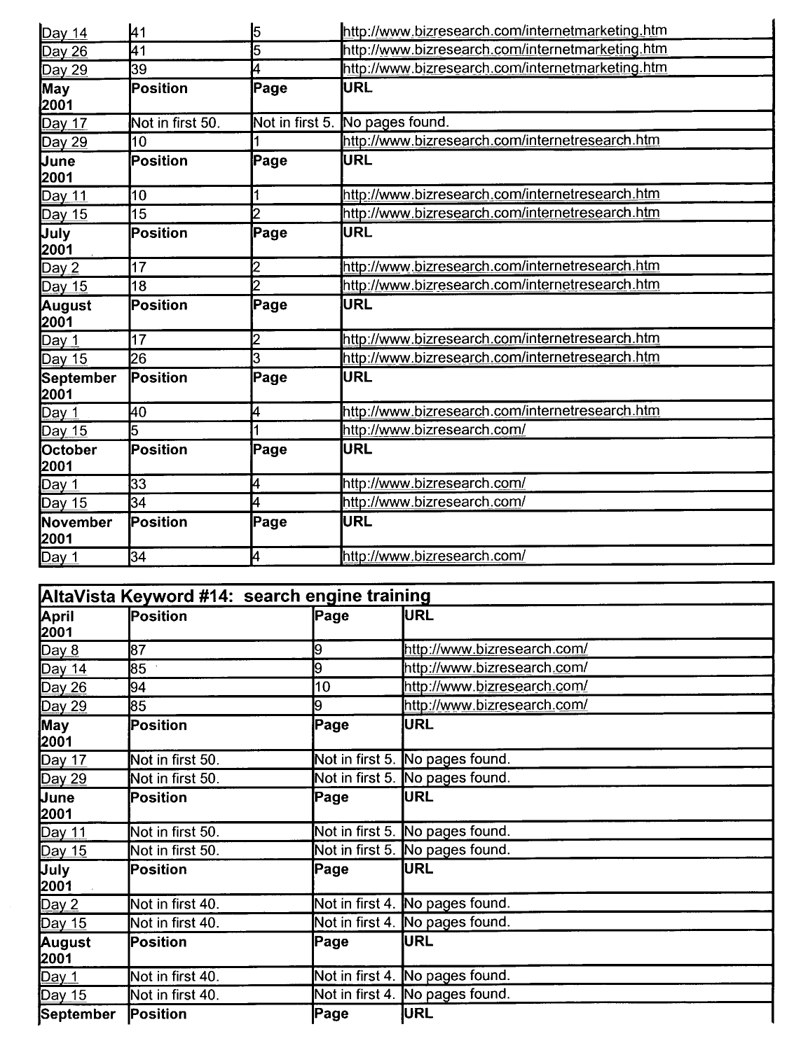

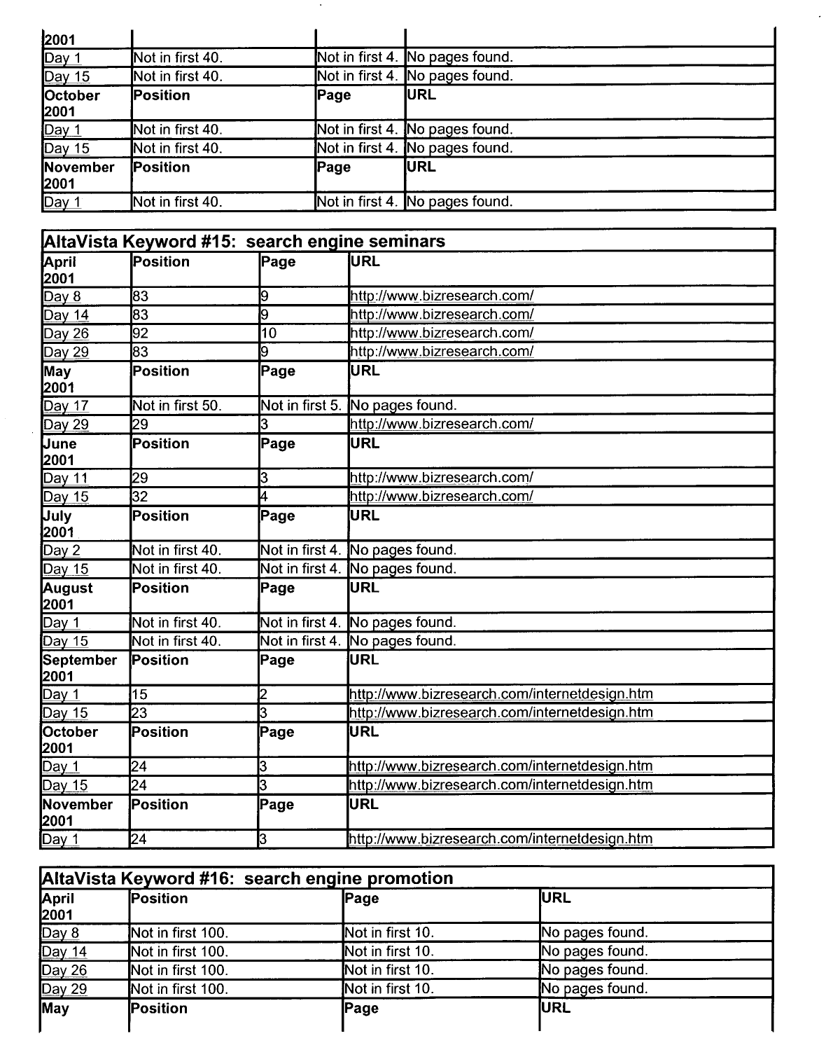

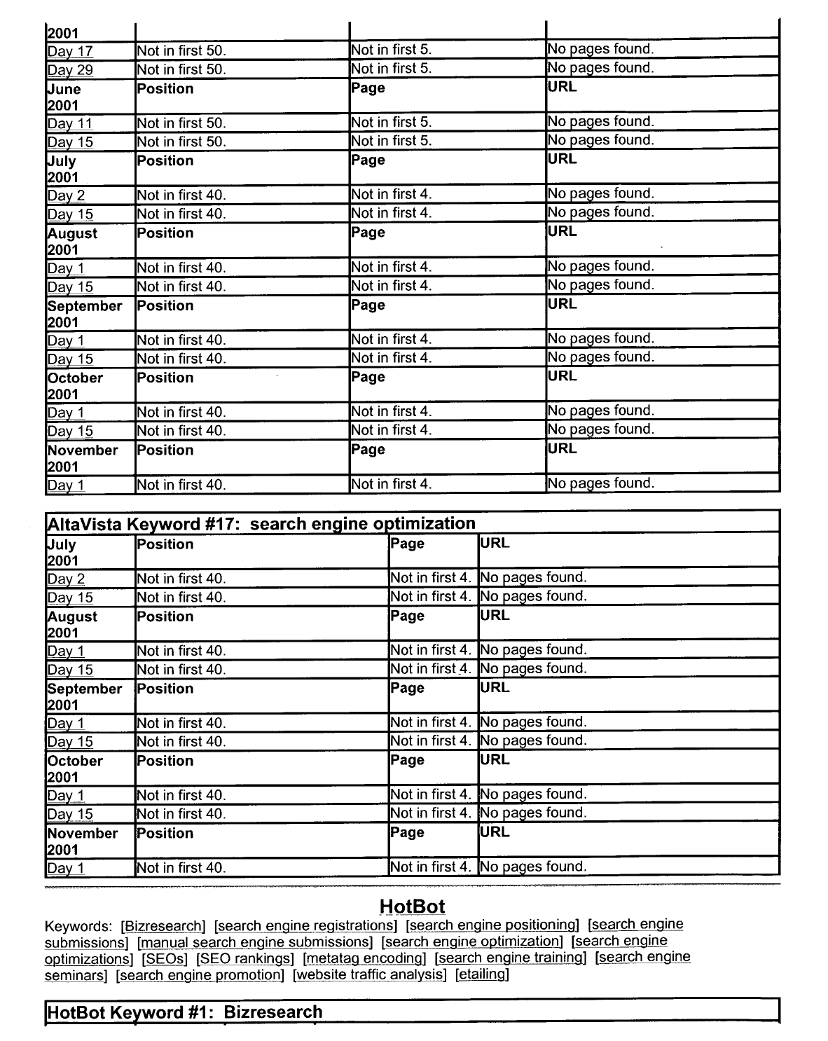

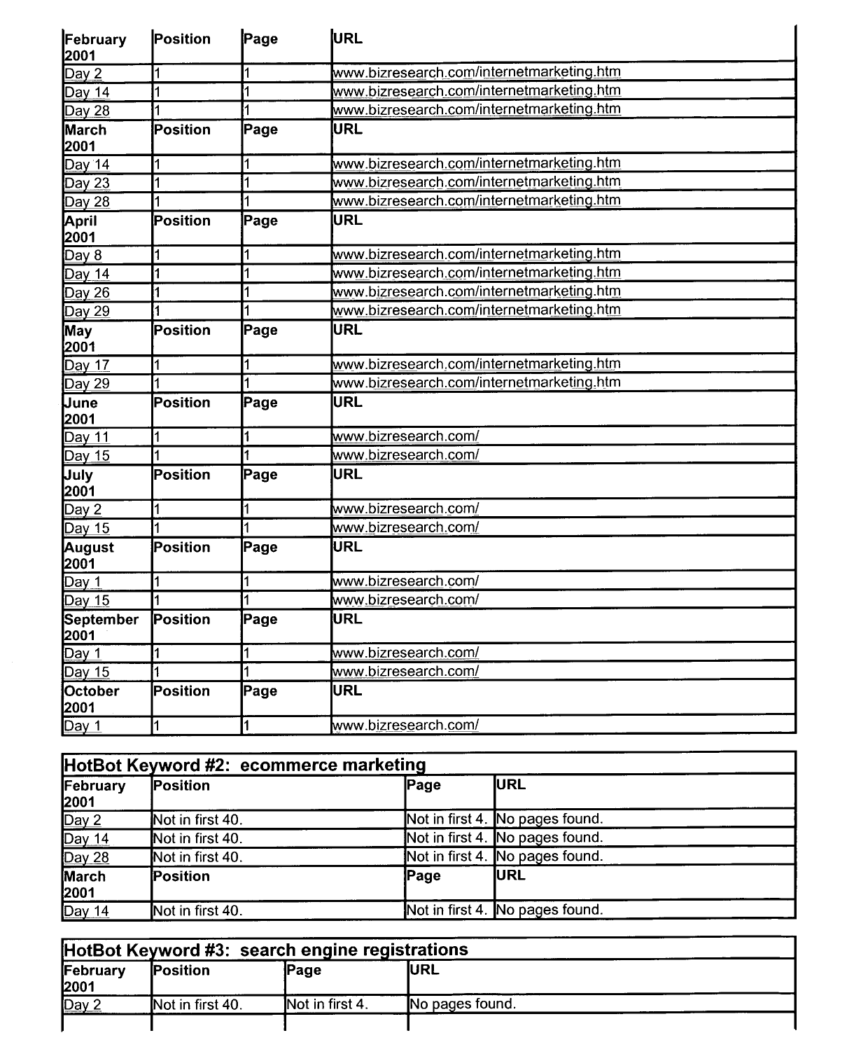

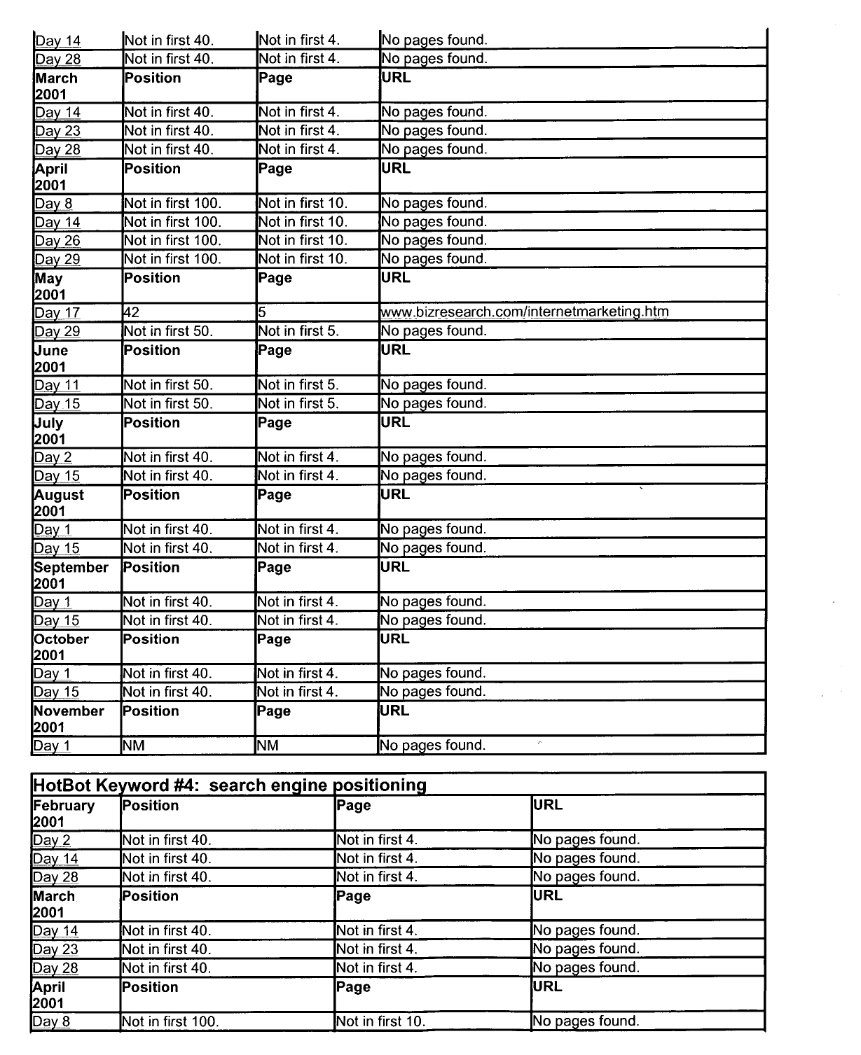

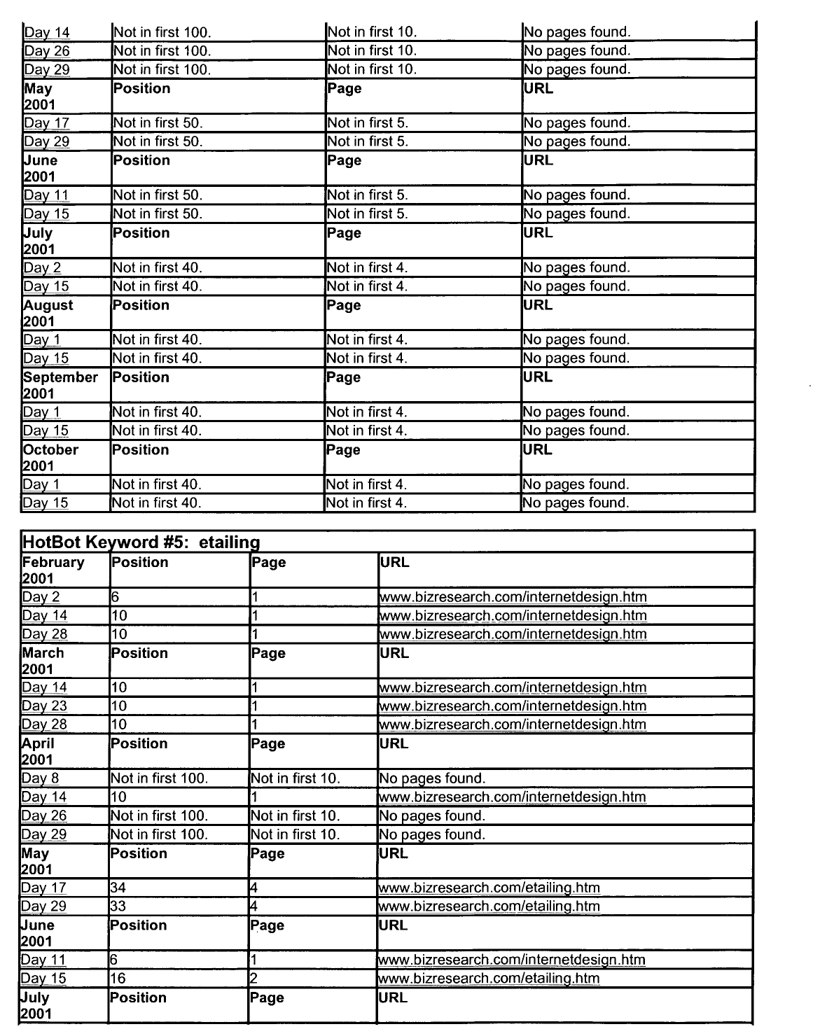

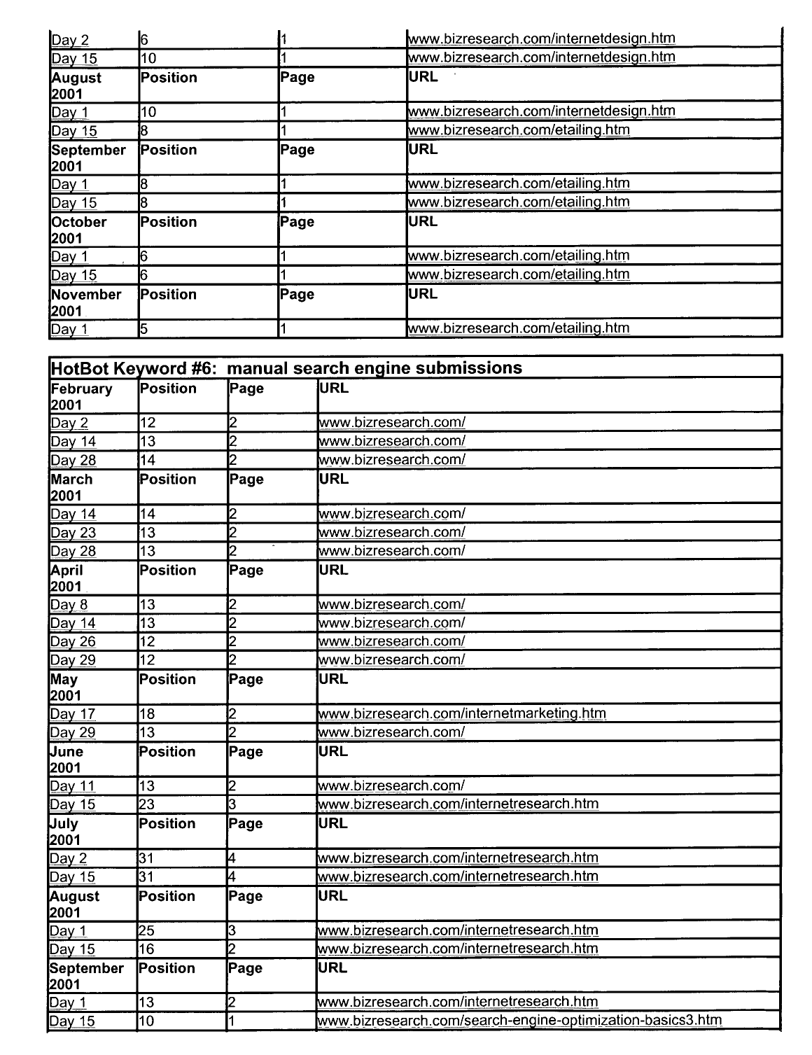

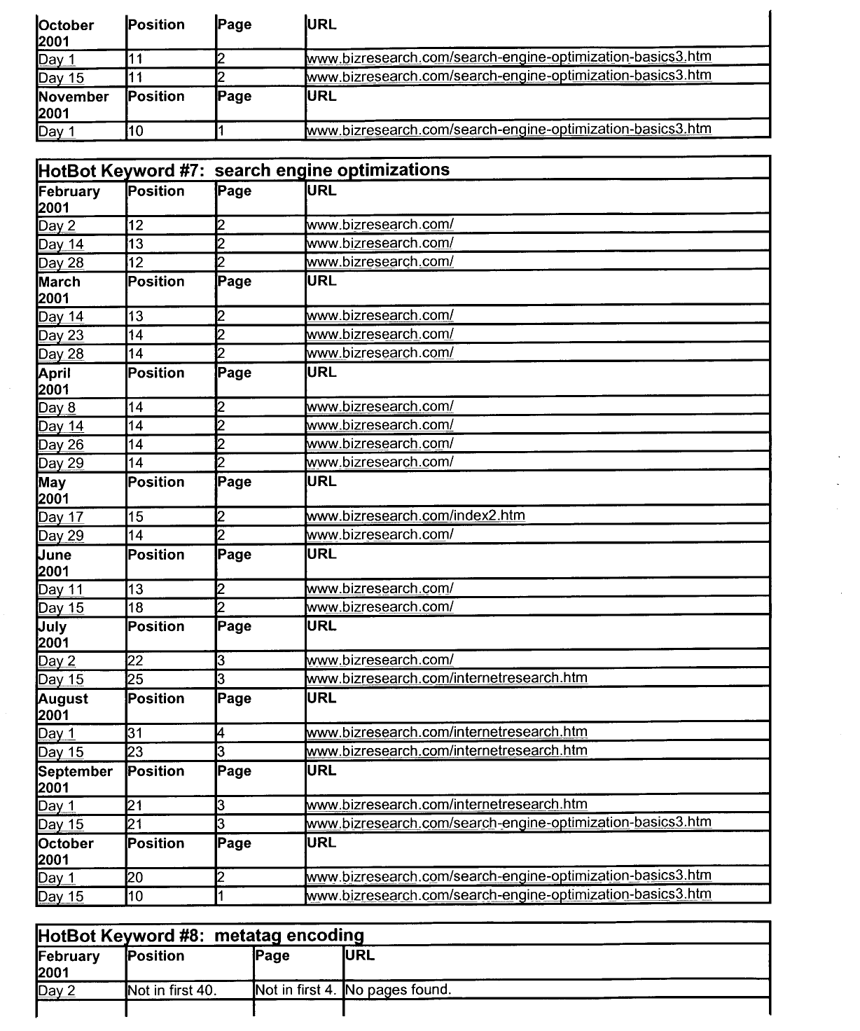

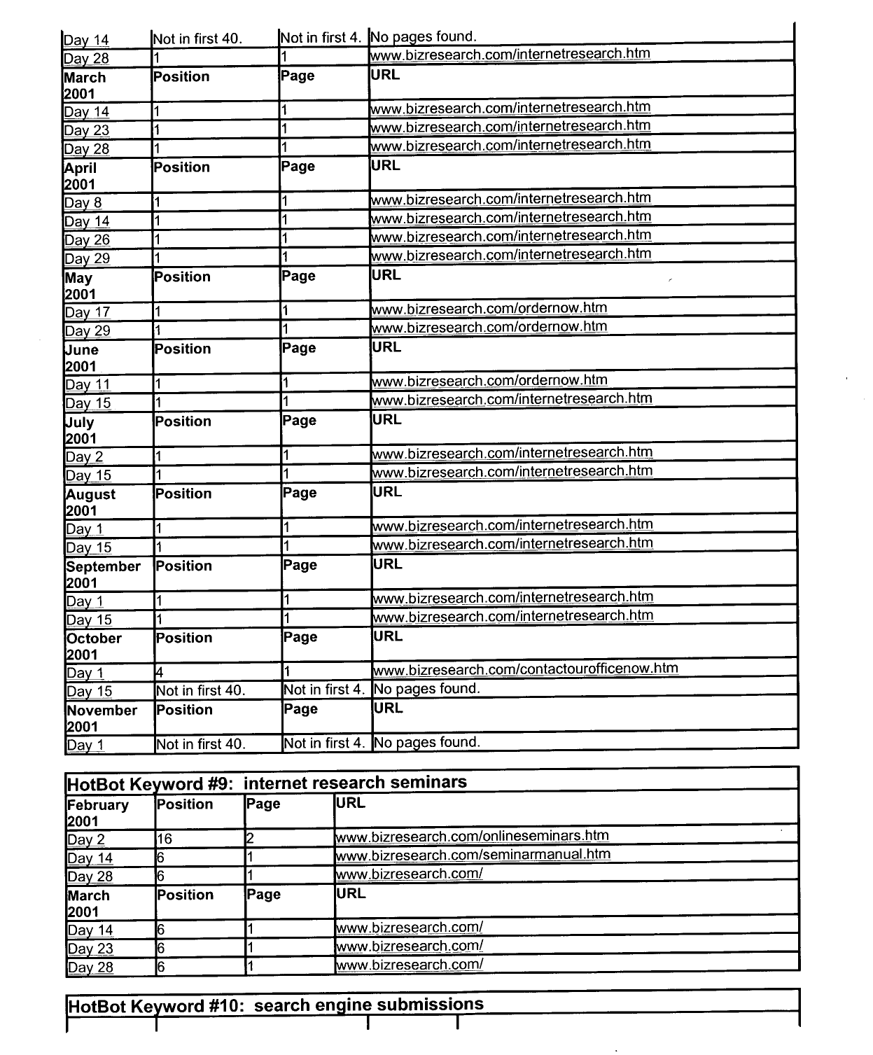

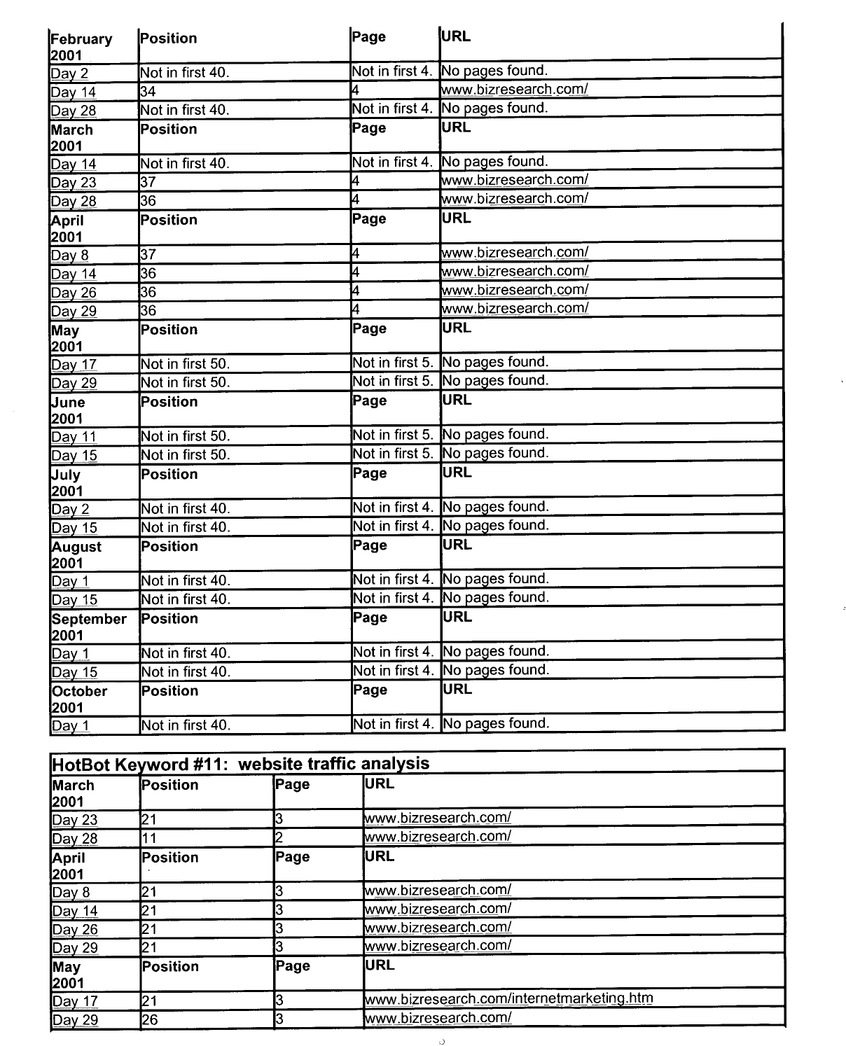

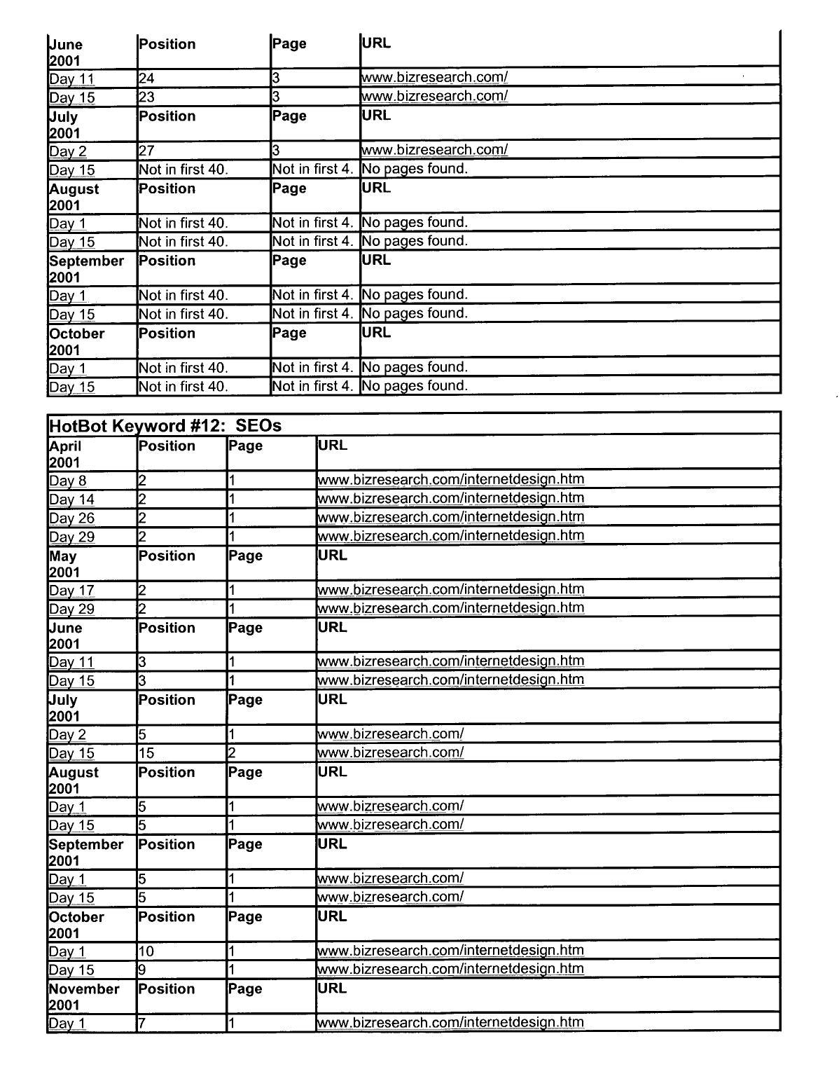

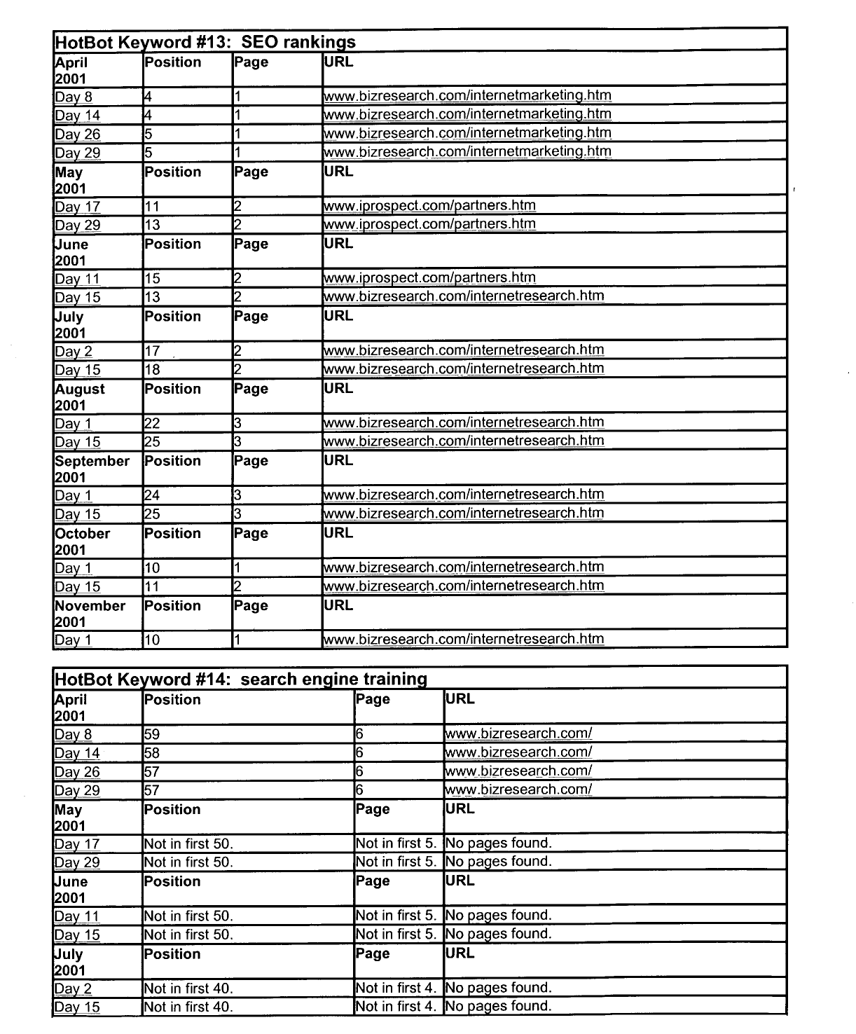

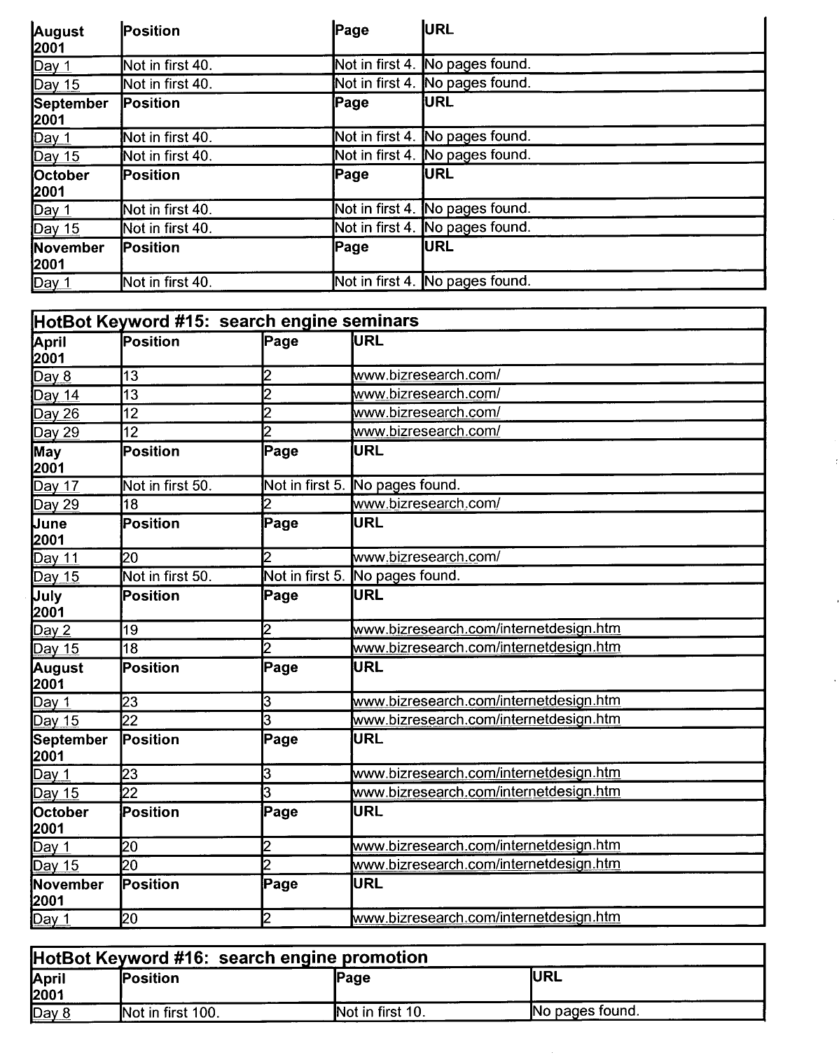

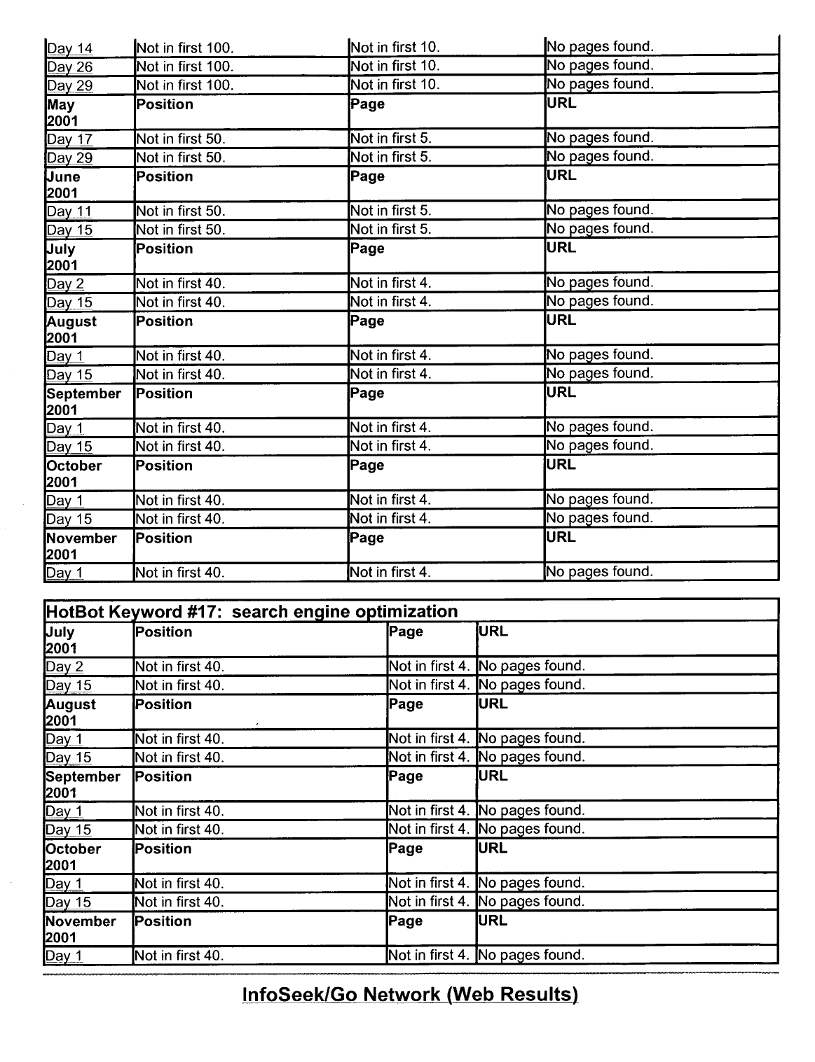

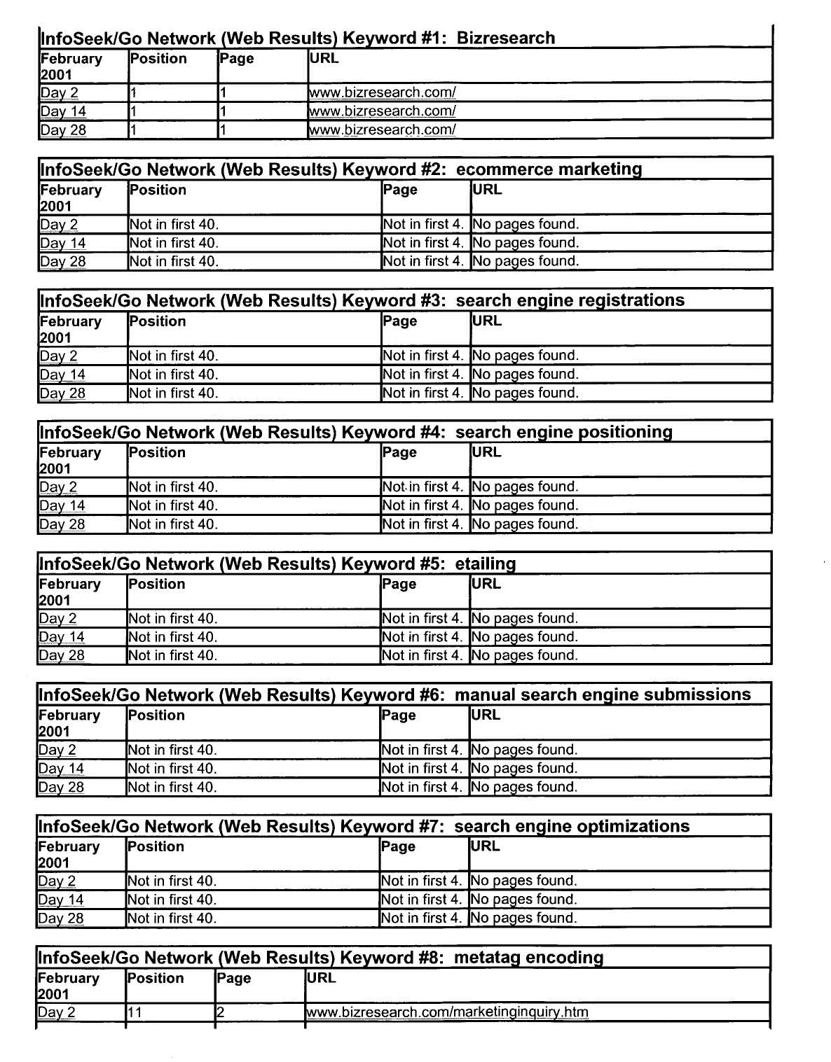

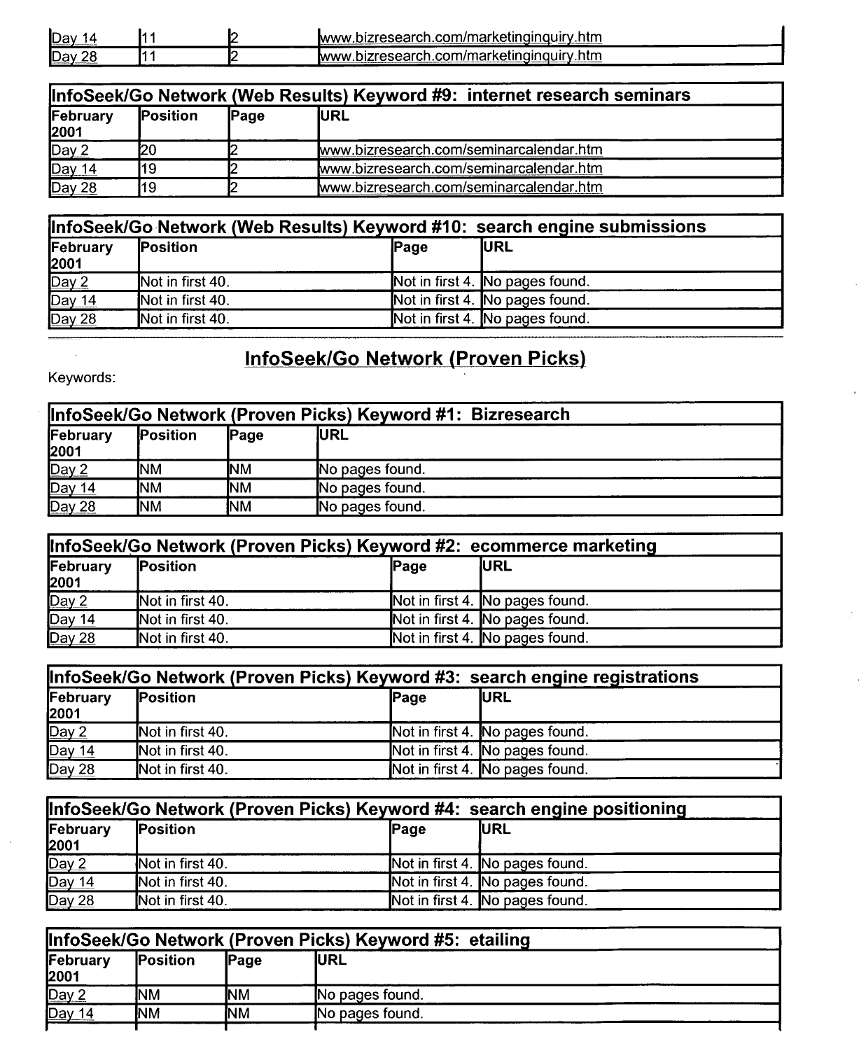

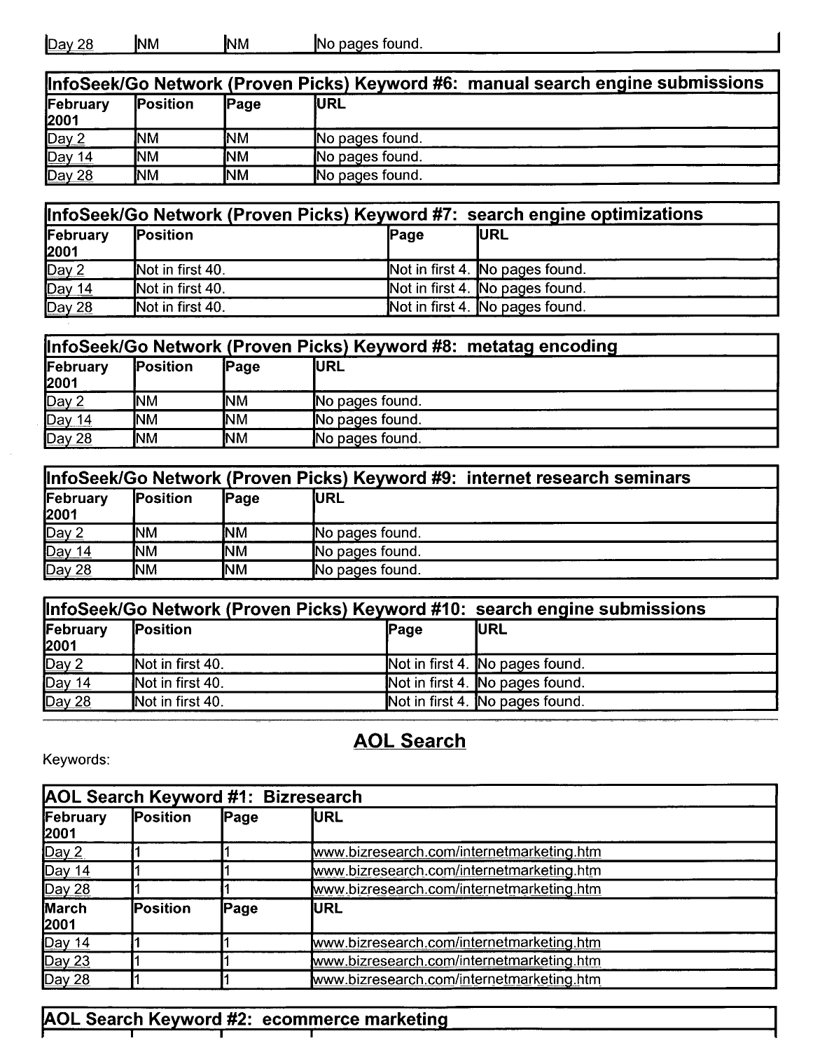

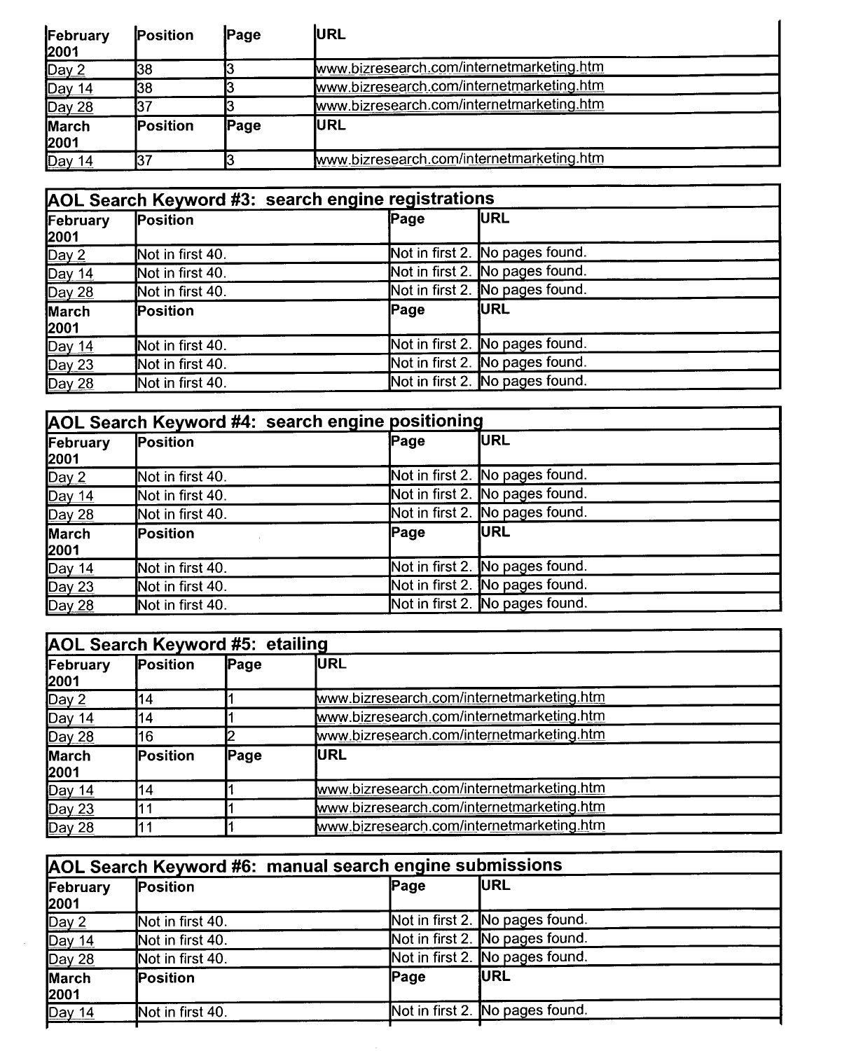

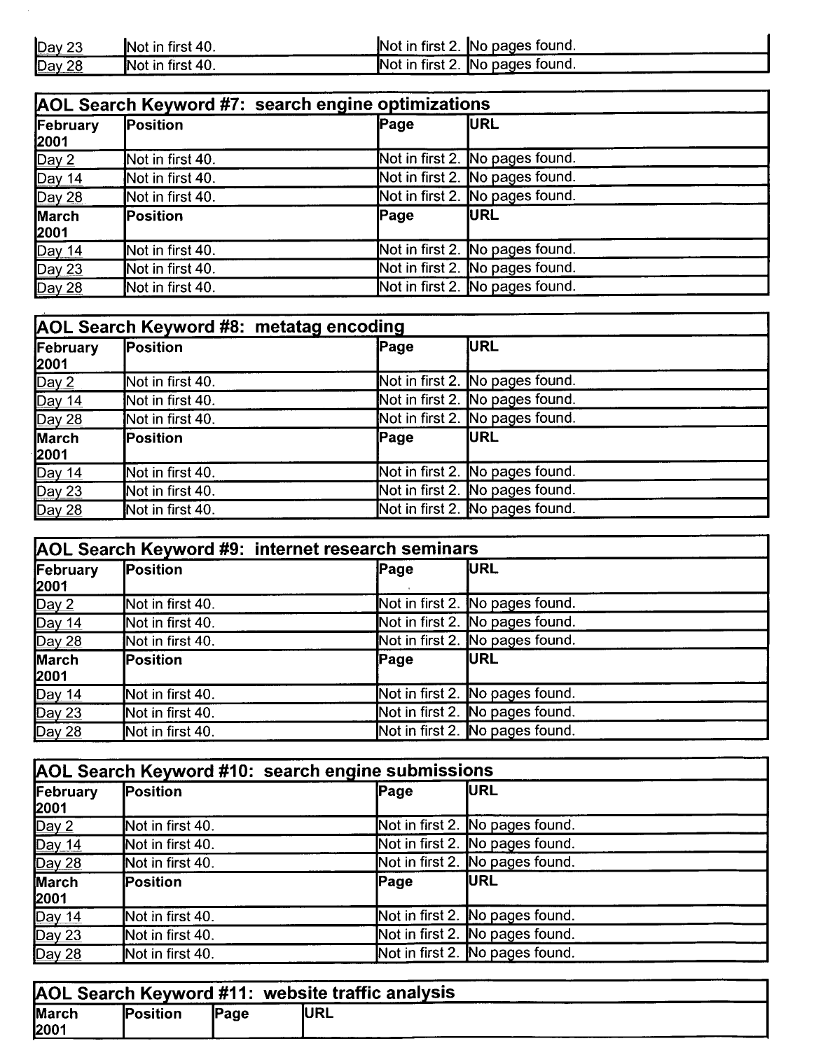

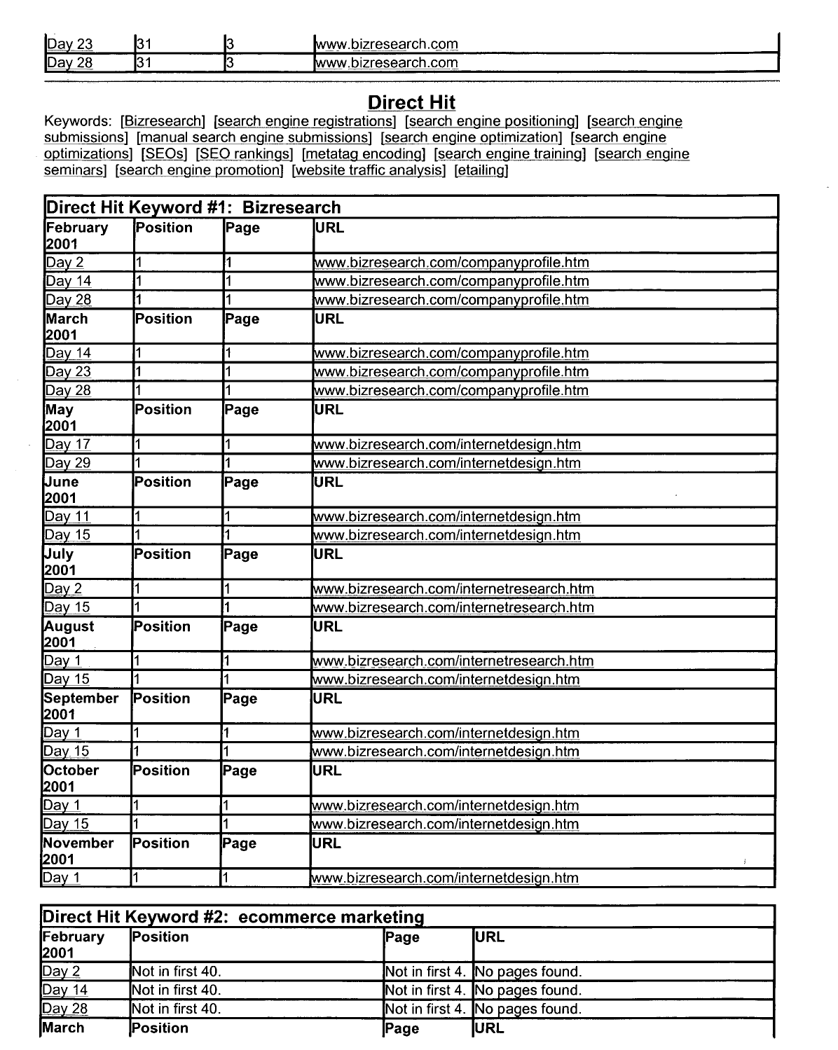

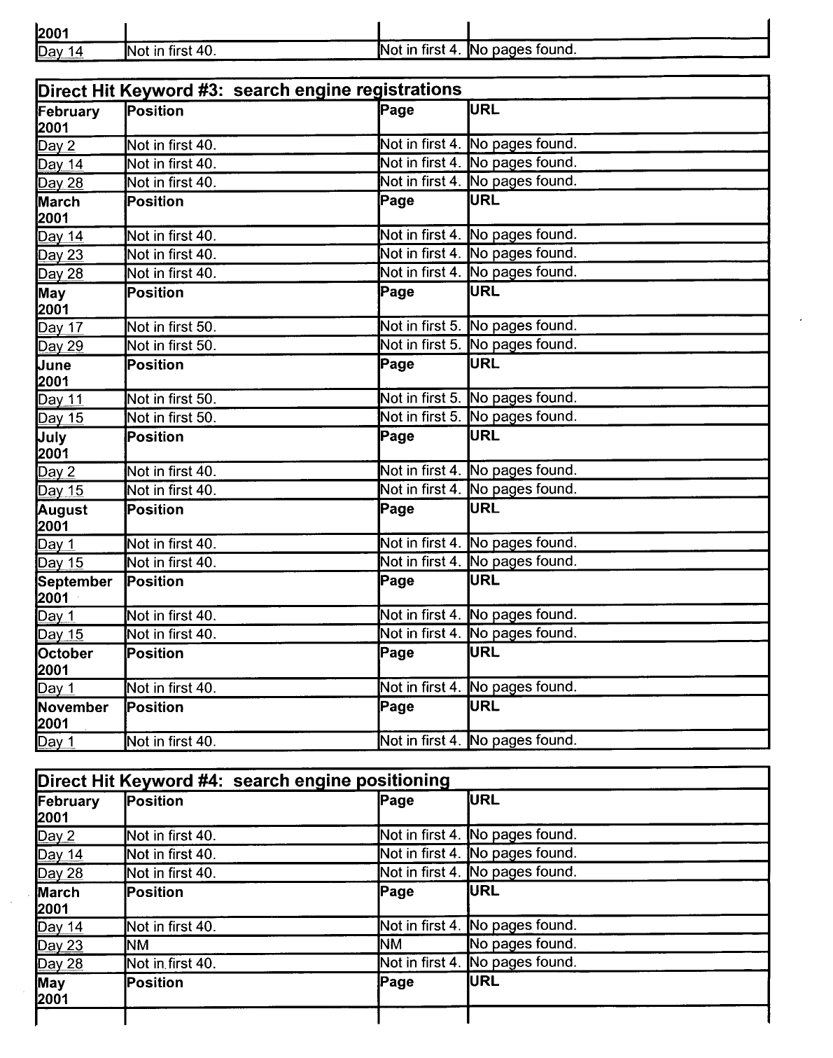

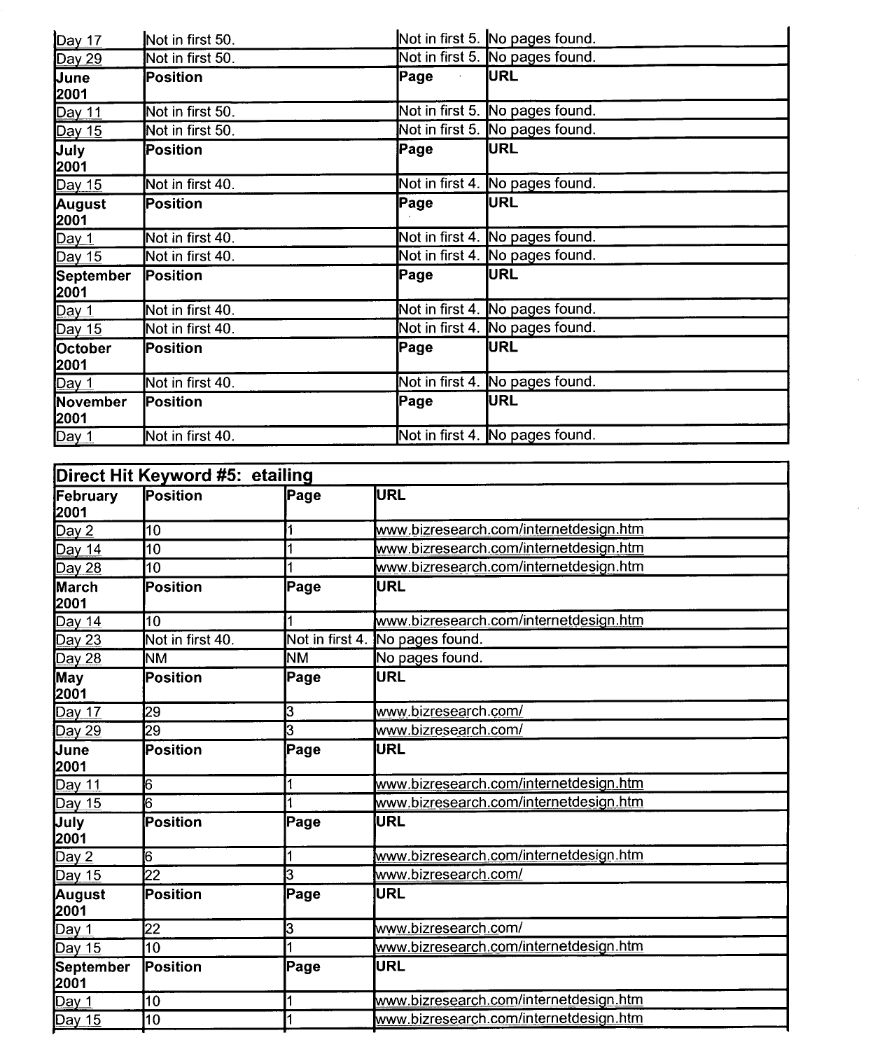

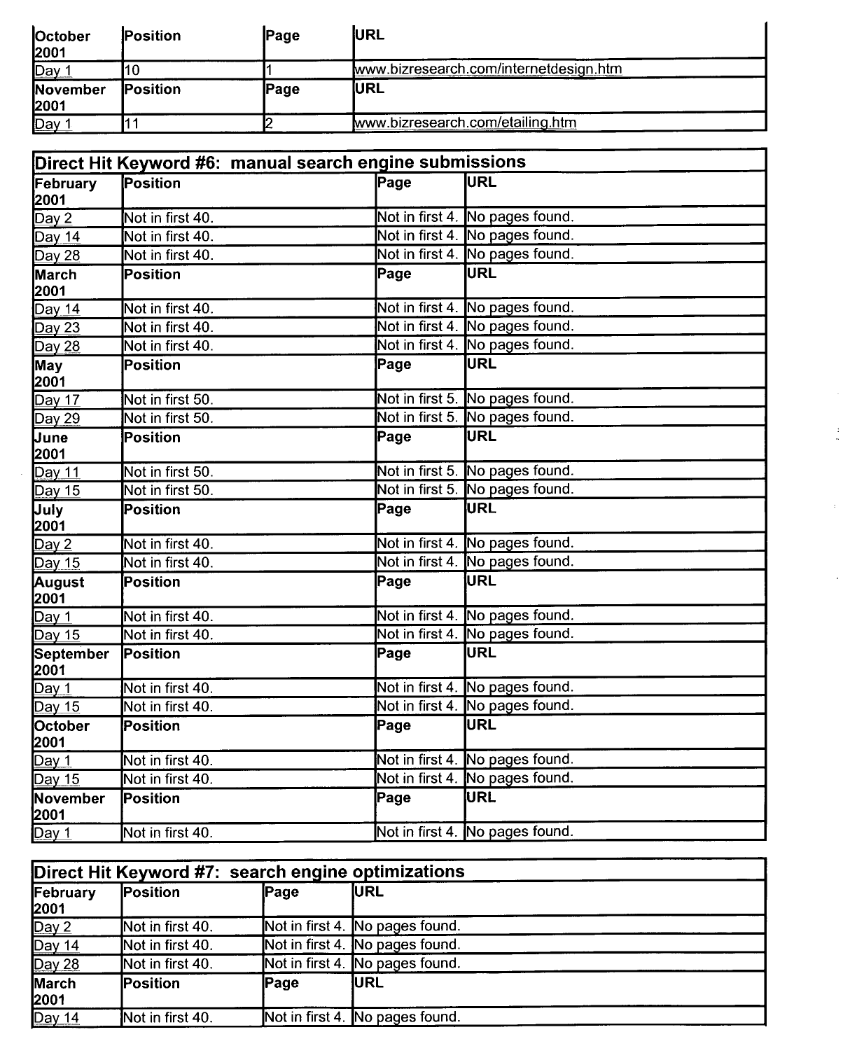

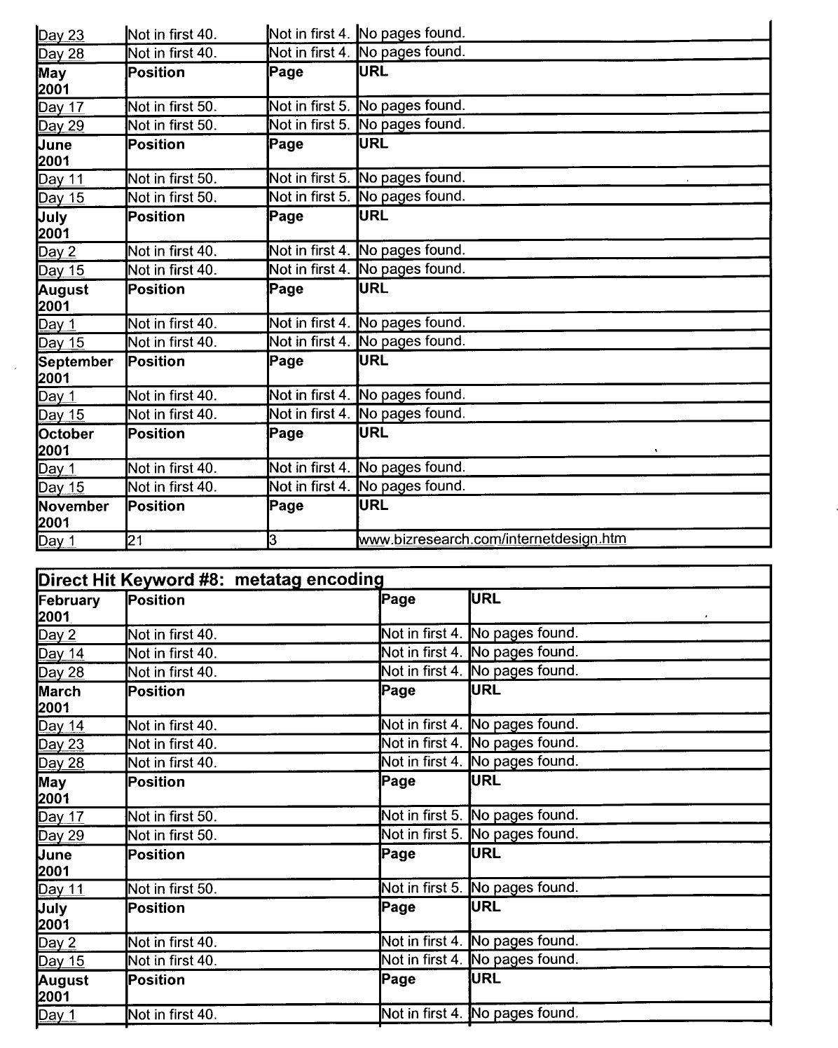

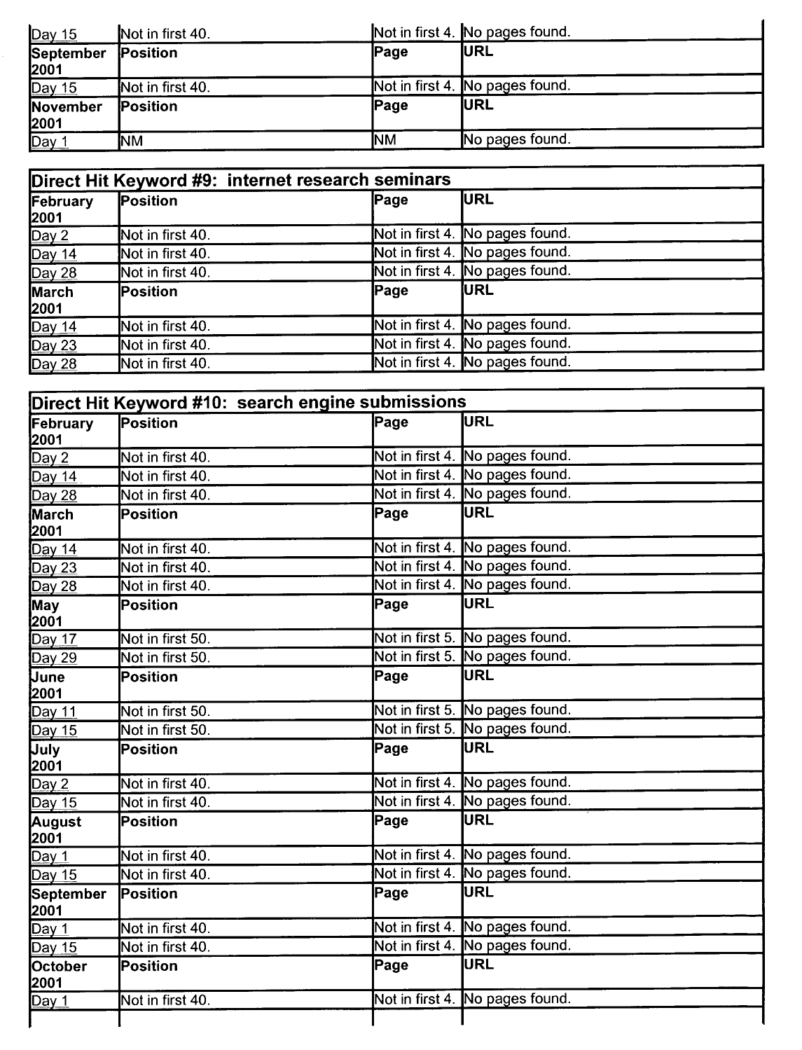

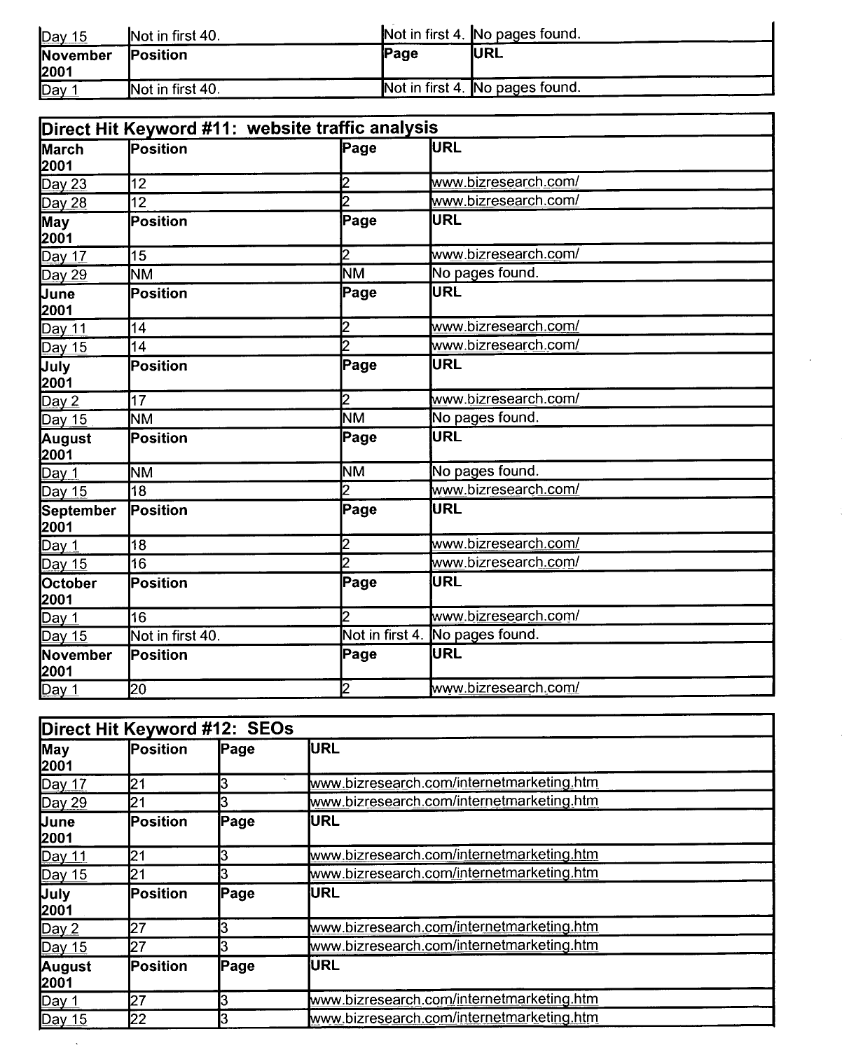

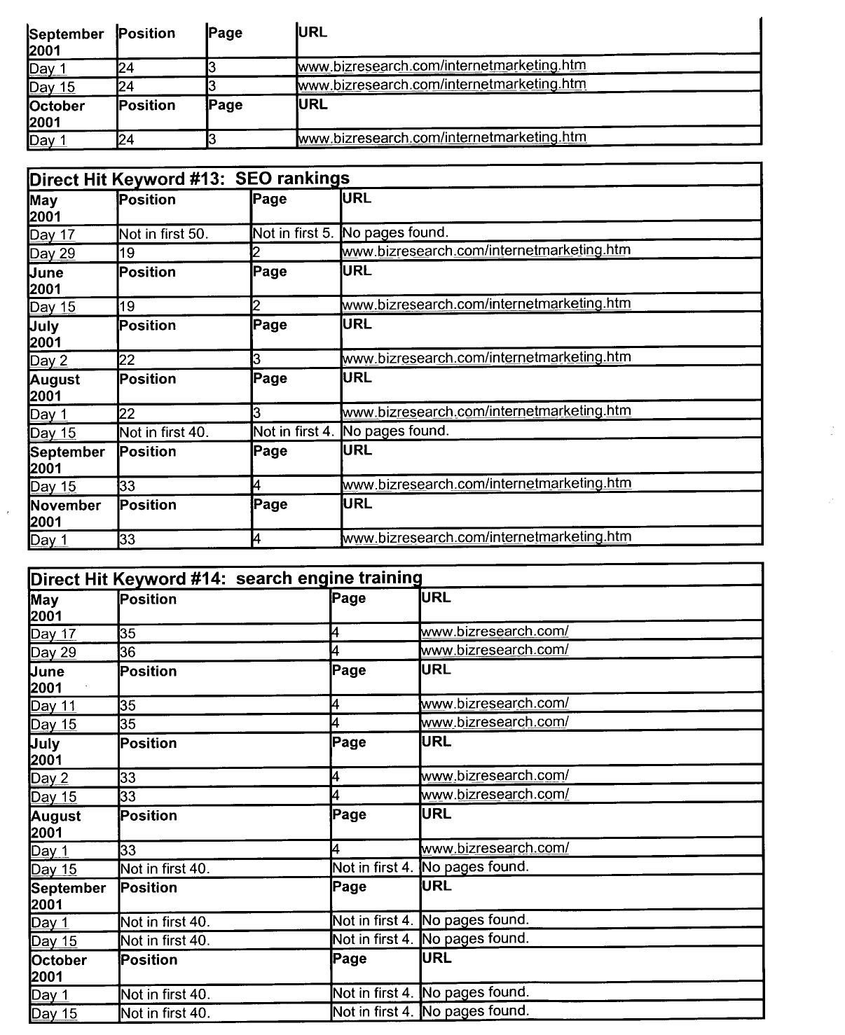

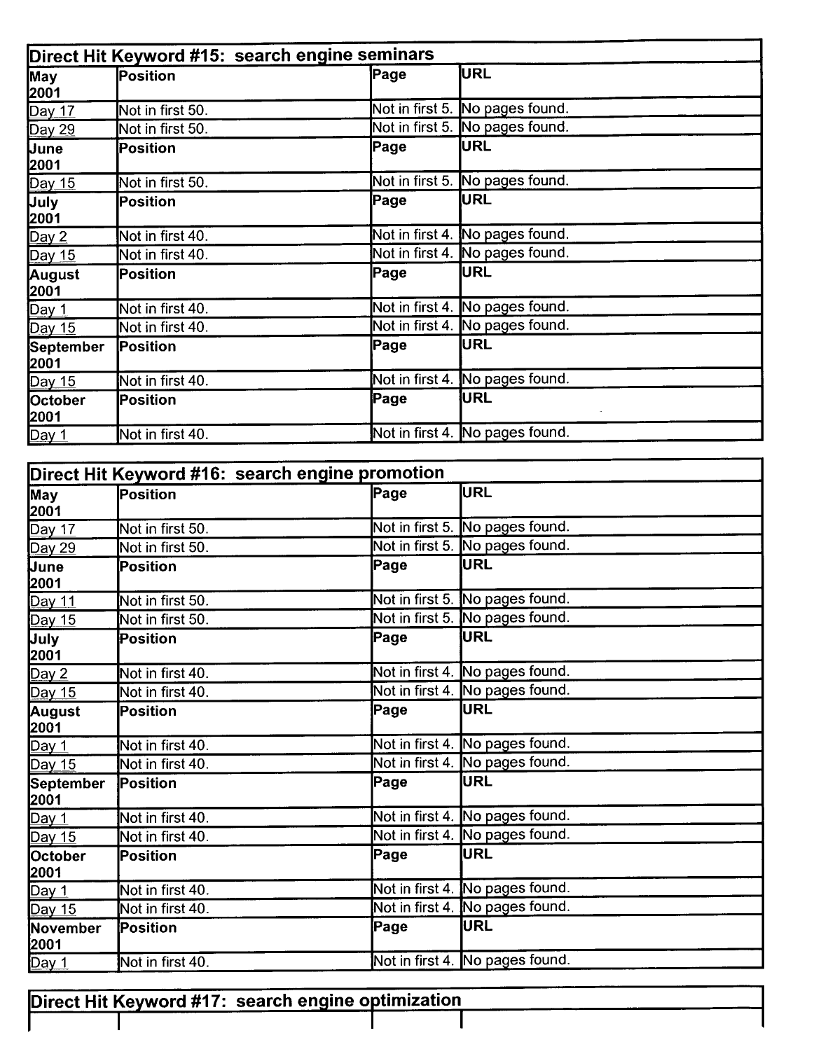

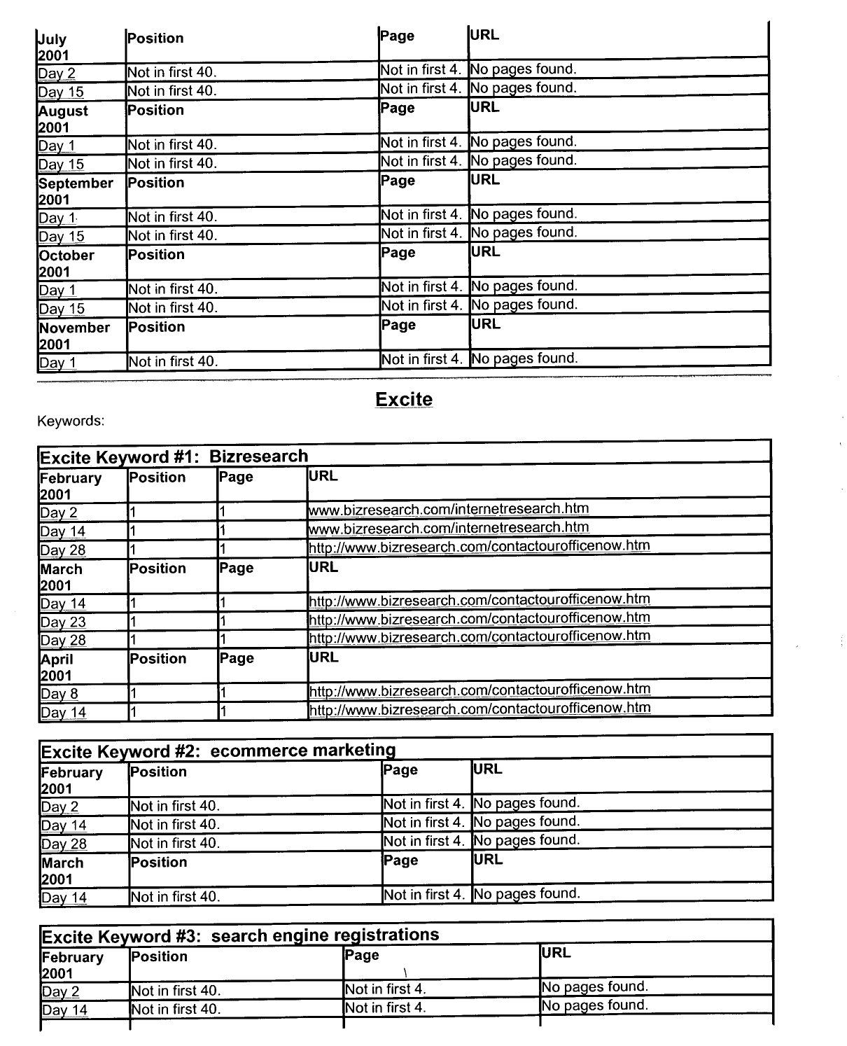

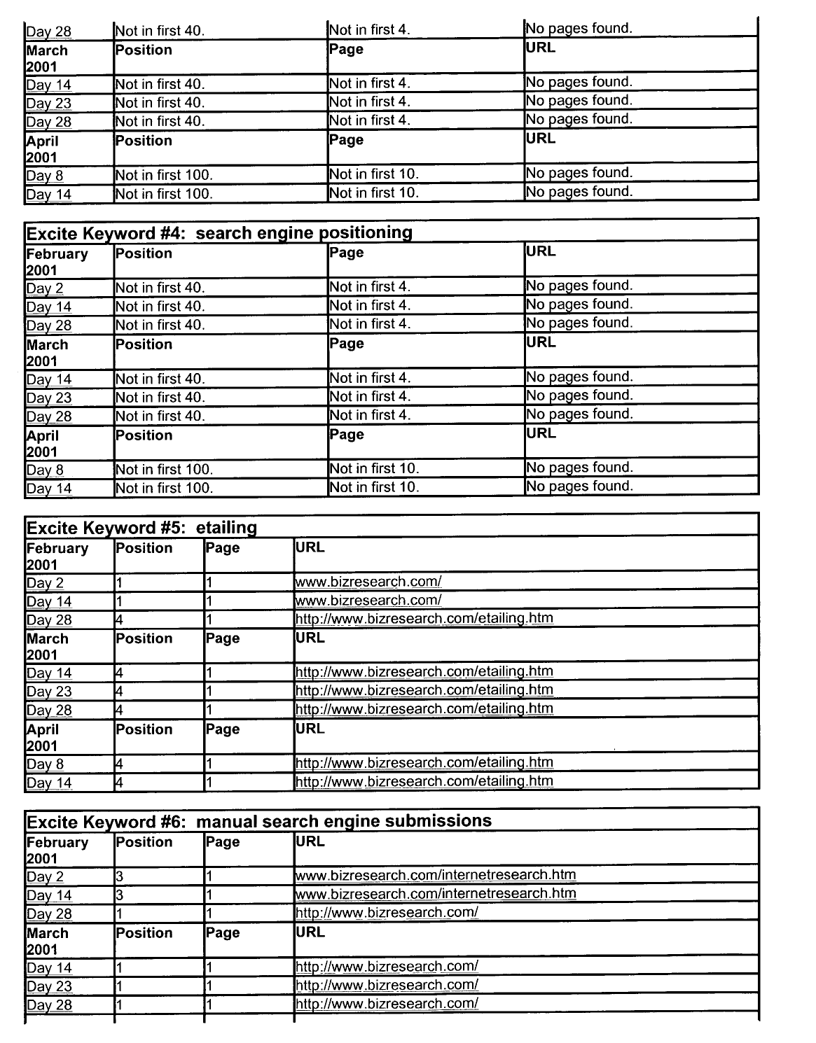

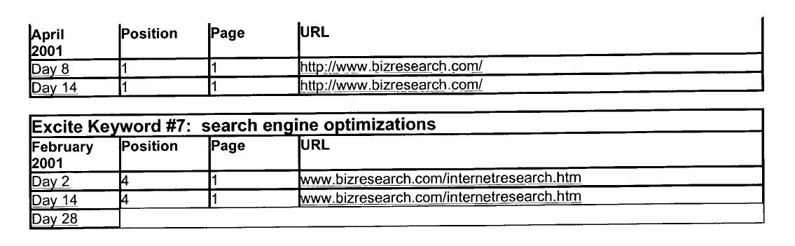

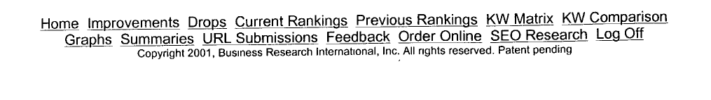

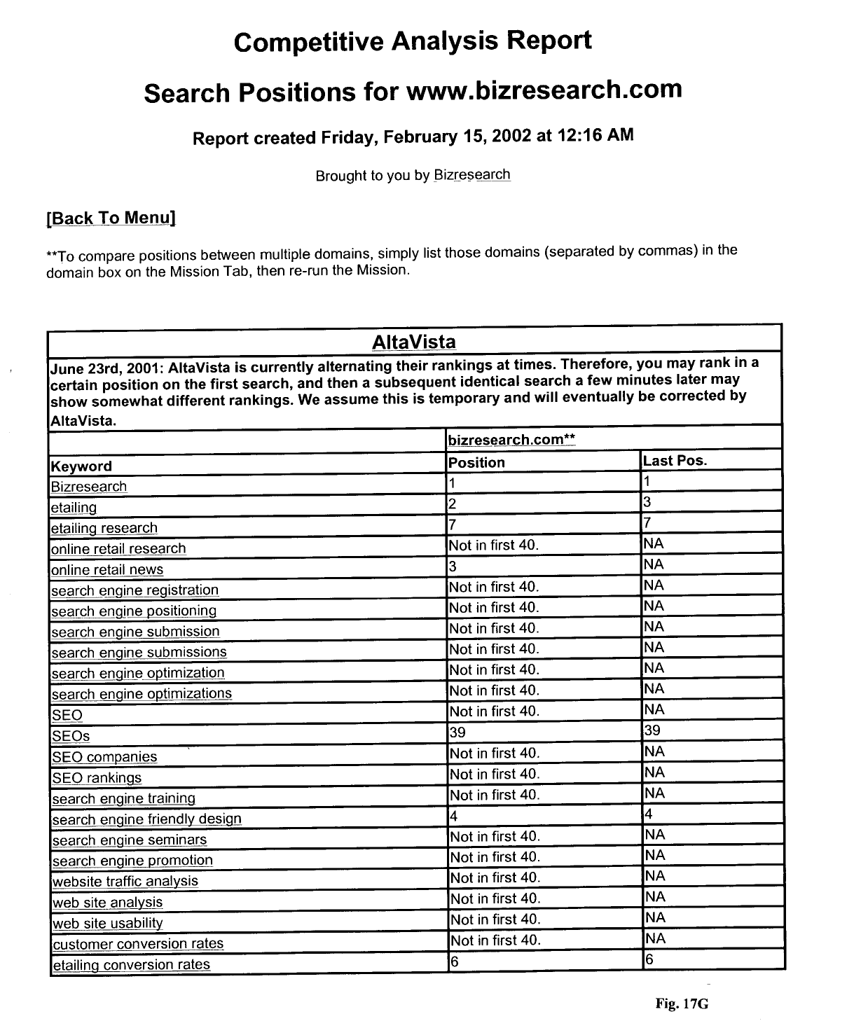

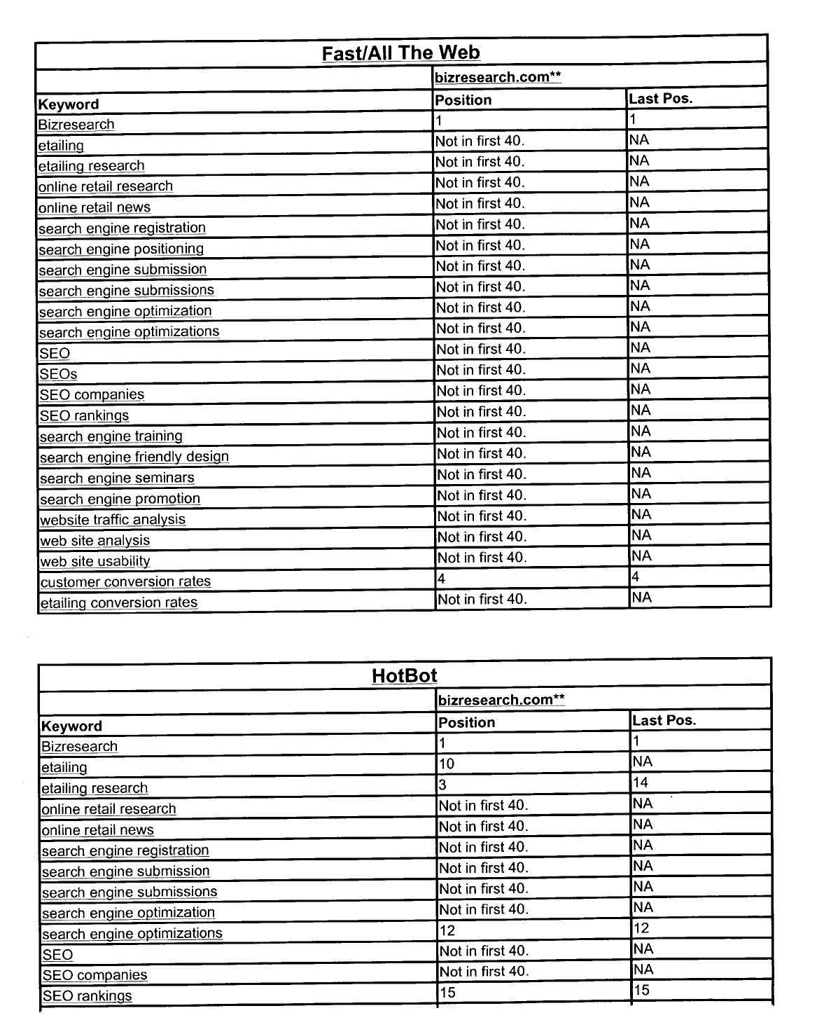

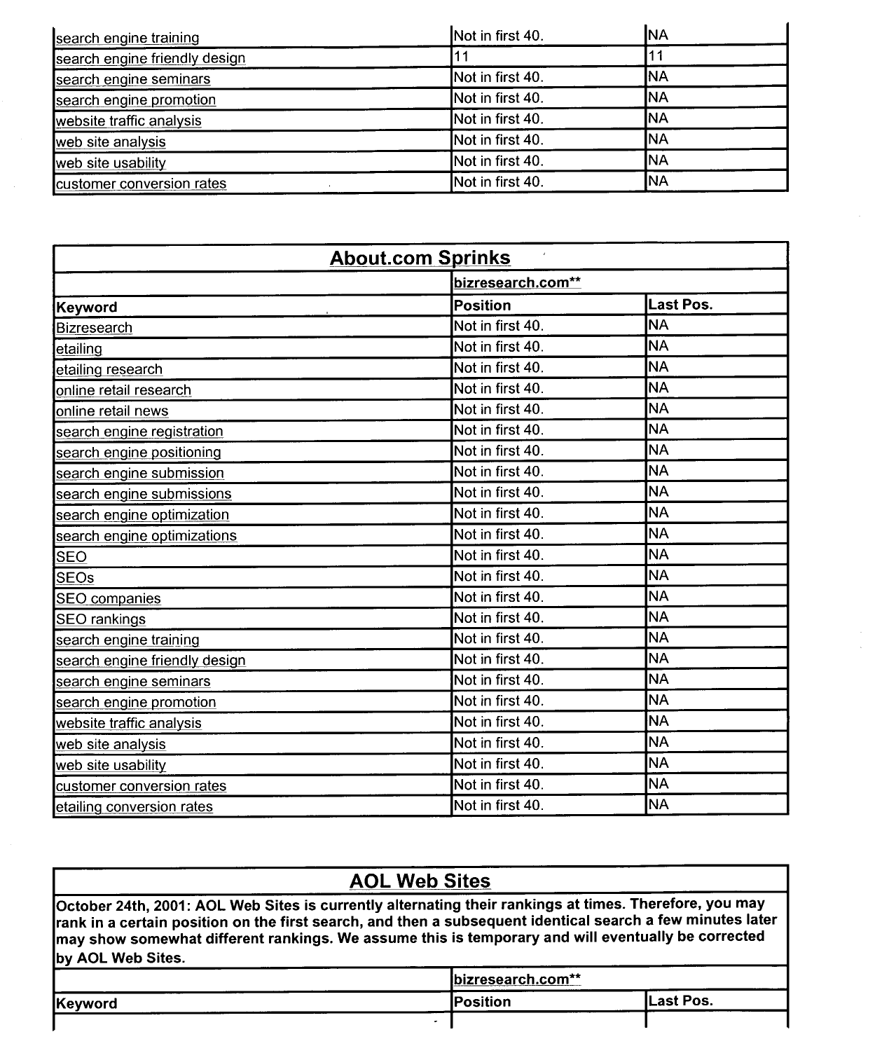

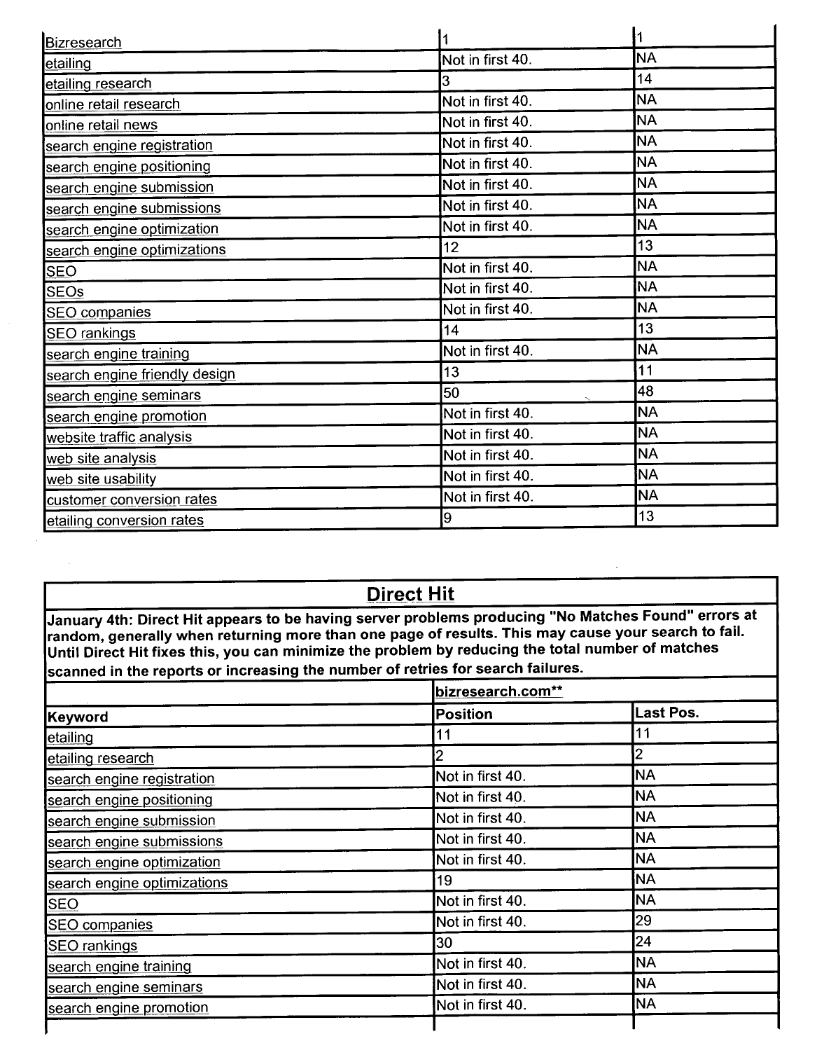

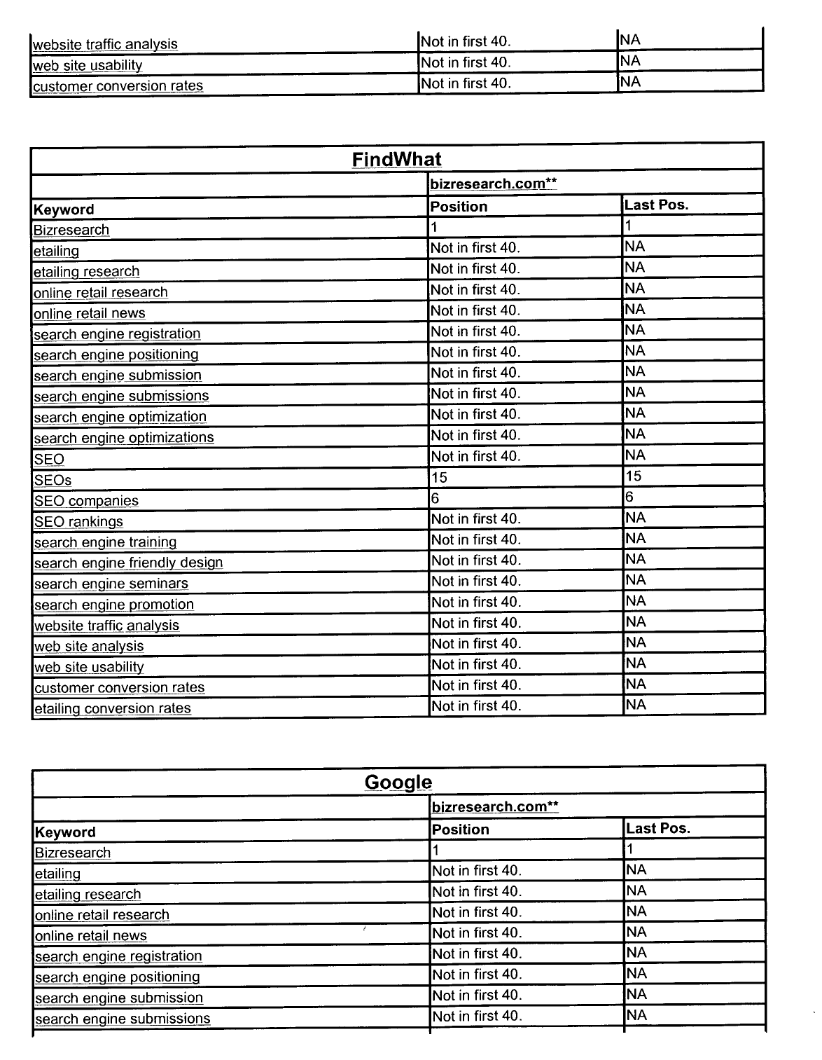

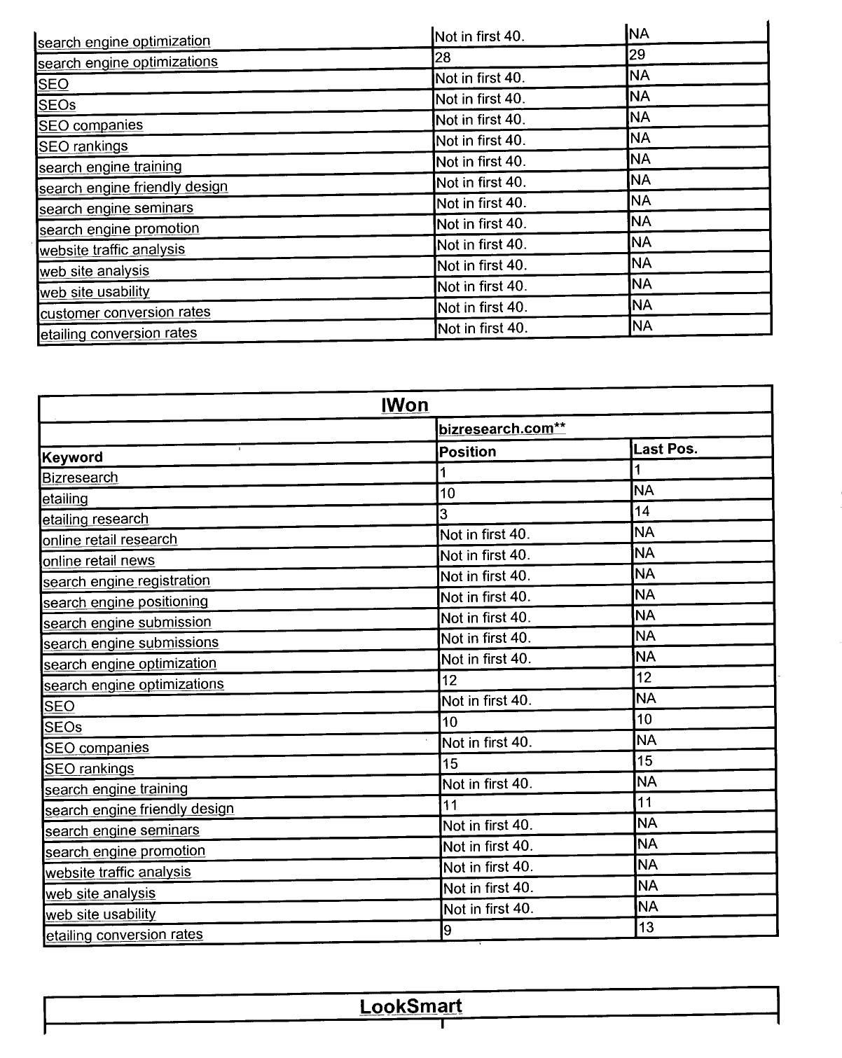

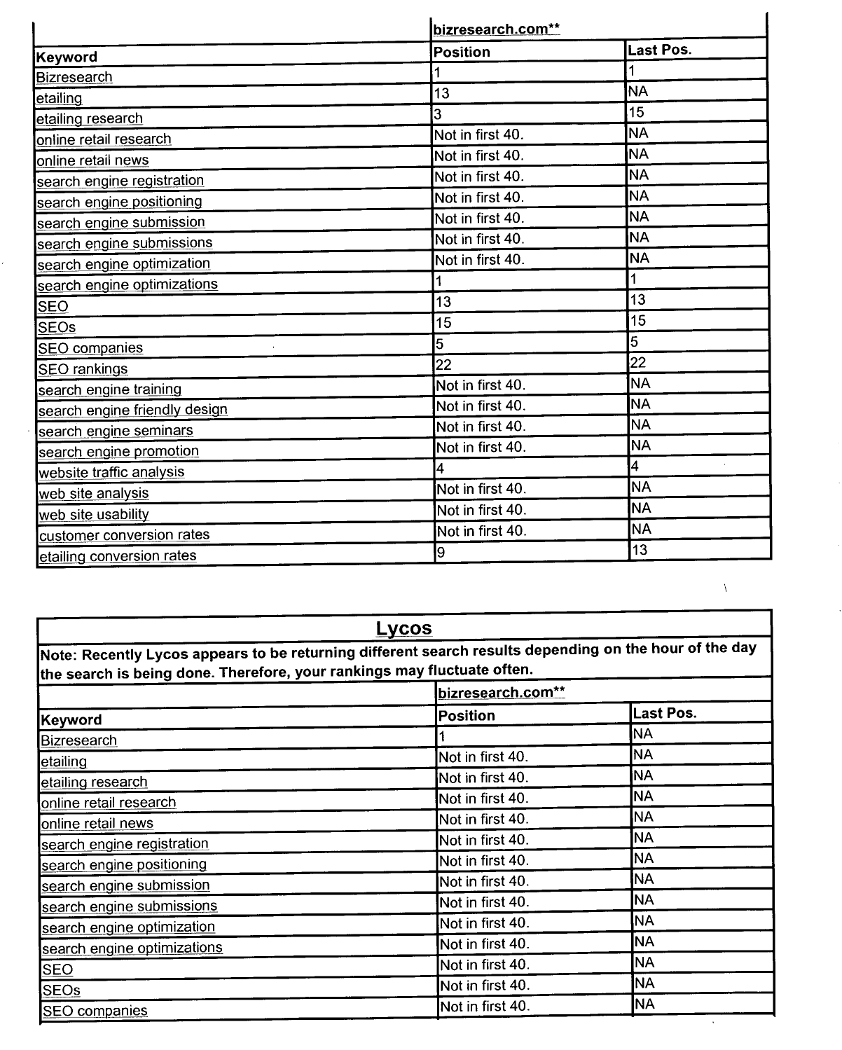

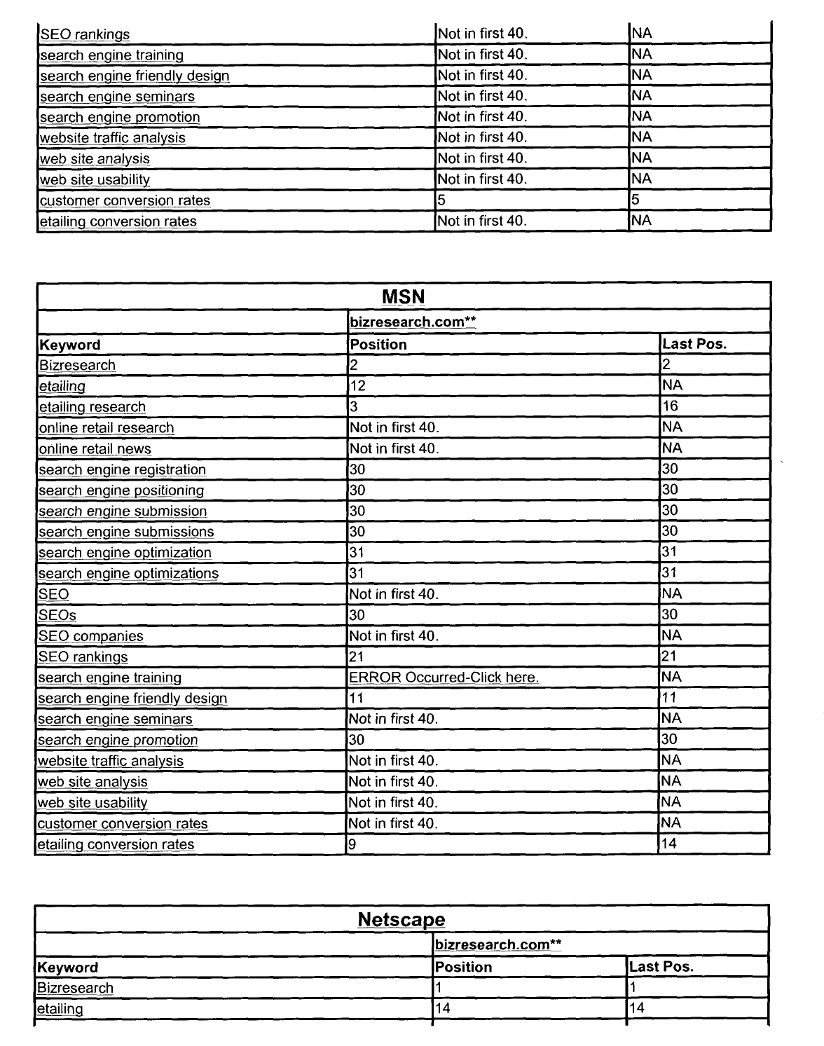

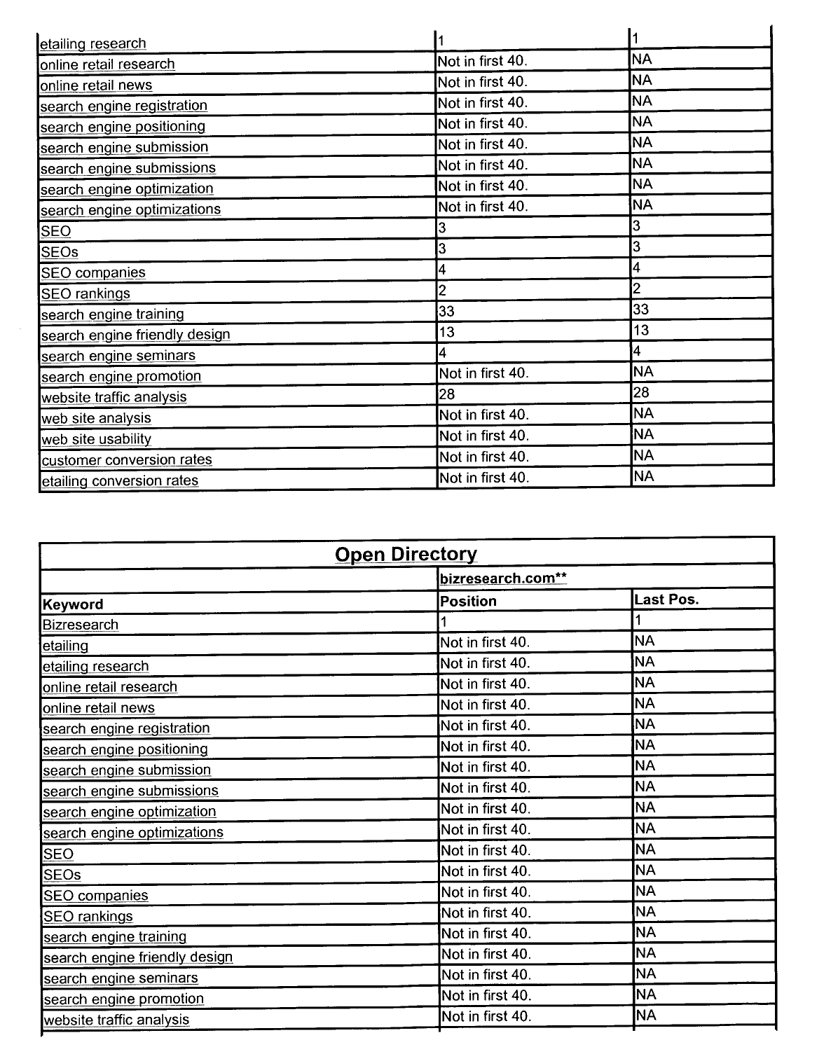

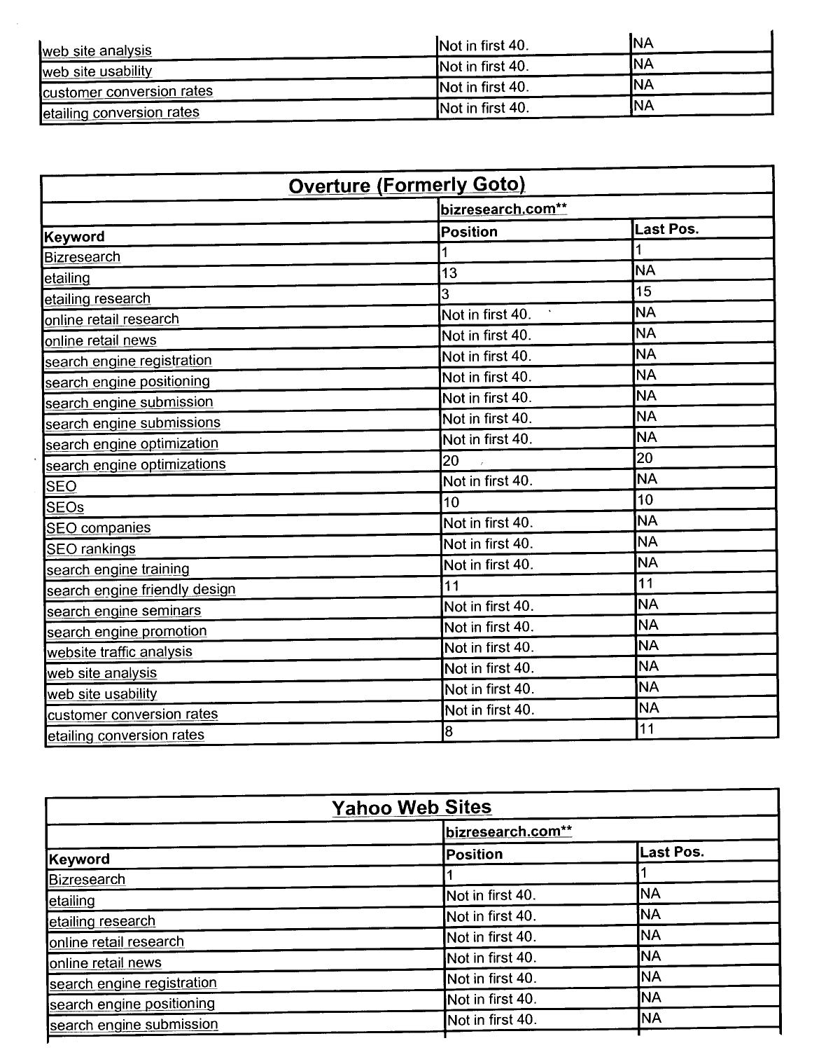

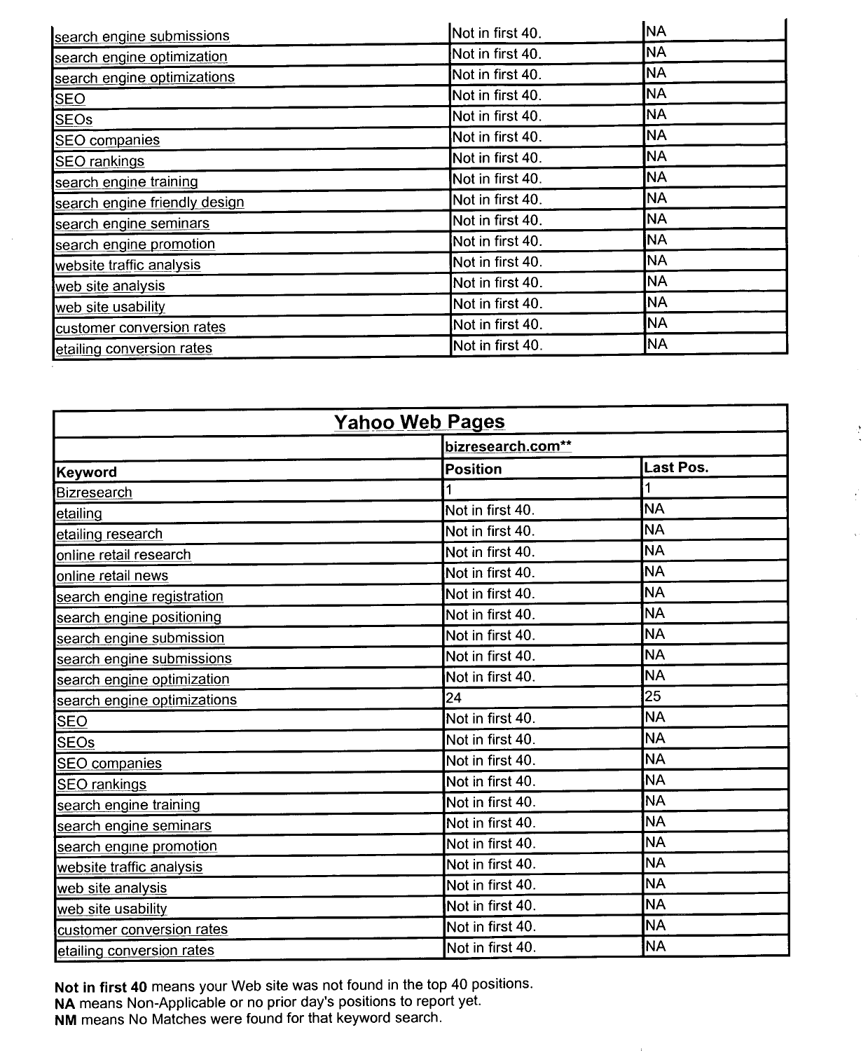

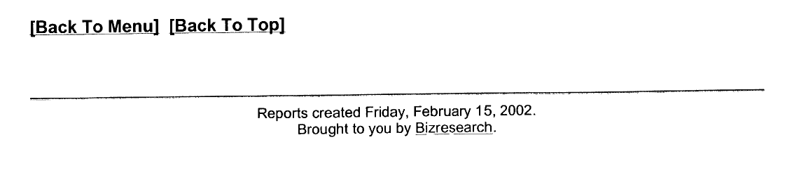

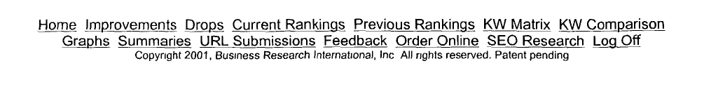

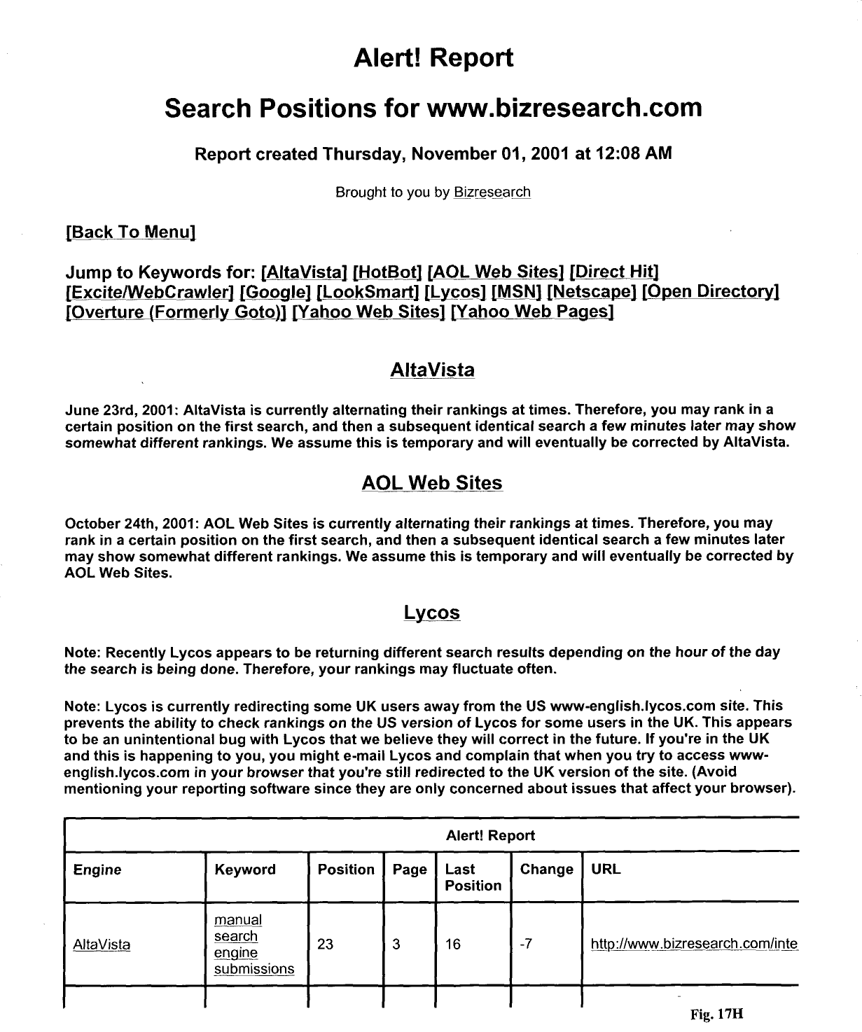

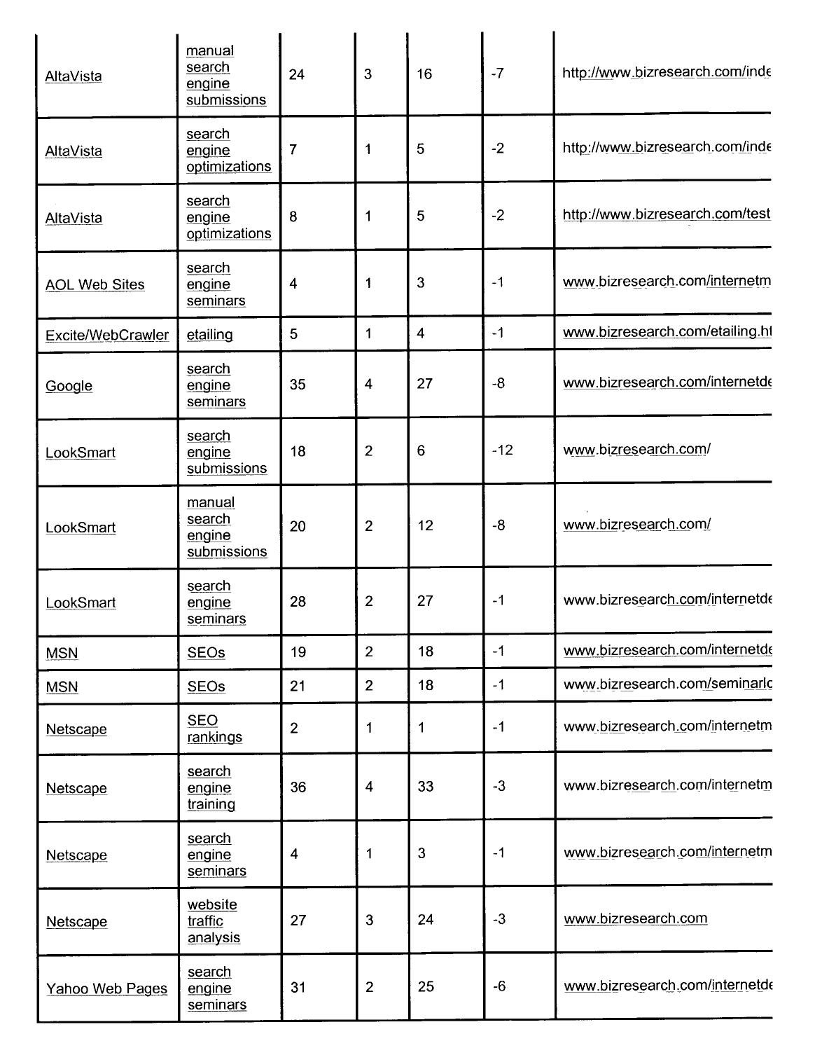

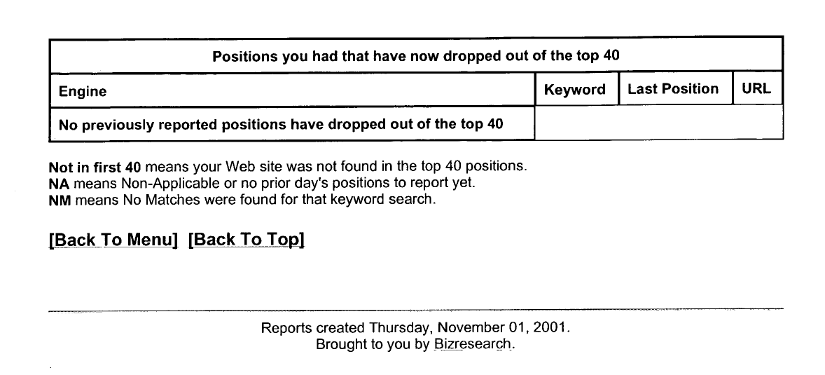

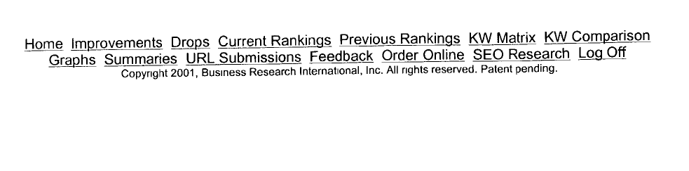

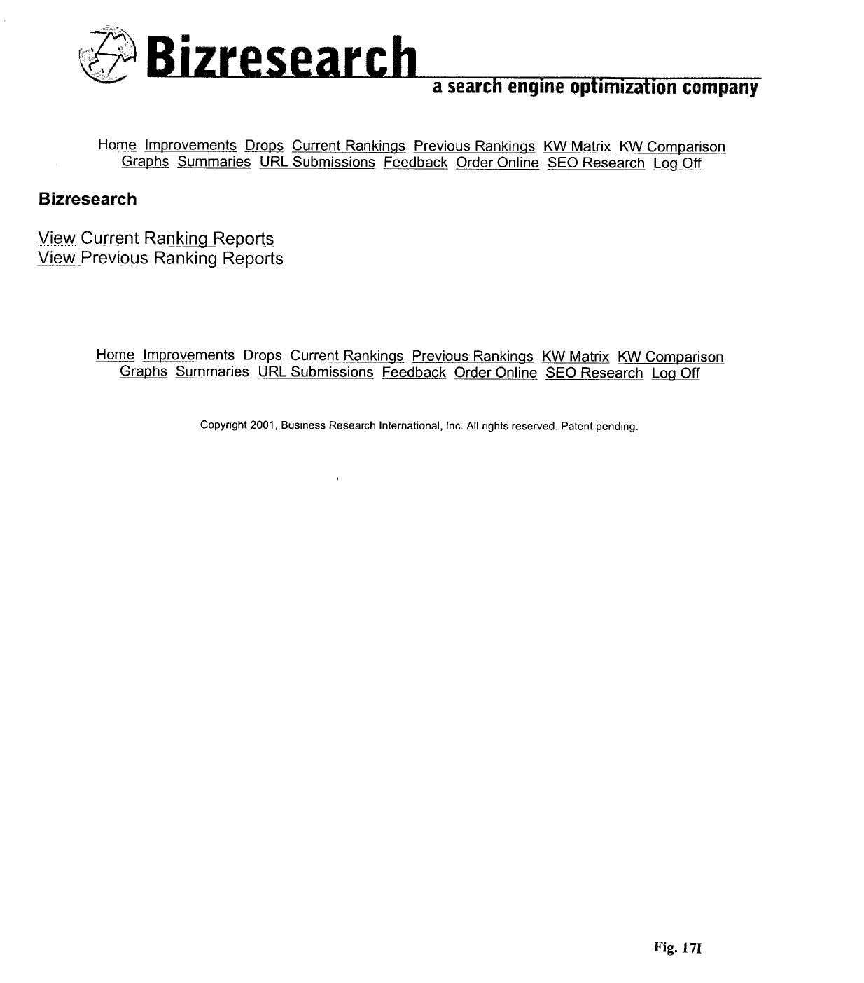

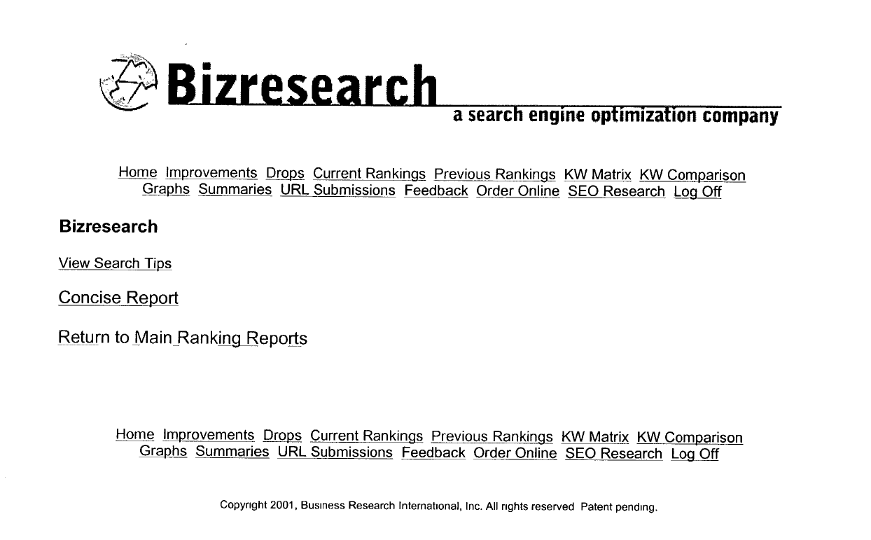

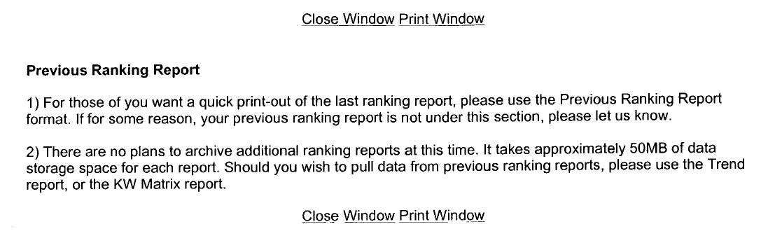

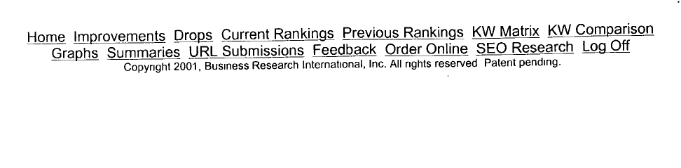

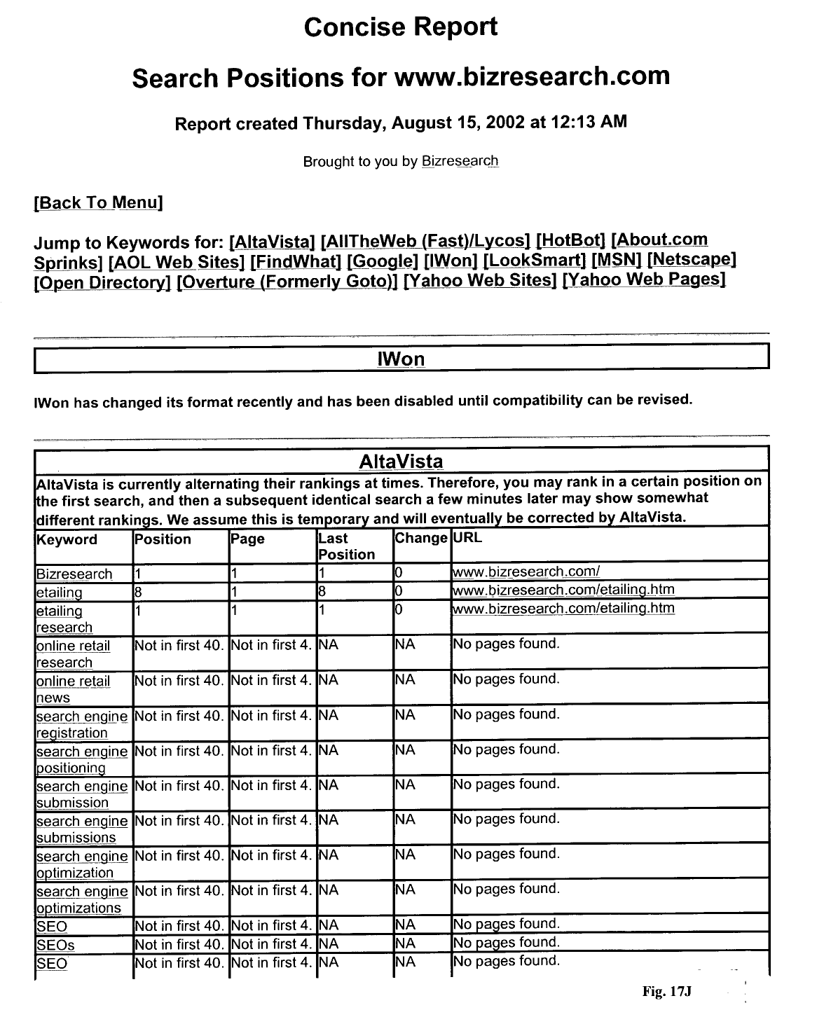

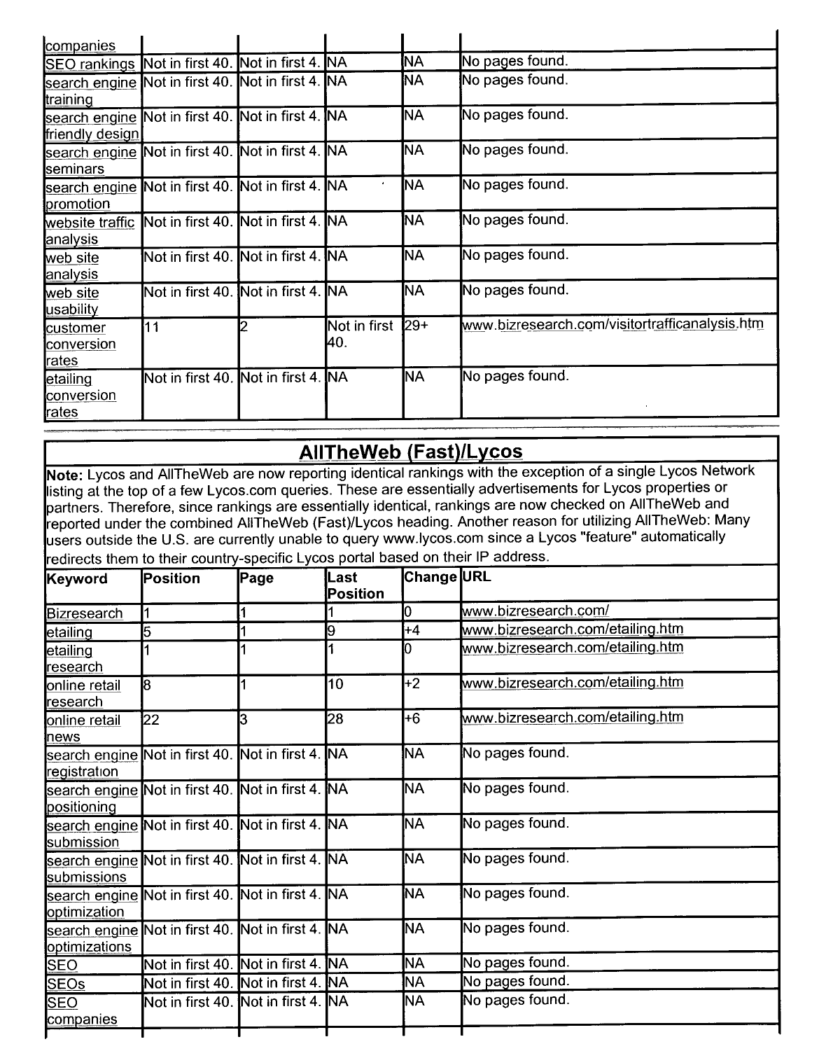

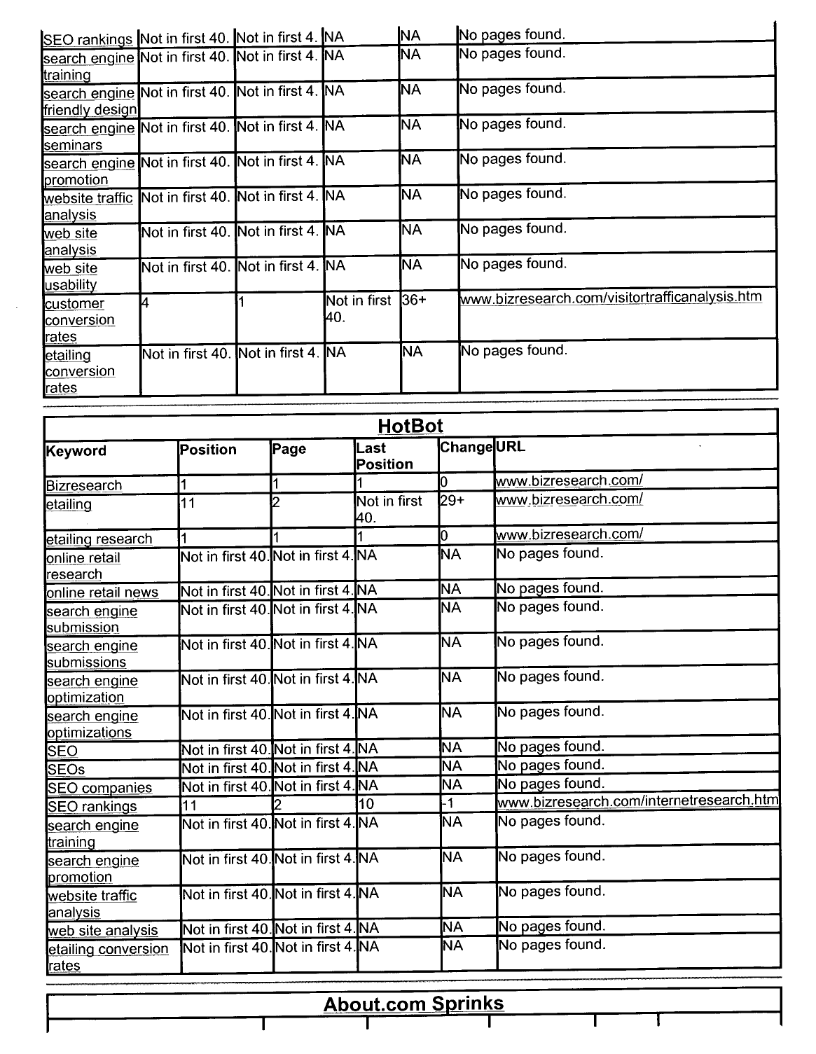

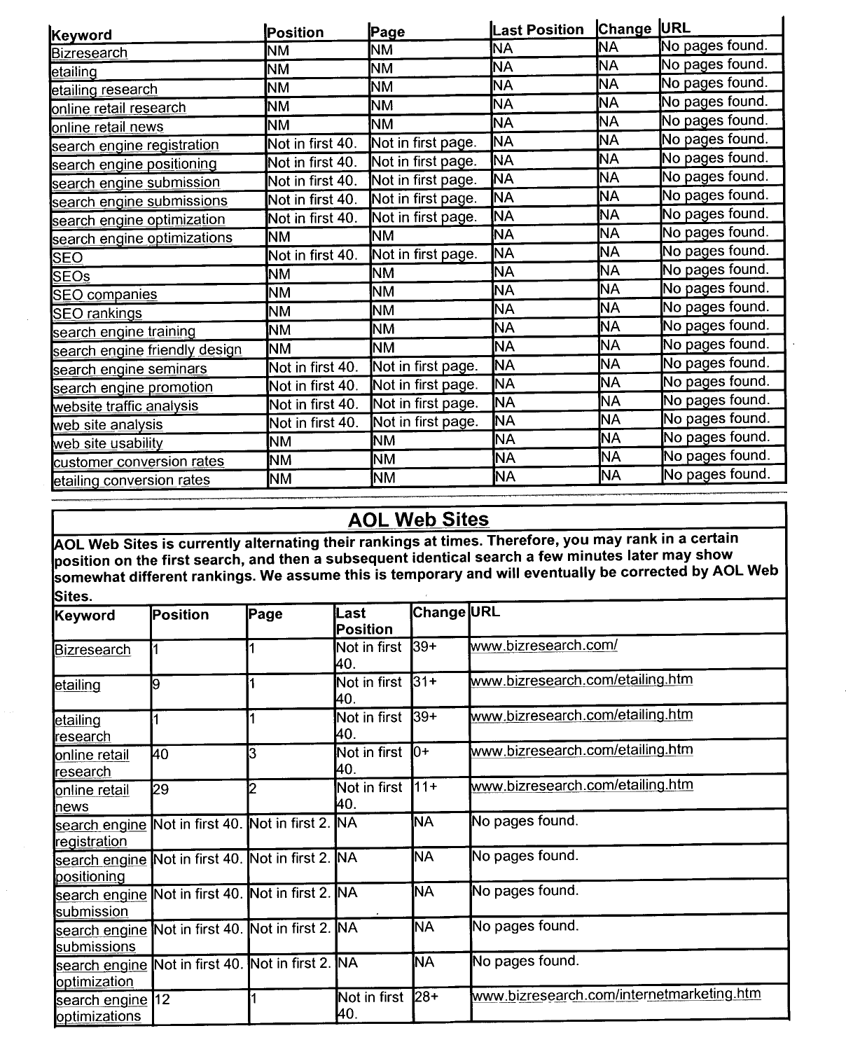

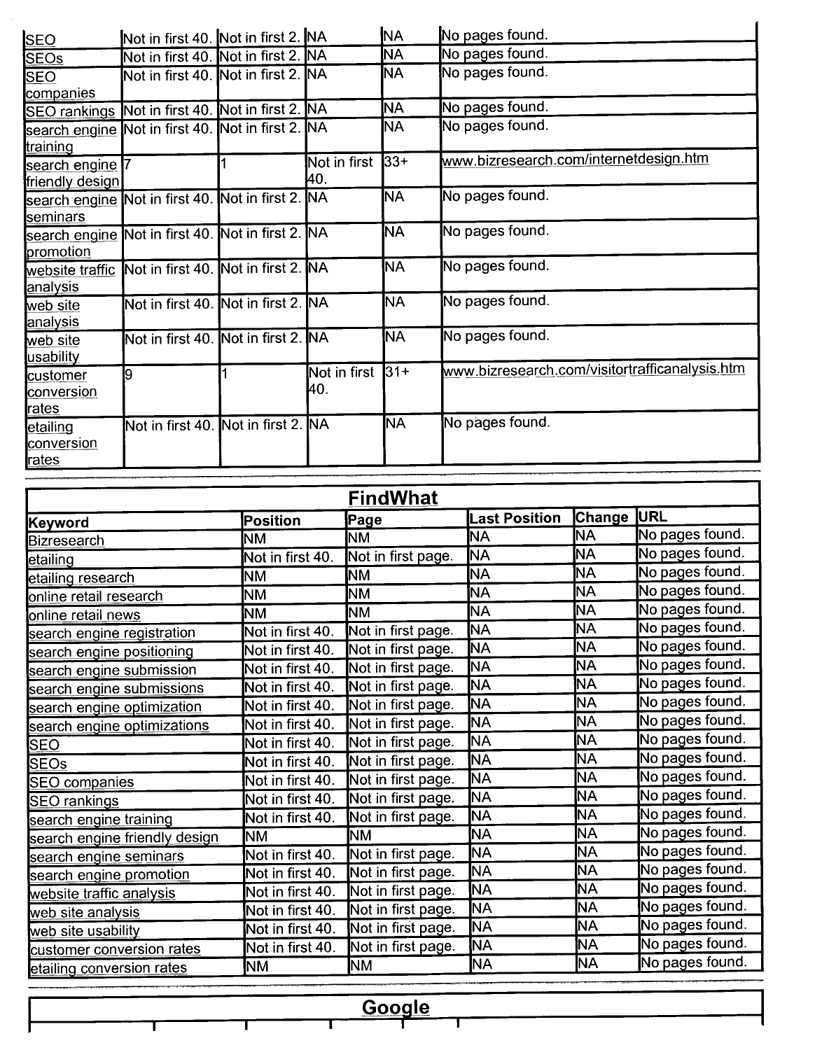

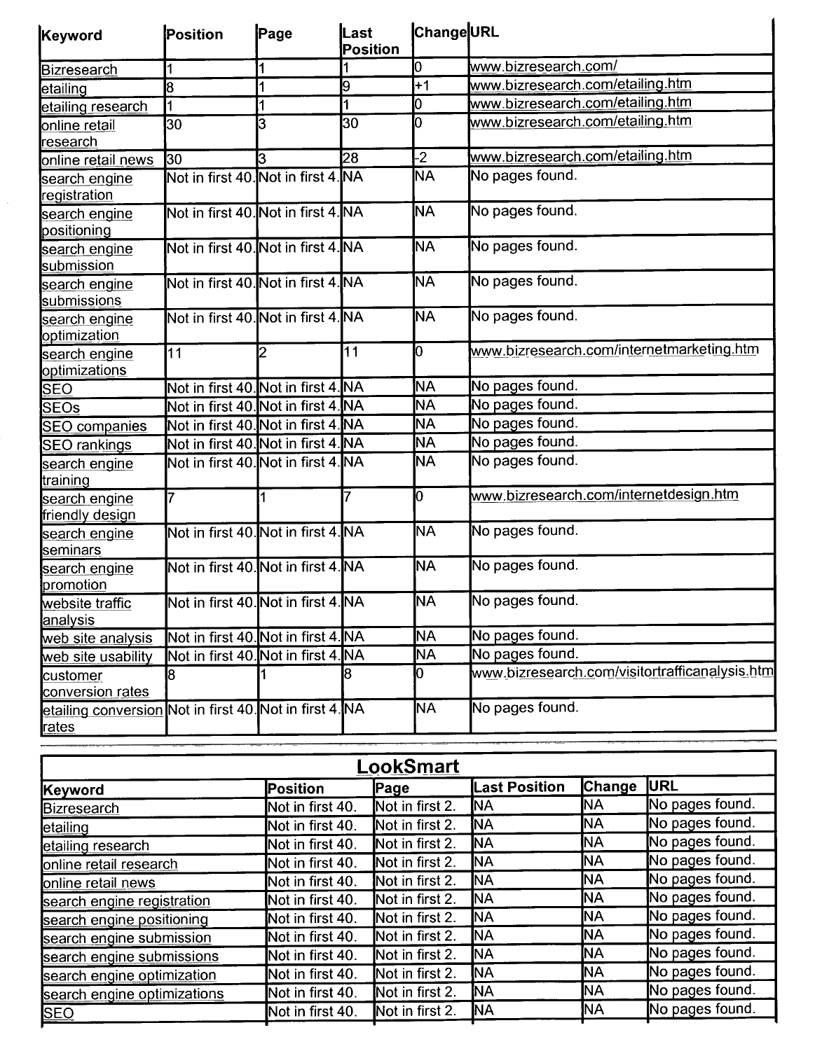

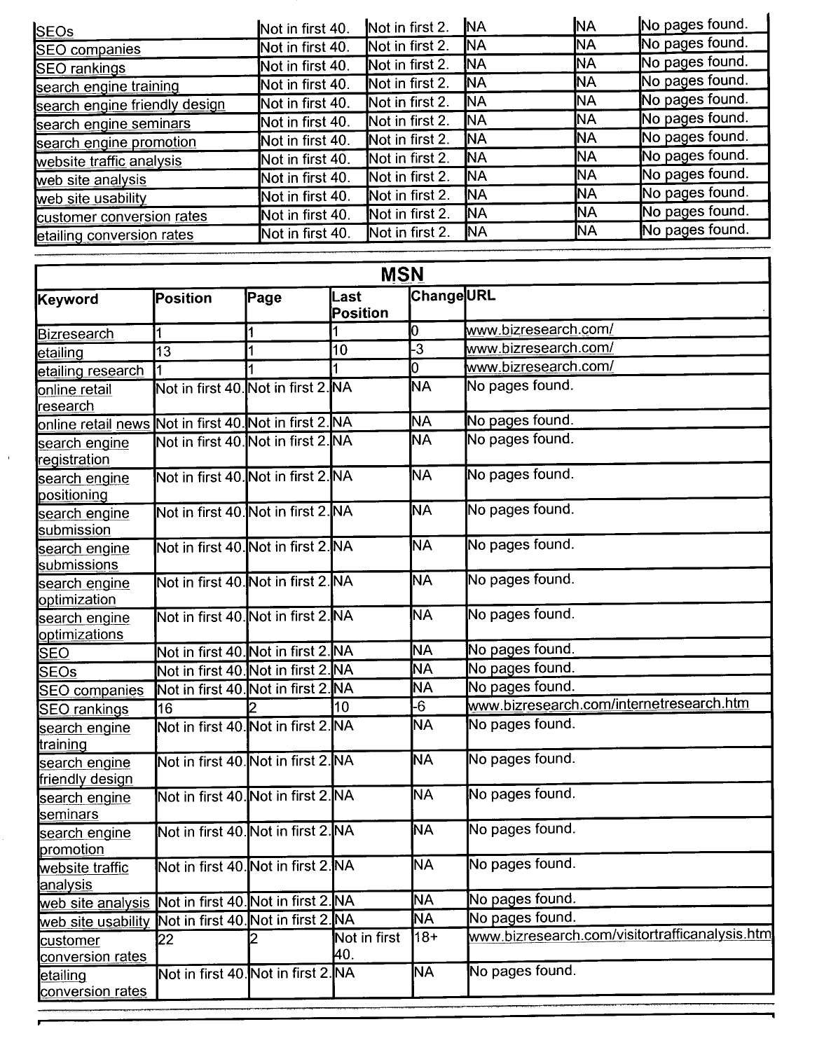

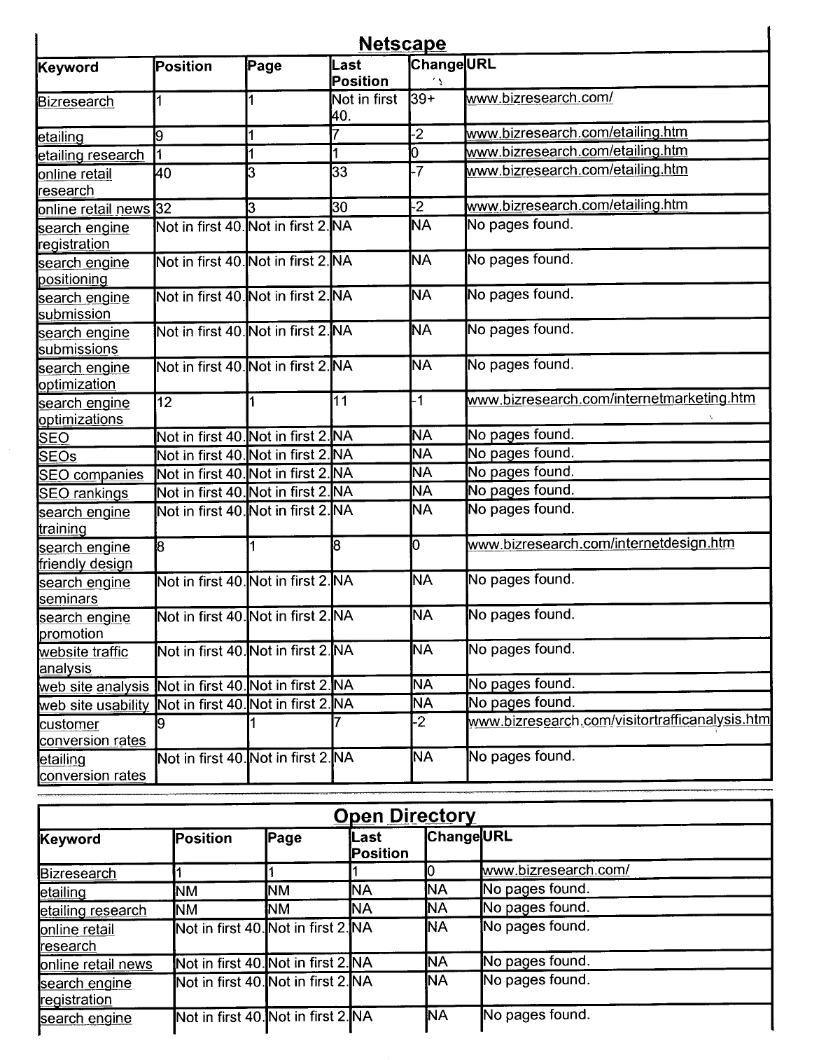

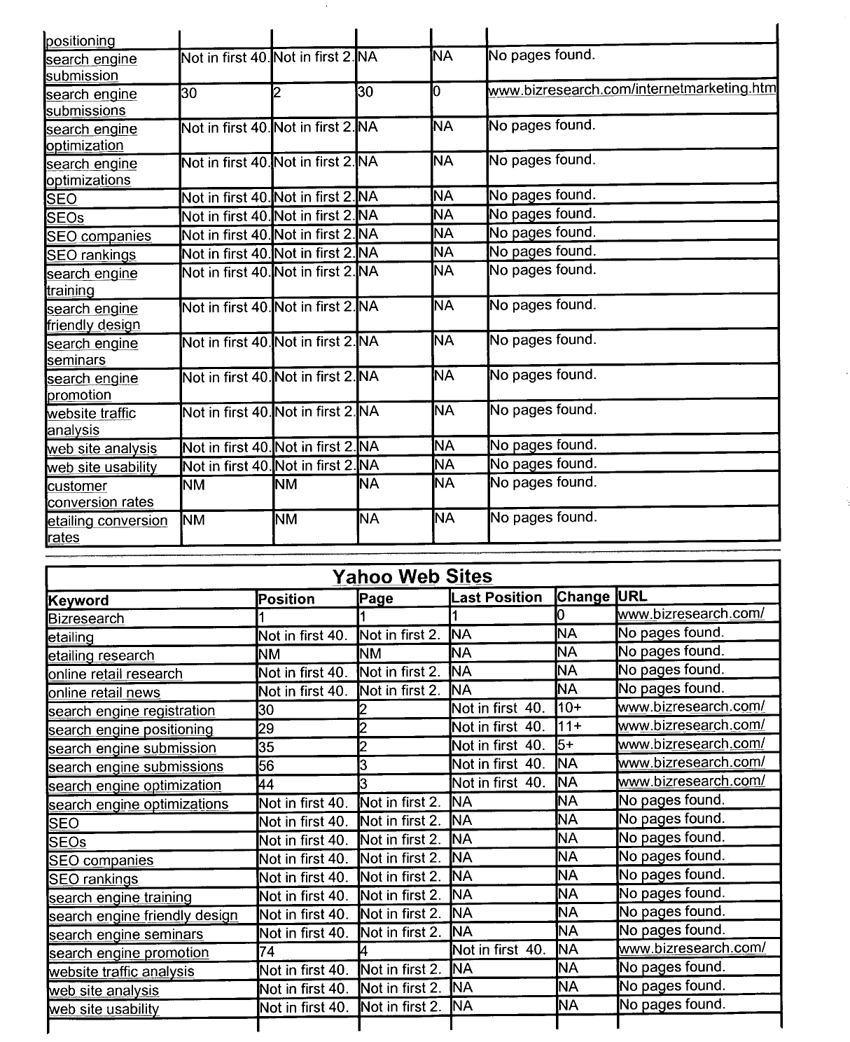

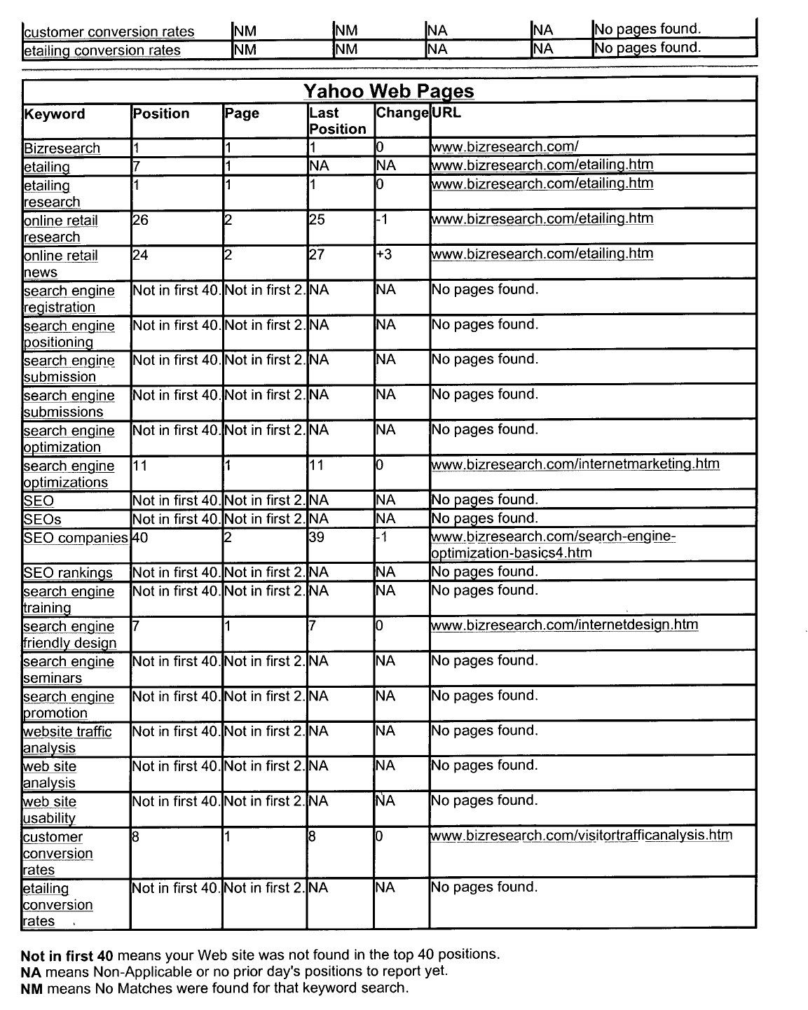

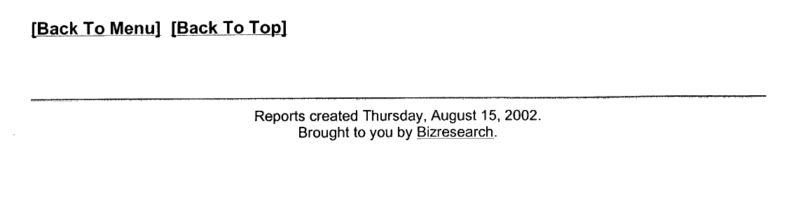

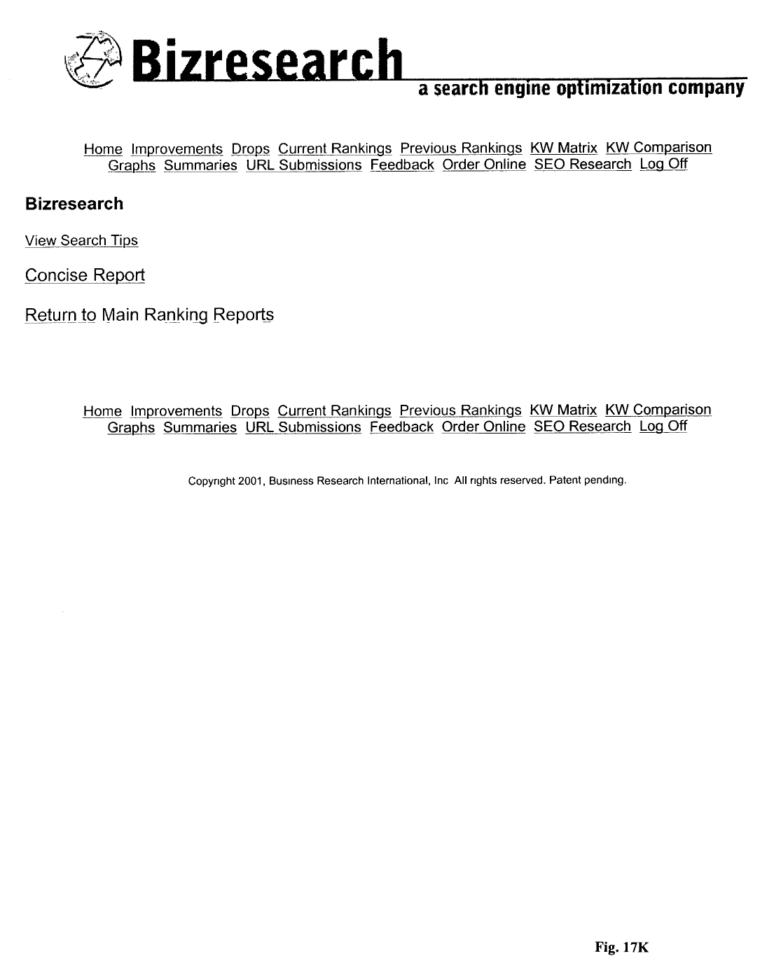

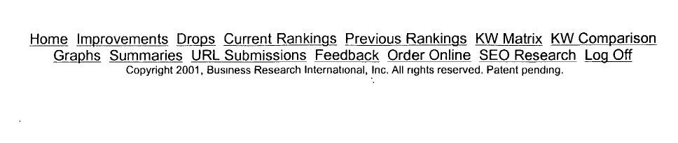

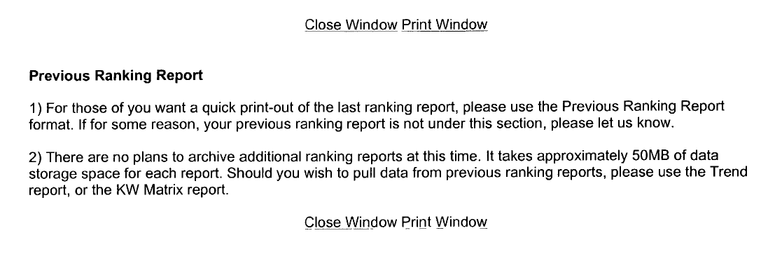

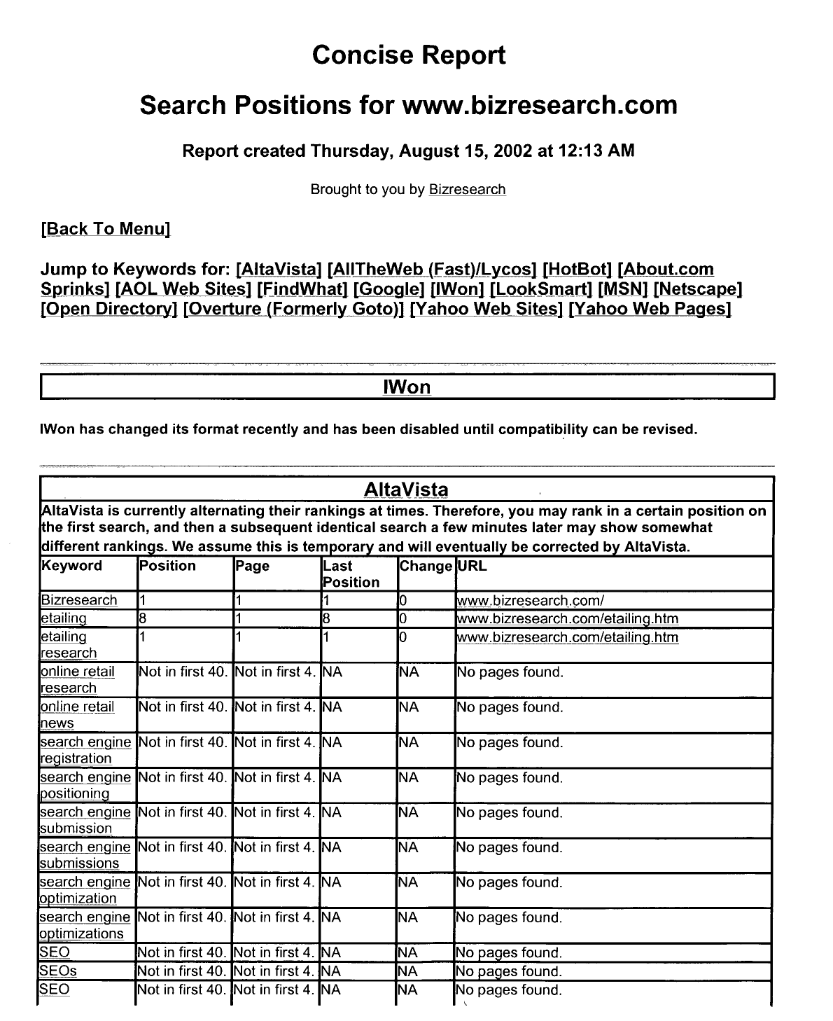

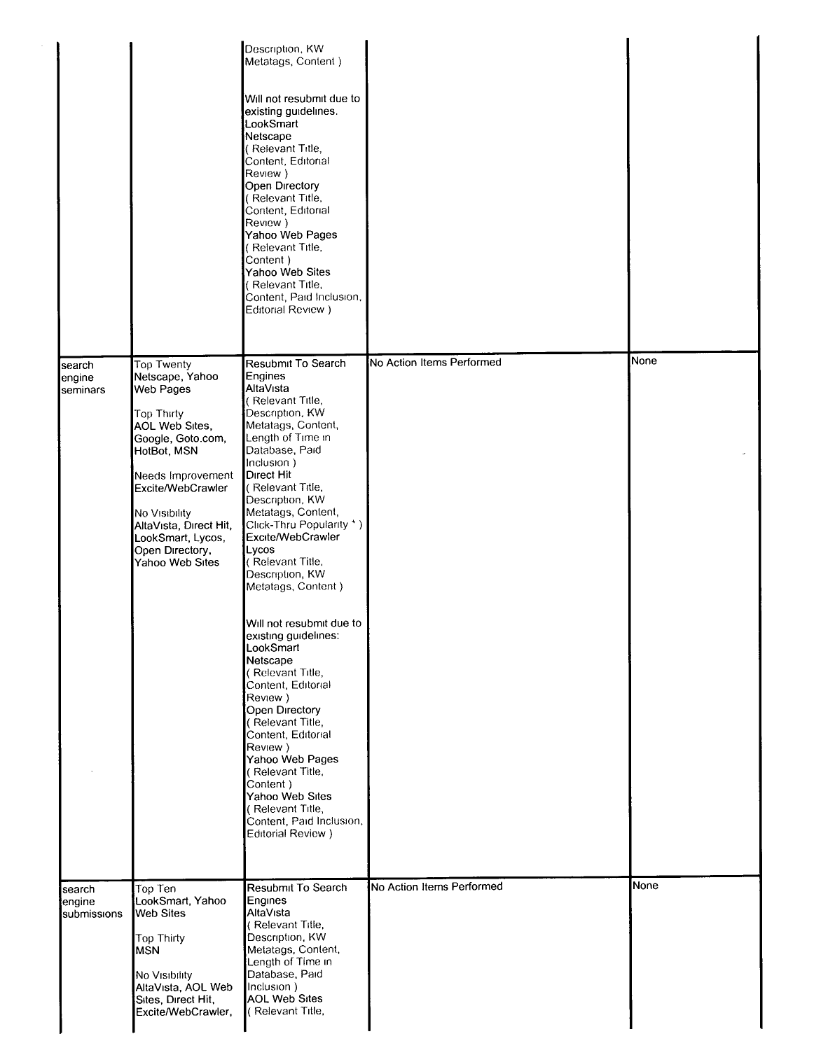

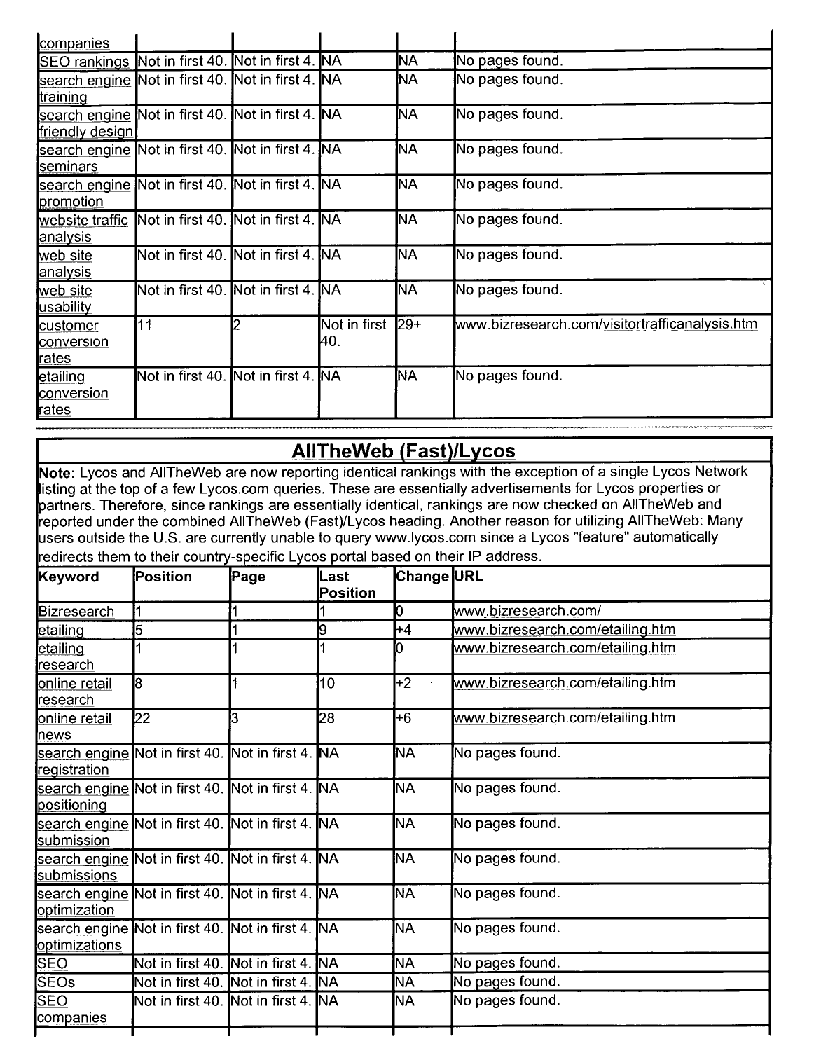

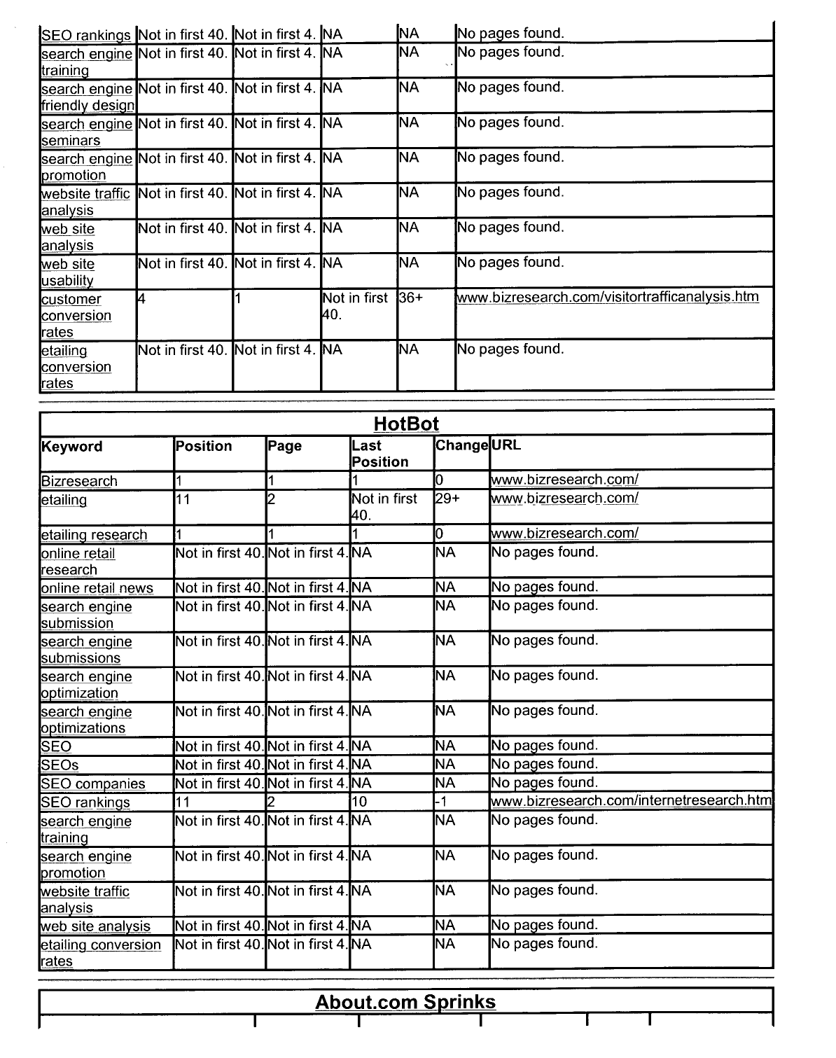

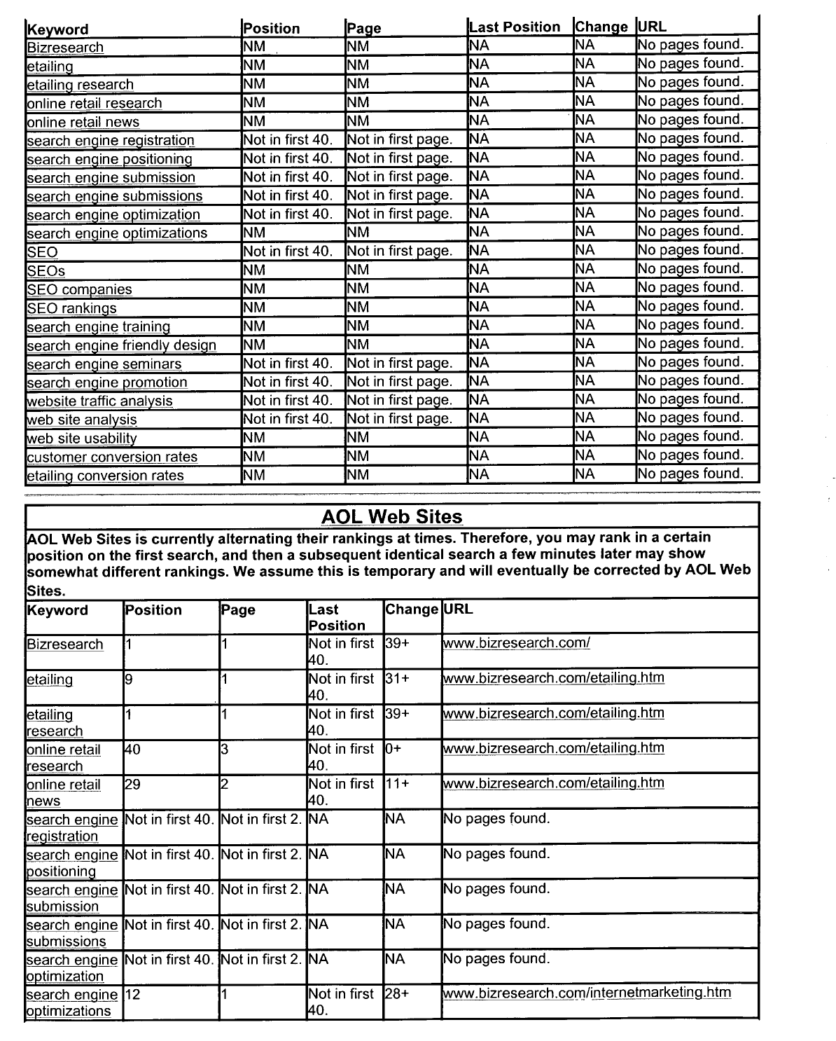

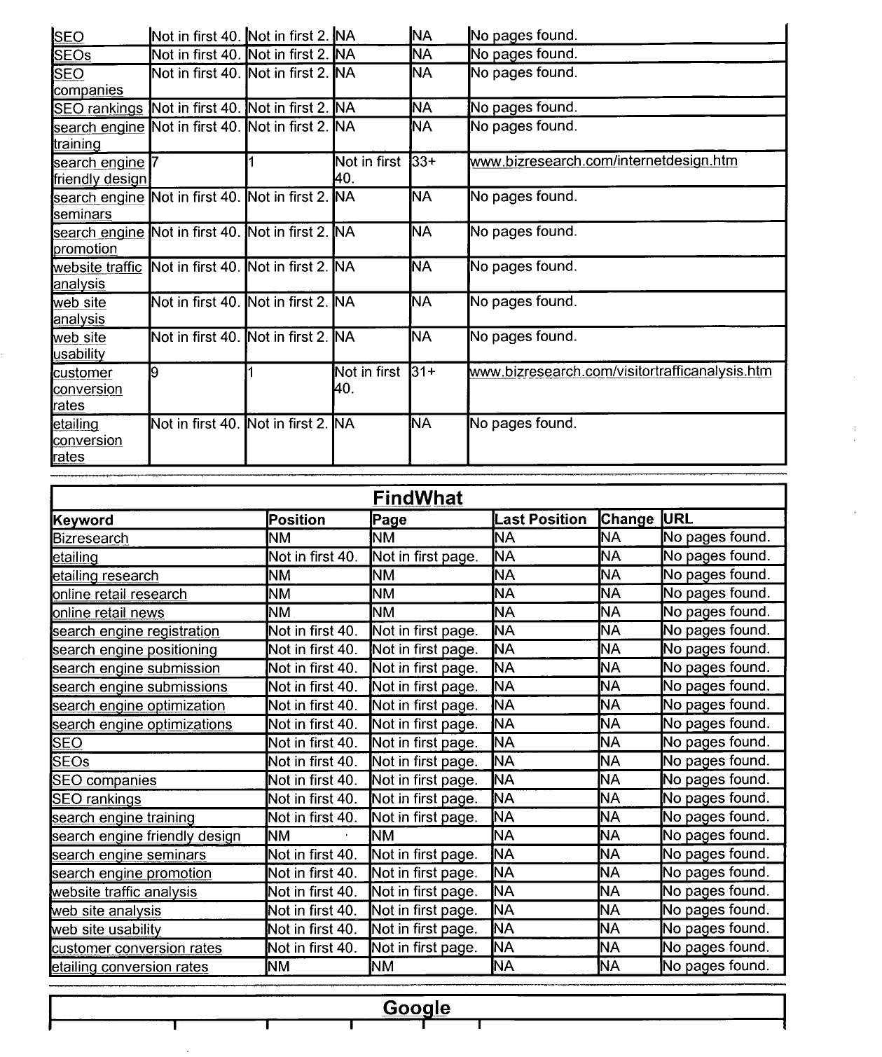

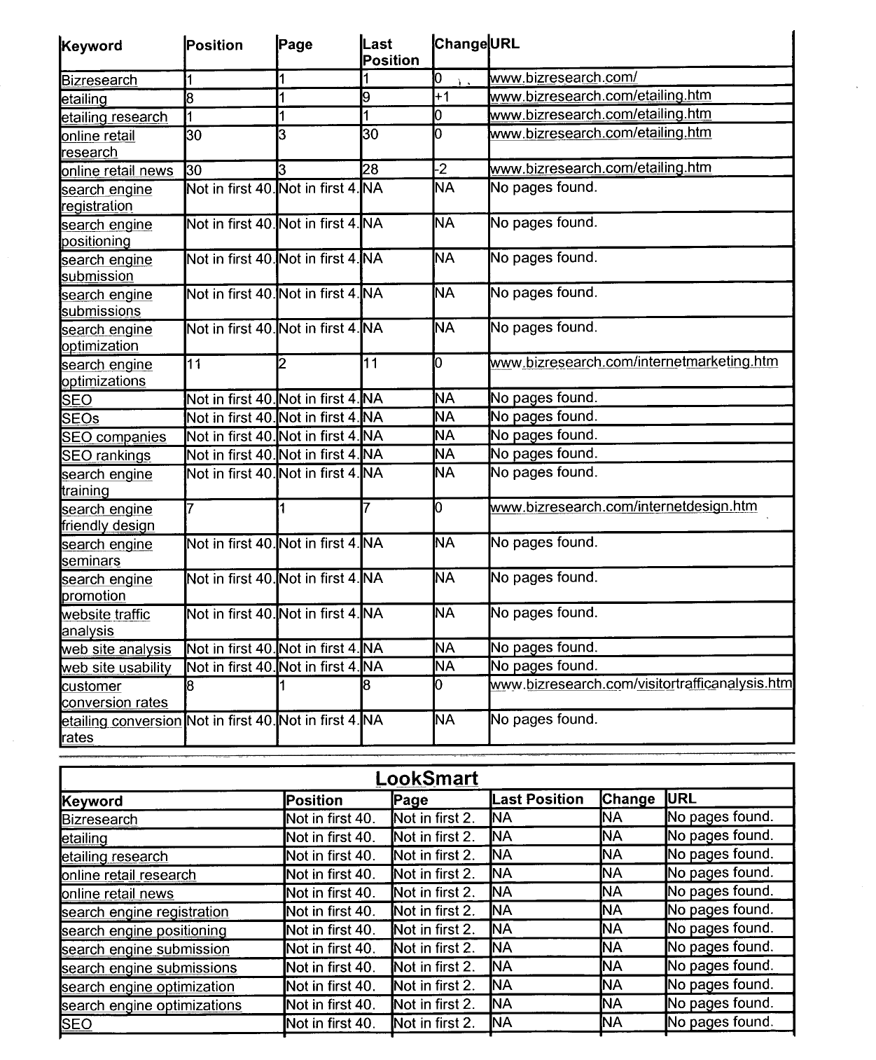

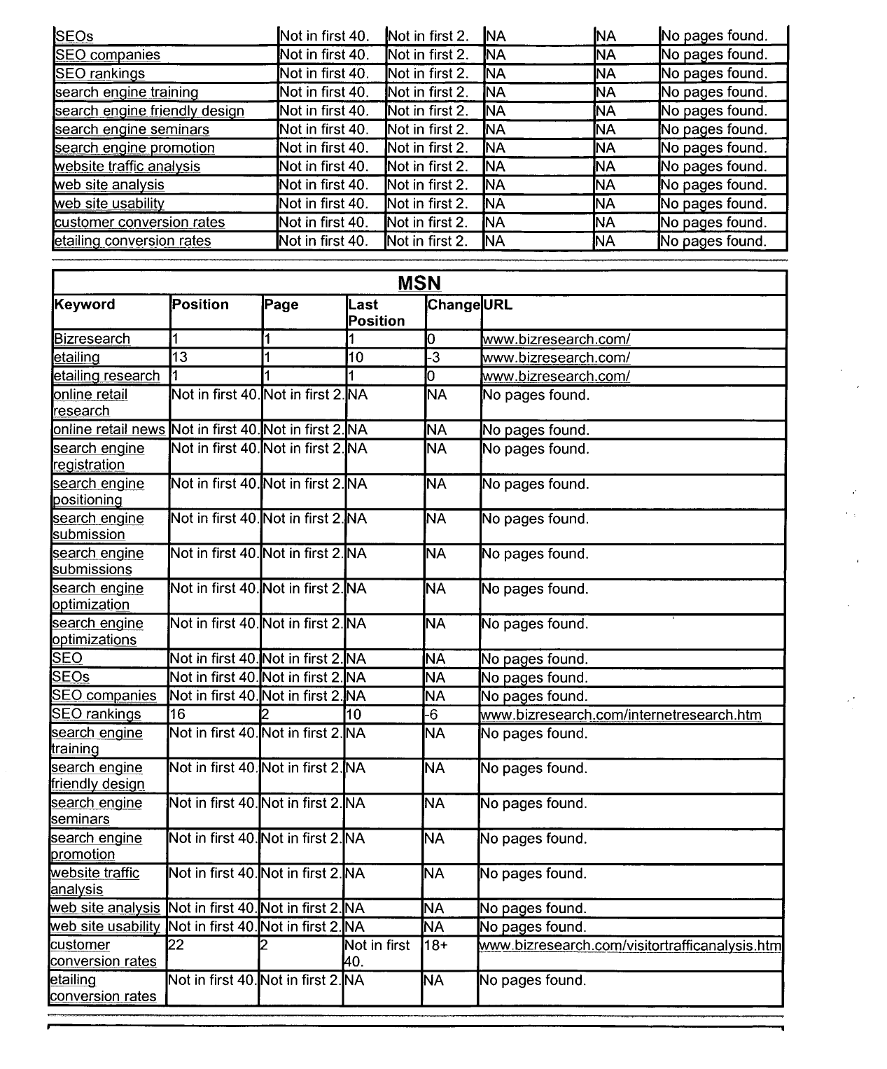

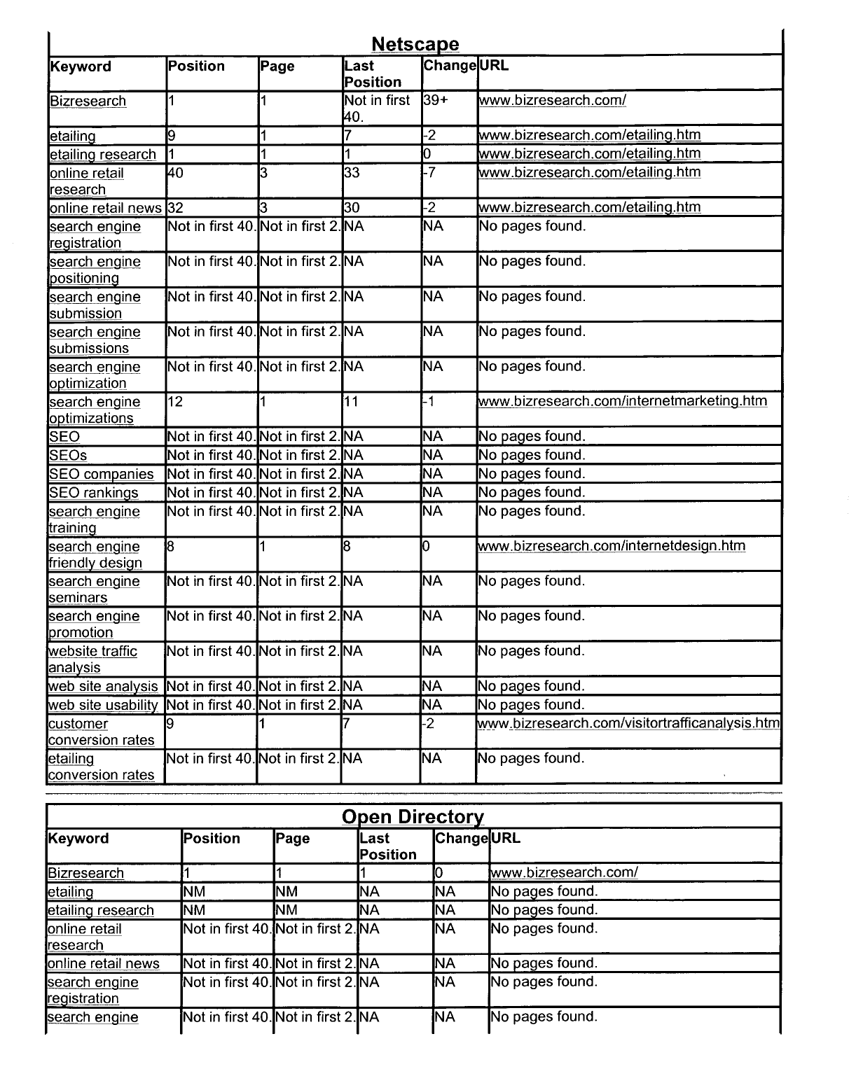

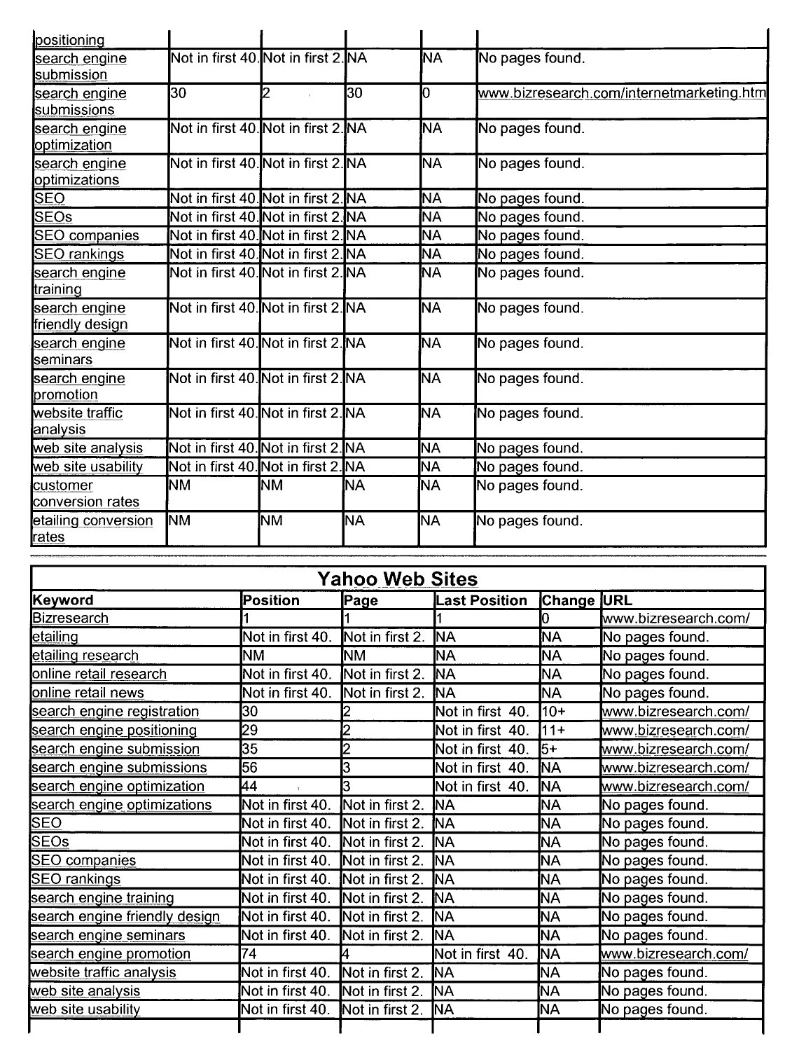

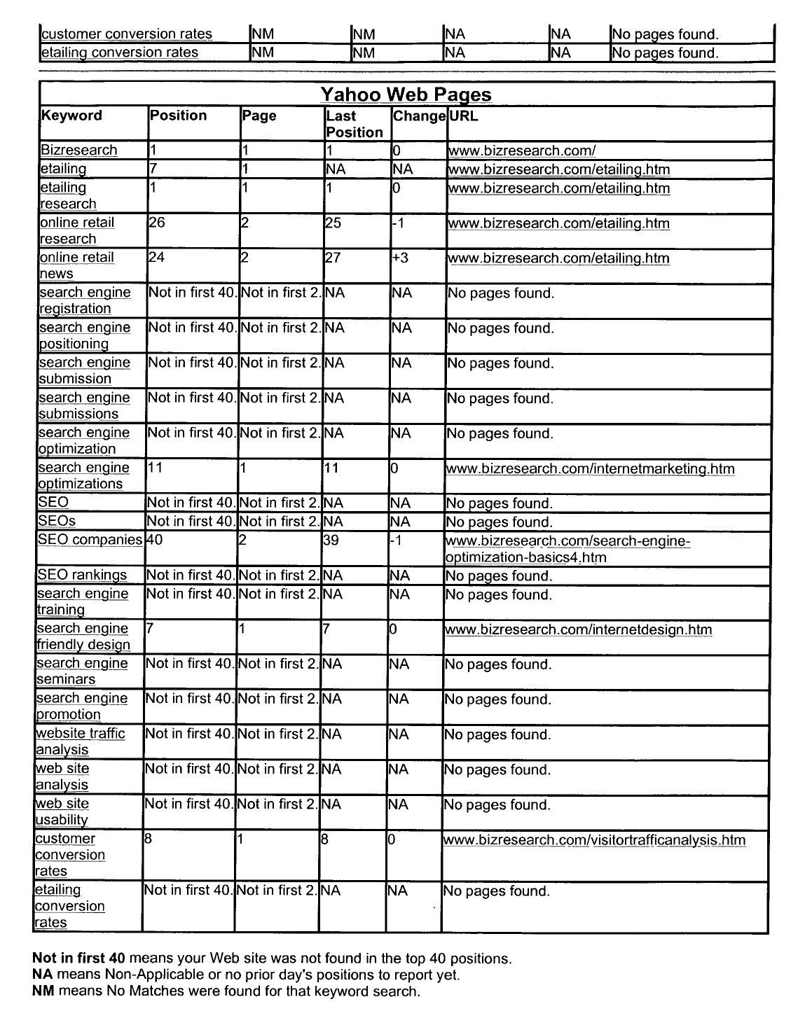

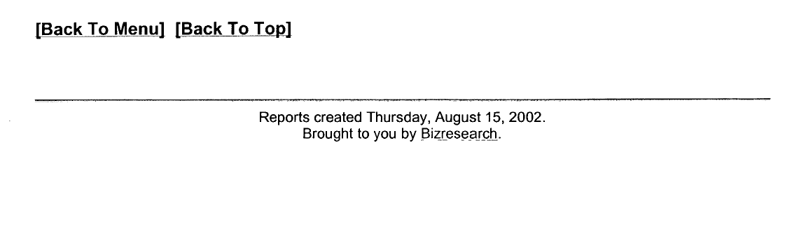

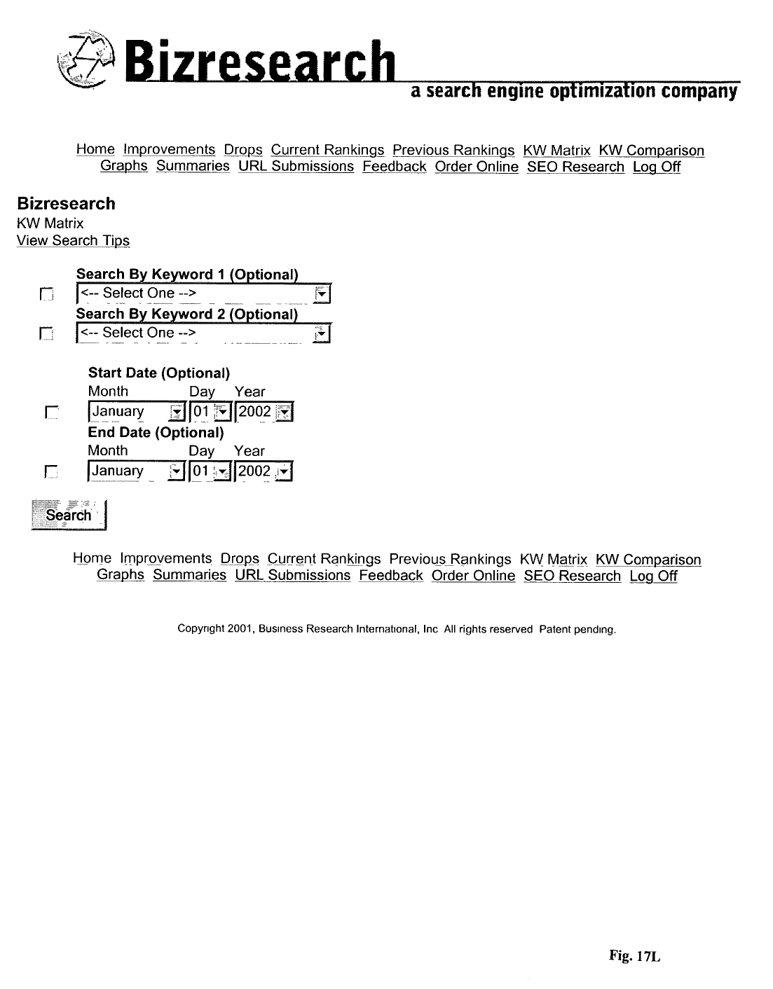

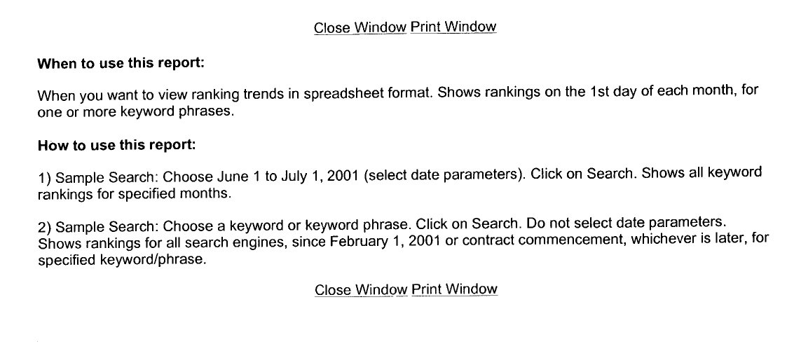

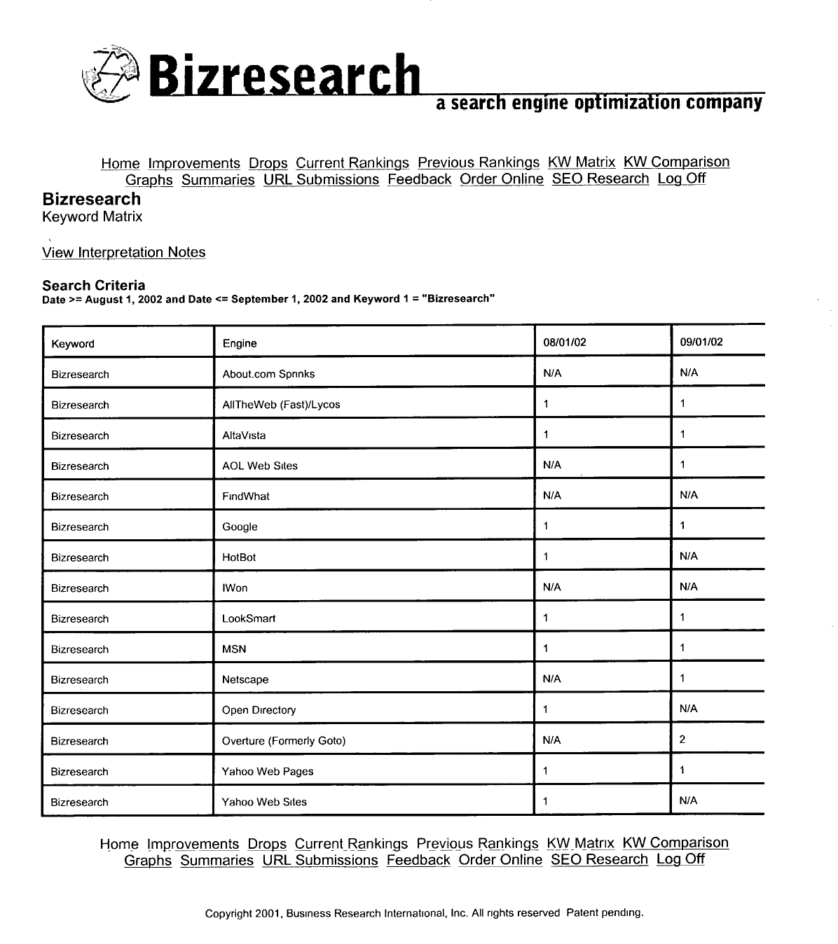

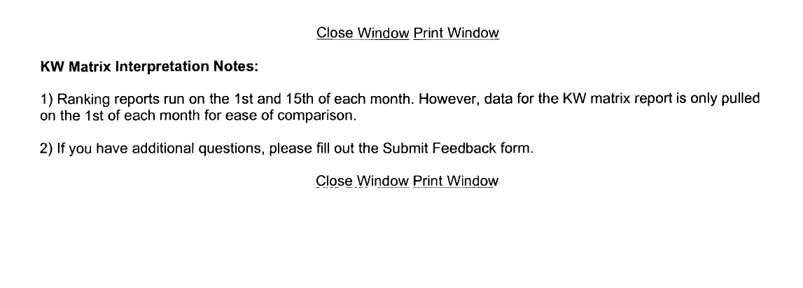

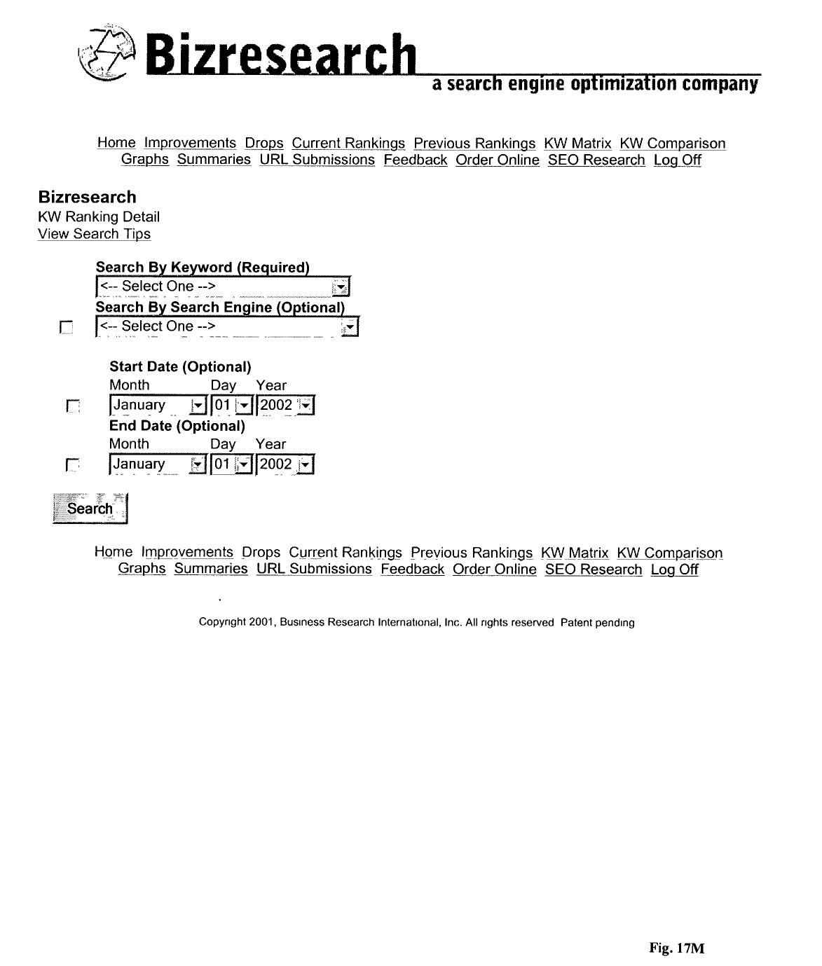

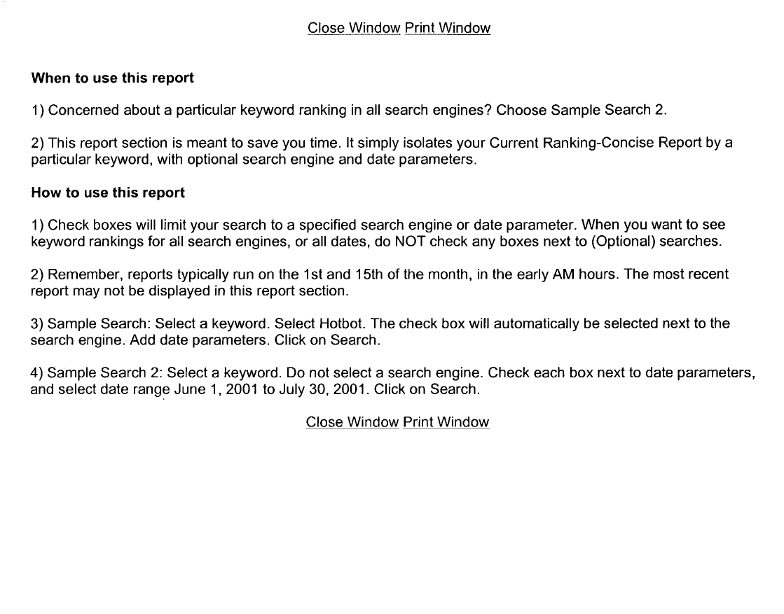

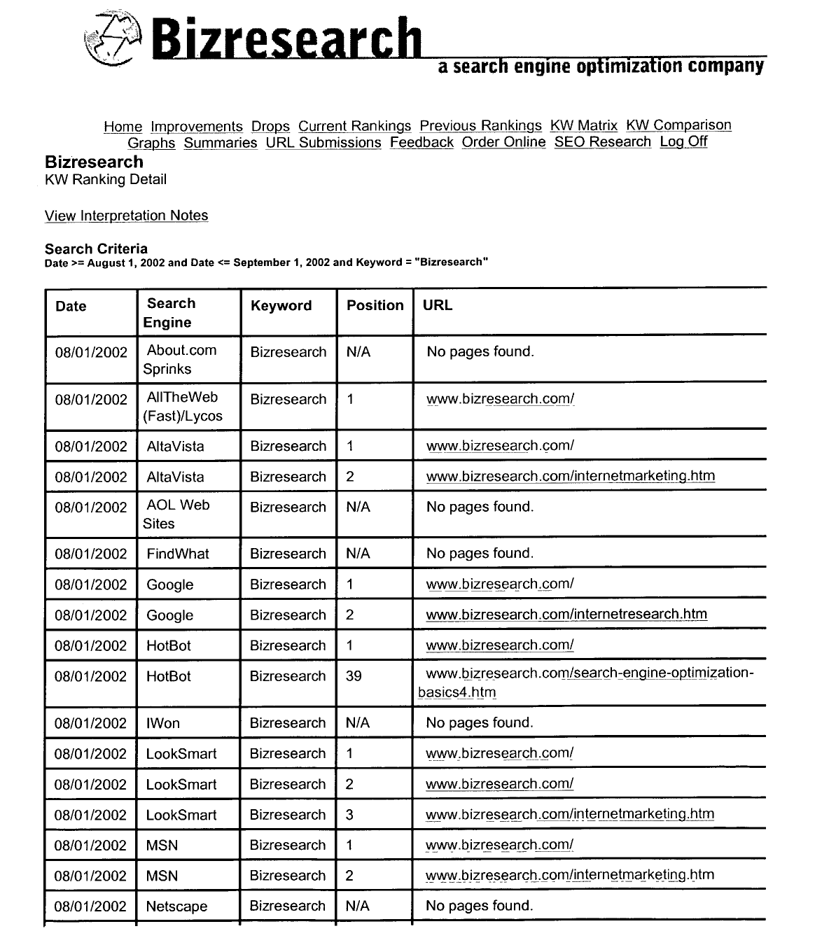

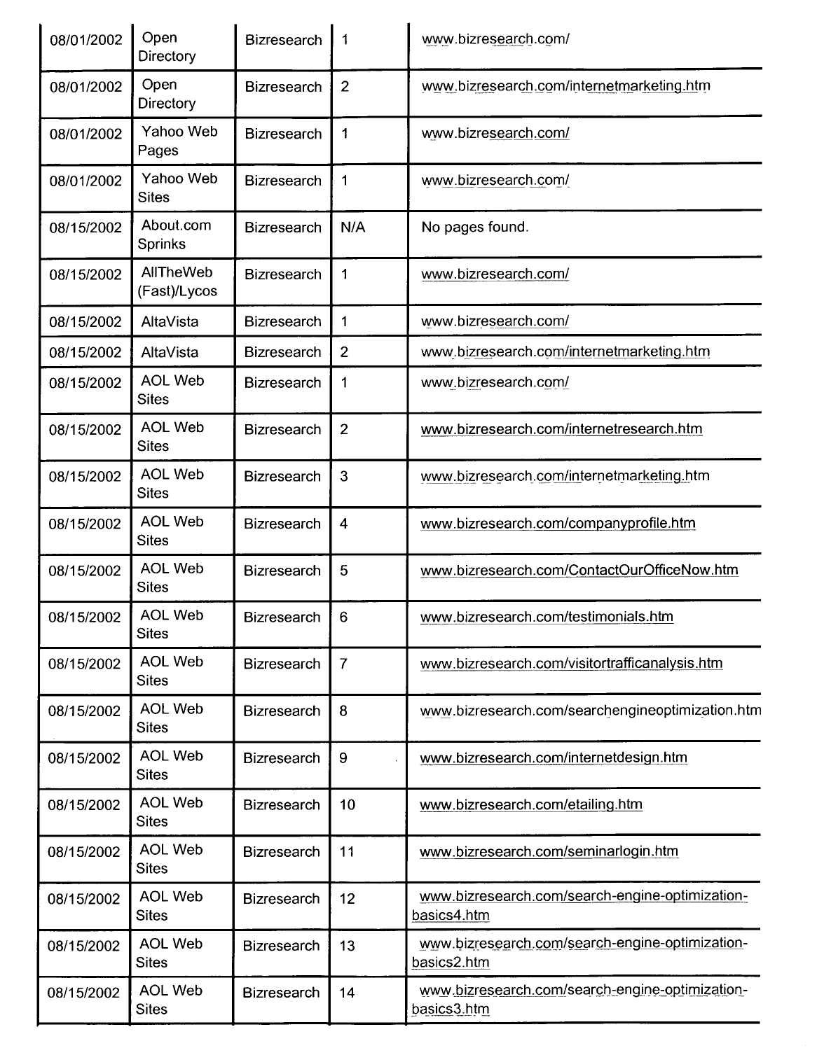

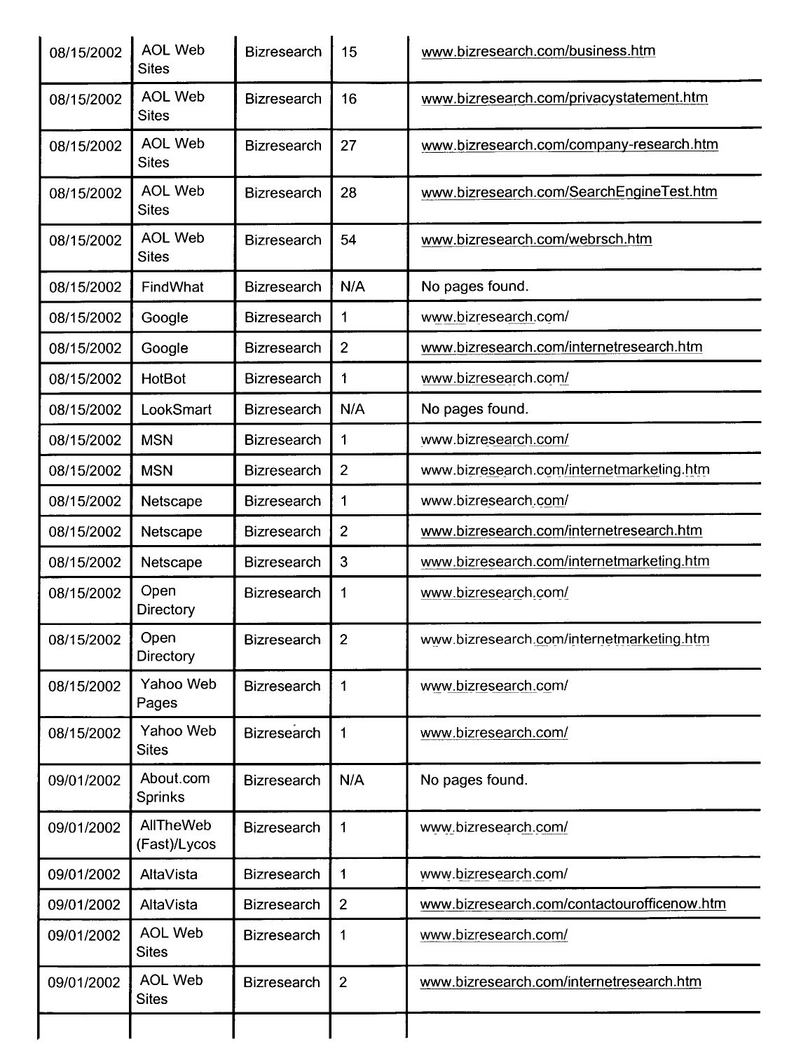

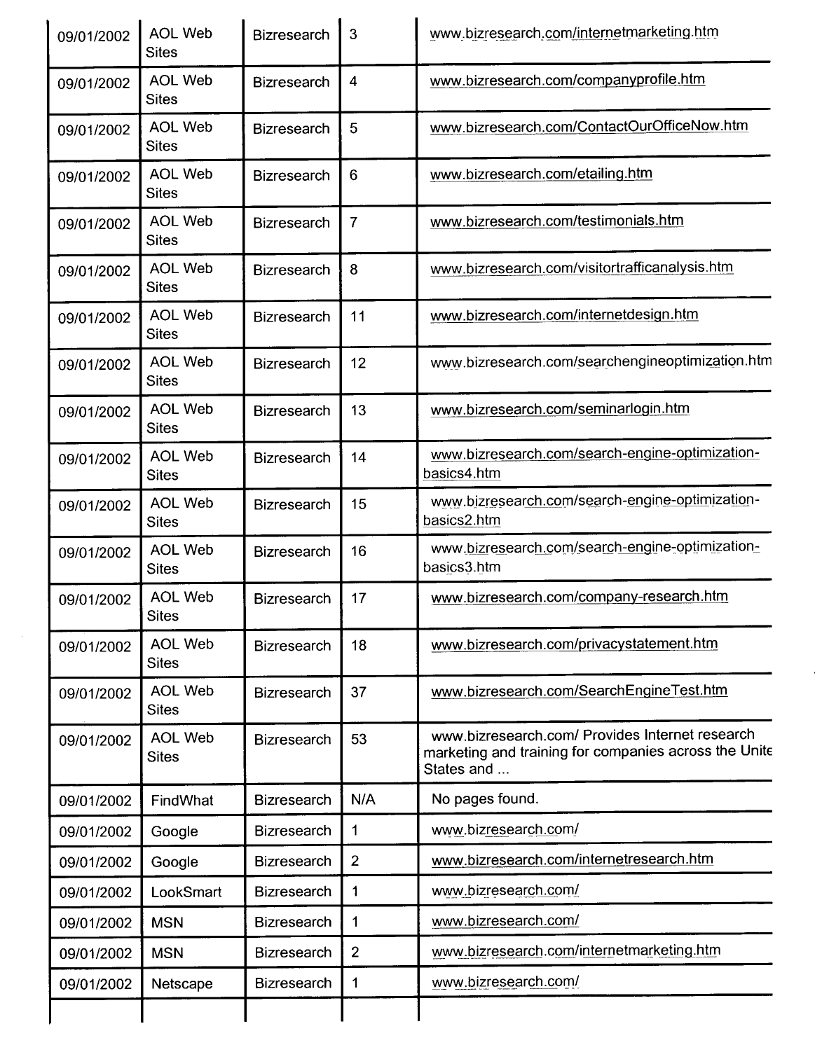

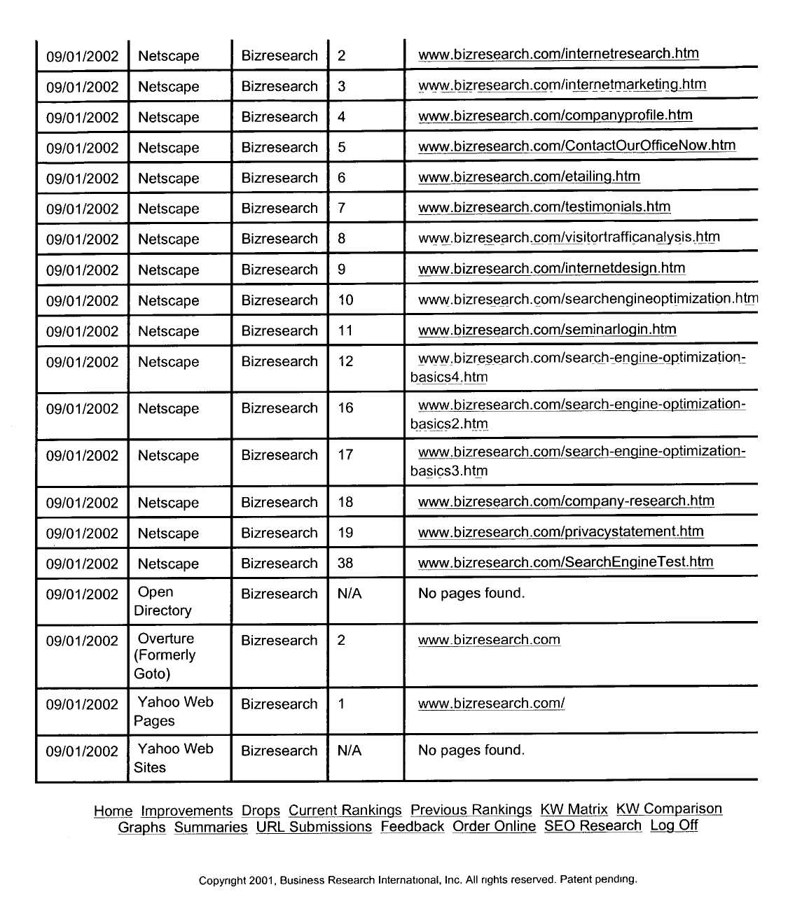

Turning now to FIGS. 16A-I, the system and method according to a preferred embodiment of the present invention allows a SEO professional the ability to administer multiple clients through a Web-based administrative tool. The tool preferably comprises several tool portions, described in detail below.

As shown in FIGS. 16B-D, a client administration tool allows a SEO professional to: add/delete/administer client information comprising: company name, username, password, e-mail, single or multiple user(s)'s name, Web site address, list of keywords, and/or URLs. The client administration tool also allows a SEO professional to report location on server, check whether or not end user should receive report notification reminders by e-mail; to determine which clients can receive specific reports by e-mail, and/or to insert or edit the personalized message that will display when client (end user) logs into the Web-based monitoring system.

As shown in FIG. 16E, a feedback administration tool allows a SEO professional to search by client, date range, or all feedback results. The feedback can be displayed by subject, then client name, and then date of last message. The SEO professional can also respond and archive all feedback for a predetermined period.

As shown in FIG. 16F, a global message administration tool allows an SEO professional the ability to insert Web site and hyper text markup language (HTML) formatting in a box that, once saved, immediately refreshes the message displayed to all end users when they log into the Web-based keyword visibility monitoring system.

As shown in FIG. 16G, a search engine administration tool allows the SEO professional to perform first through third tasks.

First, the ability to add a search engine with the following predetermined characteristics: a search engine name as it is displayed on the Web-based keyword visibility monitoring system; a search engine code as it will be abbreviated on the Web-based keyword visibility monitoring system; a search engine color as it will be displayed on the Web-based keyword visibility bar graph; the ability to select search engine by default in a drop-down box; ability to set a keyword visibility position resubmit limit (example: if keyword visibility exceeds the 40^{th} position, then resubmit); and the ability to check off whether or not some search engines or directories do not allow a SEO professional or the end user to resubmit a URL if the end user's Web site already has at least one keyword ranking.

Second, the ability to further designate a search engine's characteristics as they will be displayed in the Monthly Keyword Visibility Summary on the Web-based keyword visibility monitoring system. Other things that may boost rankings include: relevant title in the content; relevant title in the description metatags and content; relevant title in the description, kw metatags, and content; length of time in database; link popularity; click-thru popularity; paid promotion; paid inclusion; and editorial review.

Third, the ability to modify or delete a search engine as it is displayed in the end user's interface.

As shown in FIG. 16A, a global client research administration tool (not shown) has the ability to research all client reports globally at the same time, instead of being limited to administering each individual client's keyword visibility under each individual client's Web-based reports. This global report can comprise: keyword visibility detail; keyword ranking drops across all clients; keyword ranking improvements across all clients; length of time for a Web site to get indexed by a particular search engine/directory after the Web site or particular URL has been submitted by a SEO professional; and a length of time for a Web site to get dropped (keyword visibility exceeds the 40^{th} position in relevant search results) by a search engine/directory after the initial URL or Web site submission/registration.

As shown in FIG. 16H, a refresh ranking report operates when a new WebPositionGold mission, or report, is set up for a new or existing client. The reports need a way of getting populated by an Agent in the system and method of the present invention. Therefore, this administrative tool has been created to easily allow refreshing the database, and has the ability to select client and the ability to submit request to refresh ranking report.

As shown in FIG. 16I, a failed report notification is triggered occasionally due to a server or search engine time-out, or data entry error. If this happens, a mission will not run and the database will not be populated by the Agent in the system and method of the present invention. In contrast to the prior art, this is something that WebPositionGold on its own could not handle unless a user was standing by the computer at the time the error was generated and displayed on the end user's computer monitor. Thus, this Web-based administrative area has been created notify the SEO professional if a particular set of reports failed to run.

With reference to FIGS. 6 and 16J, a monthly summary administration with first through eleventh functions is shown.

First, the ability to summarize the client's (end user's) keyword visibility in something other than numerical terms (top ten, top twenty instead of 17, top thirty instead of 25, needs improvement instead of 35, and no visibility instead of 0, 100, or >40).

Second, the ability to display keyword visibility in a five-column table, that is both visible on the screen and is printer-friendly with the following information: keyword in column one—pulled from current WebPositionGold mission of keywords/phrases monitored for a particular Web site; summary of visibility (top ten, top twenty instead of 17, top thirty instead of 25, needs improvement instead of 35, and no visibility instead of 0, 100, or >40); automated recommendations based on rules set up in Web-based Search Engine Administration tool by Inventor; dynamically-generated action items which currently include but are not limited to: URL submissions that relate to the keyword's visibility in a search engine that currently has no visibility; and dynamically-generated comments that are inserted through the Keyword Visibility Monthly Summary Web-based administration tool by the inventor.

Third, the ability to select a client.

Fourth, the ability to select a summary month.

Fifth, the ability to view or edit an existing summary for the selected month.

Sixth, the ability to view an automated summary for each keyword/phrase.

Seventh, the ability to add an action item (URL submission) as it relates to each keyword, with the ability to: link to the client's (end-user's) Web site to review which Web pages or URLs would be relevant to the keyword visibility referenced in the summary; link to a search engine's add URL or home page to hand-submit or hand-register the specific URL or Web page that is relevant to the keyword visibility referenced in the summary; and the ability to record a URL submitted in summary's action items, as well as in the client's (end-user's) URL submission report.

Eighth, the ability to further comment on a keyword's visibility.

Ninth, the ability to publish, or in essence push, the automated/dynamically generated keyword visibility monthly summary to the client's (or end-user's) Summaries page.

Tenth, the ability to edit and re-publish any additional action items and/or comments on the keyword visibility monthly summary.

Eleventh, the ability to edit, add or delete the URL submitted under the URL submission page.

From the above description of the invention, those skilled in the art will perceive improvements, changes, and modifications in the invention. Such improvements, changes, and modifications within the skill of the art are intended to be covered.

1. A method for monitoring a Web site's keyword visibility in search engines and directories and resulting traffic from such keyword visibility, comprising the steps of:
establishing a set of rules and criteria;
executing a Web site promotion program;
generating a first data set from said Web site promotion program;
adding said first data set to a first historical data set;
executing a Web site keyword visibility tracking and traffic analysis program;
generating a second data set from said Web site keyword visibility tracking and traffic analysis program;
adding said second data set to a second historical data set;
establishing relationships between said first and second data sets;
establishing relationships between said first and second historical data sets;
populating a database in accordance with said rules and criteria; and
generating an output of at least one report in accordance with said rules and criteria.

2. A method as recited in claim 1, further comprising the step of providing an output of recommendations according to said report results in view of said rules and criteria.
